(19) United States
(12) Patent Application Publication
(10) Pub. No.: US 2020/0120772 A1
(43) Pub. Date: Apr. 16, 2020

(54) LOAD CONTROL SYSTEM CONFIGURATION TOOL

(71) Applicant: Lutron Technology Company LLC, Coopersburg, PA (US)

(72) Inventors: Nathan A. Boring, New Tripoli, PA (US); Somesh Rahul, Breinigsville, PA (US); Shilpa Sarode, Allentown, PA (US)

(73) Assignee: Lutron Technology Company LLC, Coopersburg, PA (US)

(21) Appl. No.: 16/599,091

(22) Filed: Oct. 10, 2019

Related U.S. Application Data
(60) Provisional application No. 62/744,091, filed on Oct. 10, 2018.
(60) Provisional application No. 62/744,476, filed on Oct. 11, 2018.

(51) Int. Cl. H05B 37/02; H05B 33/08; G05B 15/02

(52) U.S. Cl. CPC H05B 37/0245; G05B 15/02; H05B 33/0863

(57) ABSTRACT

A load control system may include a control device, such as a control-target device and a control-source device. A control circuit of a computing device(s) may execute a load control system configuration tool. The control circuit executing the load control system configuration tool may display first level details associated with the load control system in a project. The first level details may include one or more of square footage, energy code, building function, or construction type associated with the project. Based on the first level details, the control circuit of the computing device(s) executing the load control system configuration tool may generate one or more load control system configurations. Each one of the one or more load control system configurations may include one or more load control instructions. The one or more load control instructions may control the control-target devices in the load control system in the project.

### CROSS REFERENCE TO RELATED APPLICATIONS

This application claims the benefit of U.S. Provisional Application No. 62/744,091 filed Oct. 10, 2018 and U.S. Provisional Application No. 62/744,476 filed Oct. 11, 2018, which are incorporated by reference herein as if fully set forth.

### BACKGROUND

A load control environment, such as a residence or an office building, for example, may be configured with various types of load control systems. The load control environment may include load control devices that are associated with input devices for communicating load control instructions for controlling an electrical load. The load control environment may include one or more rooms. Each of the rooms includes load control devices that are capable of directly controlling an electrical load. For example, each of the rooms may include lighting control devices (e.g., ballasts, light-emitting diode (LED) drivers, and/or dimmer switches) capable of directly controlling an amount of power provided to lighting loads. A room may include additional load control devices, such as a motorized window treatment and/or a heating, ventilation, and/or air-conditioning (HVAC) system.

Each load control system may include various input devices and load control devices. The input devices may be capable of controlling the electrical load via the load control device by sending digital messages to the load control device that include control instructions for controlling the electrical load controlled by the load control device. To enable a load control device to recognize instructions received from an input device, the load control device and the input device may be associated with one another, such that the load control device may recognize the digital messages received from the input device.

In an association between input devices and load control devices, the input devices and the load control devices may be associated by a user. The user may associate the input devices and the load control devices by creating an association table. The association table may include a table that associates each load control device with input devices on a computer, a tablet, a mobile device, or equivalent device having a visual display. The association table may lack spatial information of the input devices and the load control devices. For example, the association table may include information of a general location of an input device (e.g., in a conference room, in a bedroom, etc.) or the association table may include information of a location of a load control device (e.g., in a conference room, in a bedroom, etc.). The association table may lack other information relevant to the installation and setup of the devices in the load control system. For example, information of the location of the input device as it relates to the load control device, or vice-versa, may be unknown. The compatibility of devices within the system, and how they may be wired during installation or grouped after installation, may also be unknown.

When further configuring the load control system, various occupancy sensors may be selected for installation. Configuring the load control system with the proper occupancy sensor may be difficult without an understanding of the relative location of the occupancy sensor within the load control environment and the specific occupancy sensor being installed, as each occupancy sensor may be configured to sense different types of movement at different ranges using different types of technology.

Processing the information associated with the load control system may take a long time and it may be difficult to identify accurate information about the devices to be installed in a load control system when a portion of the information about the load control system is known. For example, it may be difficult to identify control devices and/or associations between the devices (e.g., the input devices and the load control devices) in the load control system when a portion of the information about the system is provided.

### SUMMARY

A load control system may include one or more system controllers and one or more control devices for controlling an amount of power provided to an electrical load. The control devices may be or may include control-source devices and/or control-target devices. The control-target devices may be load control devices capable of controlling the amount of power provided to a respective electrical load based on digital messages received from the control-source devices. The digital messages may include load control instructions or another indication that causes the control-target device to determine load control instructions for controlling an electrical load.

One or more system controllers may communicate with control devices. For example, system controllers may communicate with control devices for configuring control devices, associating control devices, providing scenes (e.g., presets) via one or more control devices, etc. System controllers may communicate with control devices for operating control devices. For example, system controllers may communicate with control devices by generating instructions for control devices, sending instructions to control devices, and/or receiving instructions from control devices. System controllers may communicate with control devices by sending digital messages to the control devices wirelessly (e.g., using a proprietary communication protocol, such as the CLEAR CONNECT™ protocol, etc.).

As described herein, control-target devices and control-source devices may be associated with each other to allow for communication between the devices. A system controller may be used to perform the associations between the control-target devices and the control-source devices. For example, the system controller may be used to send digital messages to control-source devices for associating with control-target devices with the control-source source devices. The system controller may be used to send digital messages to the control-target devices for associating the control-source devices with the control-target devices. The digital messages may include an identification of the control-source devices and/or an identification of the control-target devices with which the system controller may communicate. A control-source device may send digital messages to a control-source device for associating the control-target device with the control-source device, and the system controller may receive the digital message and store information regarding the association between the control-target device with the control-source device.

The load control system may be configured by one or more computing devices in a load control configuration system using a load control system configuration tool. The load control system configuration tool may comprise a software that may be executed on a control circuit of a computing device. The load control system configuration tool (e.g., load control system configuration tool software) may run on a network device, such as a personal computer (PC), a laptop, a tablet, a smart phone, a server, or equivalent device having a visual display. The load control system configuration tool may provide one or more load control system configurations to a user. Each load control system configurations may include load control details to be implemented in the project to function properly. For example, the load control details may include a list of devices, such as control devices (e.g., control-source devices and/or control-target devices), electrical loads, and/or connections between the devices. The configuration tool may use the load control details from the load control system configurations to implement in the project and to function properly.

The control circuit of the computing device(s) executing the load control system configuration tool may ask the user first level details about the project. The first level details may include one or more of project location, energy code, square footage of the project, building function, and/or construction type. Based on the inputs received from the user, the control circuit of the computing device(s) executing the load control system configuration tool may generate one or more load control system configurations. For example, the control circuit of the computing device(s) executing the load control system configuration tool may use determine from a database that includes list of previous projects and may display the most commonly used project that are suitable for the project based on the first level details. The most commonly used project may be or may include the top-three popular projects used in the area based on the first level details. The one or more load control system configurations may include one or more instructions to control devices in the load control system. For example, the one or more instructions may control the control-target devices in the load control system.

The control circuit of the computing device(s) executing the load control system configuration tool may ask additional level details about the project to the user. As the user provides more details about the project, the control circuit of the computing device(s) executing the load control system configuration tool may refine and/or update the one or more load control system configurations.

The control circuit of the computing device(s) executing the load control system configuration tool may upload the one or more load control system configurations to a system controller. The system controller may control the devices associated with each of the one or more load control system configurations. For example, the system controller may control the control-target device based on the instructions associated with the one or more load control system configurations.

### BRIEF DESCRIPTION OF THE DRAWINGS

FIG. 1 is a system diagram that illustrates an example load control environment for associating control devices and controlling electrical loads.

FIGS. 2-25 illustrate example graphical representations of a user interface that may be displayed on a visual display of a network device by a software, e.g., a graphical user interface (GUI) software, for designing and configuring the load control system using templates.

FIGS. 26-43C illustrate example graphical representations of a user interface that may be displayed on a visual display of a network device by a load control system configuration tool, e.g., a GUI software such as a load control system configuration tool software, for providing load control system configurations and/or load control details.

FIGS. 44-50 illustrate example graphical representations of a user interface that may be displayed on a visual display of a network device by a load control system configuration tool, e.g., a GUI software such as a load control system configuration tool software, for providing load control system configuration and/or load control details.

FIG. 51 is a block diagram of an example programming device.

FIG. 52 is a block diagram of an example server or system controller.

FIG. 53 is a block diagram of an example control-target device.

FIG. 54 is a block diagram of an example control-source device.

FIGS. 55A-B illustrate example decision tree used by a load control system configuration tool.

FIGS. 56A-B illustrate example configuration matrix used by a load control system configuration tool.

### DETAILED DESCRIPTION

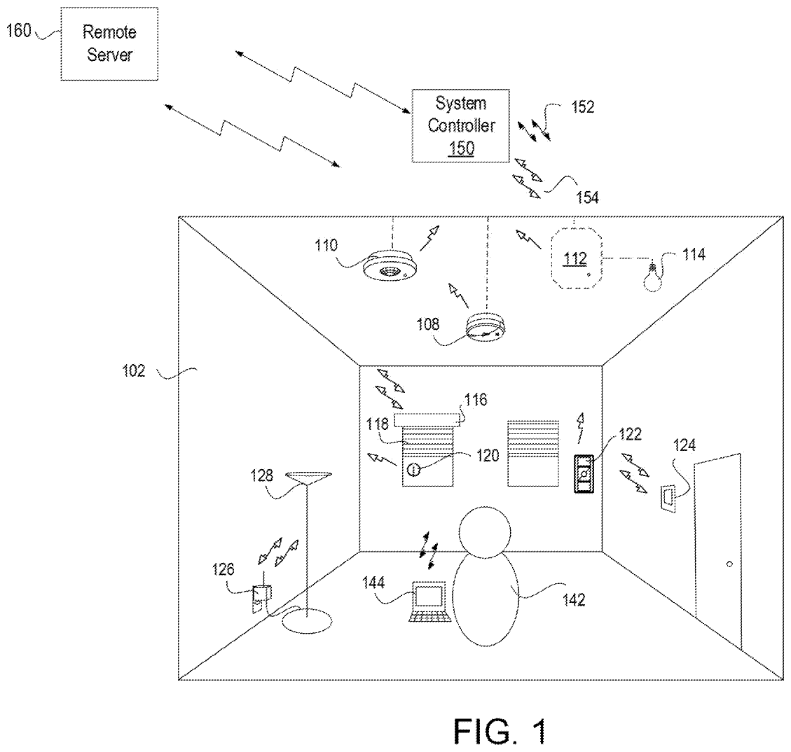

FIG. 1 depicts a load control system 100 that includes control-source devices and control-target devices. As shown in FIG. 1, the load control system 100 may be installed in a load control environment 102, which may be a room in a building. The load control system 100 may include control-target devices that may be capable of controlling (e.g., directly controlling) an electrical load. For example, load control system 100 may include a lighting control device 112. The lighting control device 112 may be a ballast, a light emitting diode (LED) driver, a dimmer switch, and/or the like. The lighting control device 112 may be capable of directly controlling an amount of power provided to lighting load 114. The load control system 100 may include one or more control-target devices, such as a motorized window treatment 116 for directly controlling the covering material 118 (e.g., via an electrical motor), a plug-in load control device 126 for directly controlling a floor lamp 128, a desk lamp, and/or other electrical loads that may be plugged into the plug-in load control device 126, and/or a temperature control device 124 (e.g., thermostat), for directly controlling an HVAC system.

The control-source devices in load control system 100 may include a remote control device 122, an occupancy sensor 110, a daylight sensor 108, and/or a window sensor 120. The control-source devices may send digital messages to associated control-target devices for indirectly controlling an electrical load by transmitting digital messages, such as load control messages, to the control-target devices. The remote control device 122 may send digital messages for controlling a control-target device after actuation of one or more buttons. The occupancy sensor 110 may send digital messages to a control-target device based on an occupancy or vacancy condition (e.g., movement or lack of movement) that is sensed within its observable area. The daylight sensor 108 may send digital messages to a control-target device based on the detection of an amount of light within its observable area. The window sensor 120 may send digital messages to a control-target device based on a measured level of light received from outside of the load control environment 102. For example, the window sensor 120 may detect when sunlight is directly shining into the window sensor 120, is reflected onto the window sensor 120, and/or is blocked by external means, such as clouds or a building. The window sensor 120 may send a digital message indicating the measured light level.

The control-source devices and/or the control-target devices may be in communication with a system controller 150. The system controller 150 may be capable of transmitting digital messages to, and/or receiving digital messages from, control devices (e.g., control-source devices and/or control-target devices). The digital messages may include association information for associating control-source devices and/or control-target devices. The system controller 150 may maintain the association between the control-target device and the control-source device when the system controller is integrated into the load control system. The system controller 150 may maintain the association between devices to enable control of the control-target devices by the associated control-source devices after integration of the system controller 150 into the load control system.

The system controller 150 may facilitate communication of control information from control-source devices to associated control-target devices using the association information. The system controller 150 may be a gateway device, a network bridge device, an access point, and/or the like. Examples of load control systems having system controllers 150 are described in greater detail in commonly-assigned U.S. Patent Application Publication No. 2014/0001977, published Jan. 2, 2014, entitled LOAD CONTROL SYSTEM HAVING INDEPENDENTLY-CONTROLLED UNITS RESPONSIVE TO A BROADCAST CONTROLLER, and U.S. Patent Application Publication No. 2015/0185752, published Jul. 2, 2015, entitled WIRELESS LOAD CONTROL SYSTEM, the entire disclosures of which are hereby incorporated by reference.

The control-source devices in load control system 100 may be associated with the control-target devices using various association techniques. For example, in an association between the control-source devices and the control-target devices, the control-source devices may be associated with the control-target devices by the user 142 actuating a button on the control-source device and/or the control-target device. The actuation of the button on the control-source device and/or the control-target device may place the control-source device and/or the control-target device in an association mode, for example, for being associated with one another. In the association mode, the control-source device may transmit an association message to the control-target device. The association message from a control-source device may include a unique identifier of the control-source device. The control-target device may locally store the unique identifier of the control-source, such that the control-target devices may be capable of recognizing digital messages (e.g., subsequent digital messages) from the control-source device that may include load control instructions. The control-target device may be capable of responding to the digital messages from the associated control-source device by controlling a corresponding electrical load according to the load control instructions received in the digital messages. Examples of load control systems are described in greater detail in commonly-assigned U.S. Pat. No. 5,905,442, issued May 18, 1999, entitled METHOD AND APPARATUS FOR CONTROLLING AND DETERMINING THE STATUS OF ELECTRICAL DEVICES FROM REMOTE LOCATIONS, and U.S. Pat. No. 8,417,388, issued Apr. 9, 2013, entitled LOAD CONTROL SYSTEM HAVING AN ENERGY SAVINGS MODE, the entire disclosures of which are hereby incorporated by reference.

An input device, such as a computer 144 may communicate with a remote server 160. The computer 144 and/or the remote server 160 may be a part of the load control configuration system and/or the design system described herein. A computing device, such as the computer 144 or the remote server 160, may be a part of both the load control configuration system and the design system. The computer 144 may receive load control system configurations comprising load control details from a load control system configuration tool and may feed the load control system configurations to other systems/software. For example, the load control system configurations may be generated by computing device(s) in the load control system configuration tool and uploaded to computing device(s) in the design system (e.g., design software executed thereon), or vice versa. The load control configuration system may include one or more computing device(s) for executing a load control system configuration tool (e.g., load control system configuration tool software), and the design system may be a separate system that may include one or more computing device(s) for executing design software. Alternatively, or additionally, the load control system configuration tool (e.g., load control system configuration tool software) and the design software may be pieces of a suite of software executed on the same computing device(s). The remote server 160 may include a web server (not shown). Based on the input from the computer by a user, the remote server 160 may send load control system configurations comprising load control details and/or quotes. The load control system configurations may be displayed, e.g., via GUI software, in the computer 144. The load control system configuration tool may be utilized via one or more computing device(s), such as the computer 144 and/or remote server 160, as described hereinafter.

The control circuit of the computing device(s) executing the load control system configuration tool described herein may generate one or more load control system configurations. The load control system configuration tool may be a load control system estimation tool that identifies different load control systems based on information provided by the user. The load control system configurations may be different solutions for estimating the load control system configuration for a project. Different load control system configurations may be different estimated solutions based on a portion of the information provided by a user about the system.

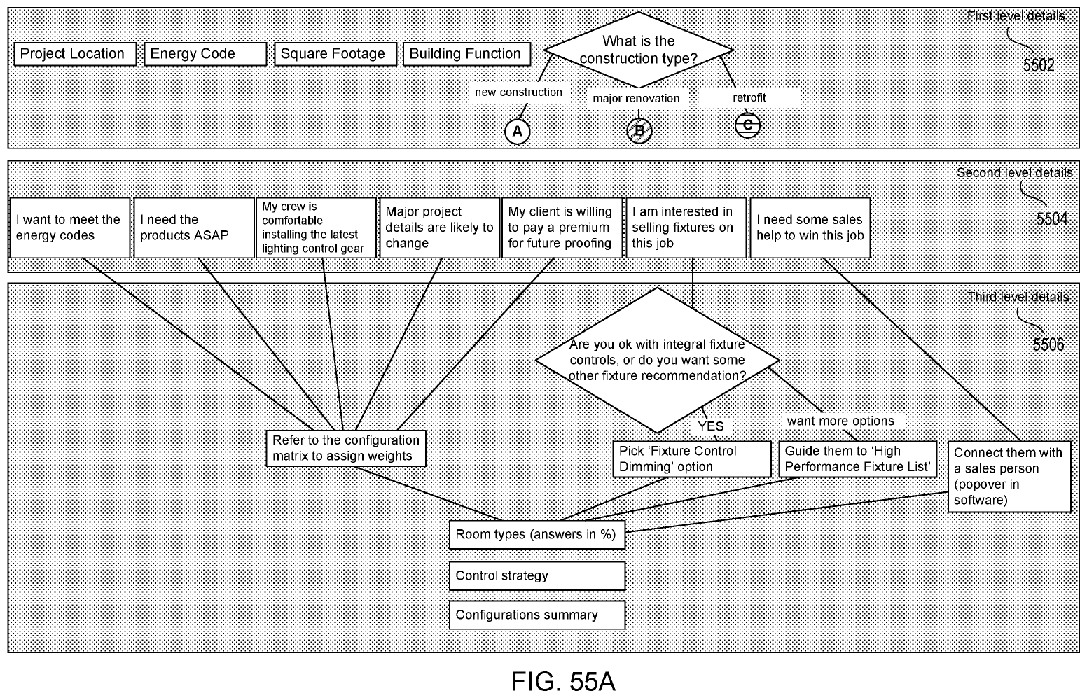

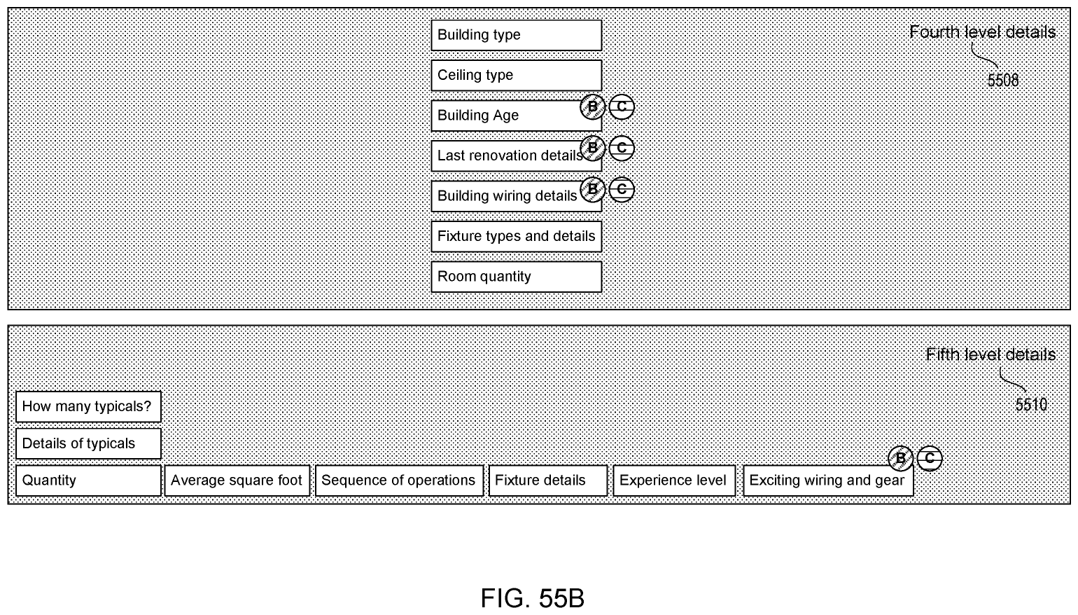

A user may define, design, layout, and/or configure a load control system (such as the load control system 100) for a load control environment (such as the load control environment 102) to obtain different load control system configurations using a load control system configuration tool (also referred to herein as a configuration tool) as described herein. The load control system configurations may include, but not limited to load control details or project details. The load control details may be or may include one or more level of details about the project. For example, the load control details may include first level details, and the first level details (e.g., first level details 5502 as shown in FIGS. 55A-B) may include one or more of project location, energy code, square footage of the project, building function, construction type, and/or the like. Additional levels of load control details (e.g., second level details 5504, third level details 5506, fourth level details 5508, fifth level details 5510 shown in FIG. 55B as examples) may include one or more of number of buildings in the project, number of floors in each of the building in the project, types of ceiling (e.g., hard, drop, open ceiling, and/or the like), emergency power type, voltage type (e.g., 277V, 120V, a combination of 277V and 120V, and/or the like), project completion date (e.g., to update building code and/or availability of products based on the completion date), project situations (e.g., such as budget flexibility, schedule flexibility, project detail flexibility, expertise on the latest lighting control technologies, expertise of the workers to handle the latest lighting control technologies, customer preferences on installing the latest lighting control technologies, information about the preexisting fixtures in a load control system, urgency of the project time line, and/or the like), room details (e.g., room height, dimensions, fixture and zone information, room functions, and/or the like), and/or the like. The load control details shown in the second level details through the fifth level details at FIGS. 55A-B may be illustrated as examples and one or more load control details from the additional level details may be added/removed from the additional levels of details. The load control details may include a list of devices, such as control devices (e.g., control-source devices and/or control-target devices), electrical loads, connections between the devices, communication types between the devices in the load control system, and/or control information. For example, the load control details may include information about the system configuration being connected in wired or wireless communication (e.g., for communication types). The load control details may include information about how the devices are connected (e.g., via communication types) with each other. The control information included in the load control details may be control instructions configured to control an electrical load and/or a control-target device. The control instructions may be generated based on a command from a control-source device, a sensor event, a timer event, or another triggering event in the system.

A user may use the load control system configuration tool to define a graphical representation of the load control environment (e.g., a room, a floor with one or more rooms, several floors with several rooms, etc.), to define particular electrical devices for the load control system (e.g., electrical loads/fixtures and/or control devices, such as control-source devices and/or control-target devices), to select defined electrical devices, to place graphical representations (e.g., icons) of the selected electrical devices within the graphical representation of the load control environment at desired locations within the environment, and/or to configure selected electrical devices (which may include generating graphical representations of connections (e.g., electrical and/or communication connections) and/or associations between selected electrical devices) to thereby create the load control system.

A user may also use the configuration tool described herein to define particular window treatments, including motorized window treatments (e.g., shades, such as roller shades and/or cellular shades, blinds, such as venetian blinds, draperies, etc.) for the load control system, to select defined window treatments, to place graphical representations (e.g., icons) of the selected window treatments within the graphical representation of the load control environment at desired locations within the environment, and to configure selected window treatments (which may include generating graphical representations of connections and/or associations between selected window treatments and other electrical devices). For description purposes, the configuration tool will be described hereinafter using the term shade or shades to refer to window treatments, but is applicable to other types of window treatments and the use of the term shade or shades is not meant to limit the applicability of the load control configuration system and/or the design system.

Such a load control system configuration tool may have multiple uses for various types of users of the load control system configuration tool. For example, the graphical representation of the load control environment together with the graphical representation (e.g., icons) of the electrical devices and shades may allow the user, such as a contractor, to design and/or layout a load control system and visually convey the resulting design and/or layout to get details about a load control system configuration. The load control system configuration tool may generate one or more (e.g., different) load control system configurations that include load control details. As described herein, the load control details may include, but not limited to a list of devices, such as control devices (e.g., control-source devices and/or control-target devices), electrical loads (e.g., fixtures), connections between the devices, a bill of materials listing electrical devices, shades, etc., to be implemented on the project to function properly. The graphical representation of the load control system together with the graphical representation of the electrical devices and shades may assist installers/electricians/builders, for example, in installing the actual load control system within the physical/real world load control environment. The connections and/or associations between electrical devices including shades generated by the configuration tool may define the operation of the load control system once the load control system is installed in the physical load control environment, and thus, assist installers in configuring the load control system once installed. The configuration tool may also generate warnings and errors as the user designs and/or configures a load control system. These are only some example benefits of the load control system configuration tool described herein, and one will recognize that the configuration tool may not provide each of these benefits and may also provide additional benefits.

A user, such as a contractor for a commercial project, may use a load control system configuration tool described herein to generate load control system configurations (e.g., that include load control details) on the project. The details about the project may vary at any given point of time, especially at the beginning. Yet the user may still generate one or more load control system configurations of the project, e.g., to use the generated configurations for submitting a bid or to provide a rough estimate of the configuration of the system to a client. The control circuit of the computing device(s) executing the configuration tool may help the user to generate load control details by taking a first level of details about the project (e.g., first level details 5502 shown in FIG. 55A). For example, as shown in FIGS. 55A-B, the load control details may be or may include first level details 5502, second level details 5504, third level details, 5506, fourth level details 5508, fifth level details 5510, and so on. The load control details may be or may include answers and/or inputs from the user based on answering/providing one or more level details about the project.

The control circuit of the computing device(s) executing the load control system configuration tool may ask first level details to the user (e.g., the first level details 5502 shown in FIG. 55A). The first level details may include one or more of project location, energy code, square footage of the project, building function, and/or construction type.

Based on the inputs received from the user, the control circuit of the computing device(s) executing the load control system configuration tool may provide one or more load control system configurations, each providing a load control system suitable for the project. For example, the control circuit of the computing device(s) executing the load control system configuration tool may provide one or more load control system configurations (e.g., top three most-commonly used configurations) that satisfy the first level details from a database. The database may include previously configured and/or saved load control system configurations, and each of the load control system configurations may have one or more load control details associated with the corresponding system configurations.

The control circuit of the computing device(s) executing the load control system configuration tool may ask second level details (e.g., the second level details 5504 shown in FIG. 55A). Based on the inputs from the user for the second level details, the control circuit of the computing device(s) executing the load control system configuration tool may filter one or more generated load control system configurations. The control circuit of the computing device(s) executing the load control system configuration tool may continue to ask additional level details and gather more information about the project. Based on the answers/inputs gathered from the user about the project, the control circuit of the computing device(s) executing the load control system configuration tool may refine/update the load control system configurations.

As the user has more information on the project, the load control system configuration tool may receive such additional levels of information from the user, and the configuration tool may provide more accurate load control configurations (e.g., including load control details, estimates, and/or the like) about the project.

The control circuit of the computing device(s) executing the load control system configuration tool may assign weights to answers/inputs from the user about each level of load control details in a decision tree (e.g., as illustrated in FIGS. 55A-B). The control circuit of the computing device(s) executing the configuration tool may assign different weights to each level of the load control details. For example, the control circuit of the computing device(s) executing the configuration tool may assign greater value weights to the answers/inputs corresponding to the first level control details than the answers/inputs corresponding to the other levels of control details (e.g., the second level control details, the third level control details, so on). For example, the control circuit of the computing device(s) executing the configuration tool may assign the greater value weights to the answers/inputs from the user corresponding to the first level control details than the answers/inputs corresponding to the second level control details. The control circuit of the computing device(s) executing the configuration tool may assign the greater value weights to the answers/inputs from the user corresponding to the second level control details than the answers/inputs corresponding to the third level control details, and so on. The control circuit of the computing device(s) executing the configuration tool may assign the highest weights to the answers/inputs corresponding to the first level control details (e.g., rather than the answers/inputs corresponding to the other levels of control details).

The control circuit of the computing device(s) executing the configuration tool may assign different weights to the answers/inputs corresponding the control details within the same level of the decision tree. For example, as described herein, the first level details may be or may include one or more of project location, energy code, square footage of the project, building function, and/or construction type. The control circuit of the computing device(s) executing the configuration tool may assign greater value weights to the inputs correspond to the energy code, the square footage, and/or the building function than other first level details (e.g., the project location, and/or the construction type), though the greater value weights may be assigned differently.

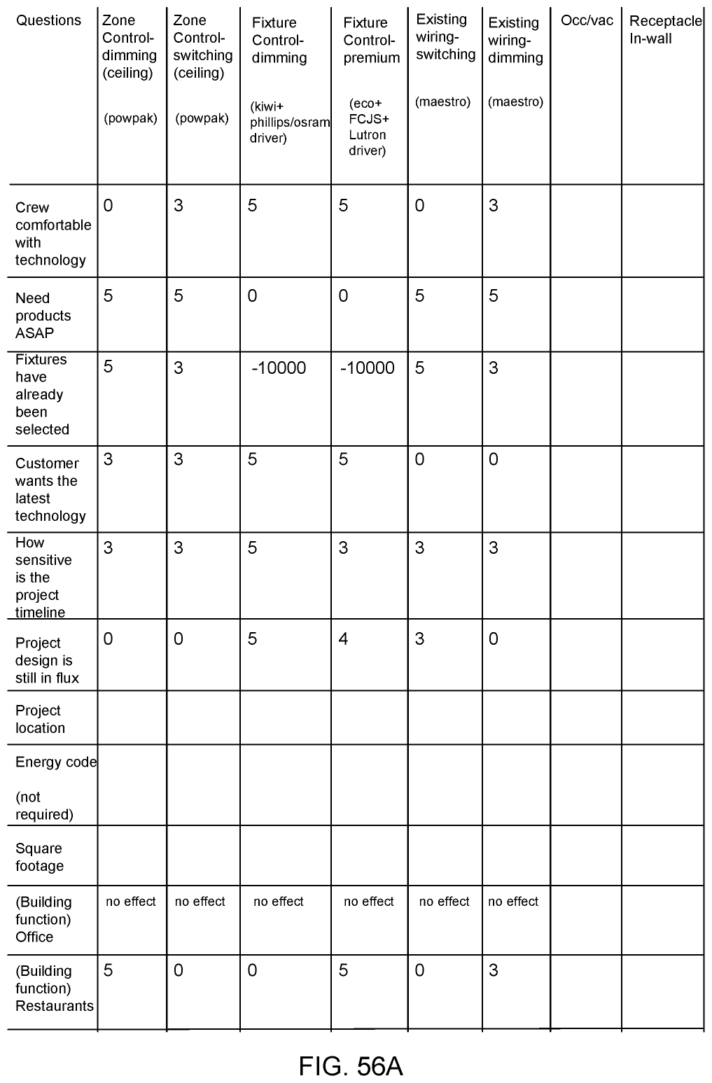

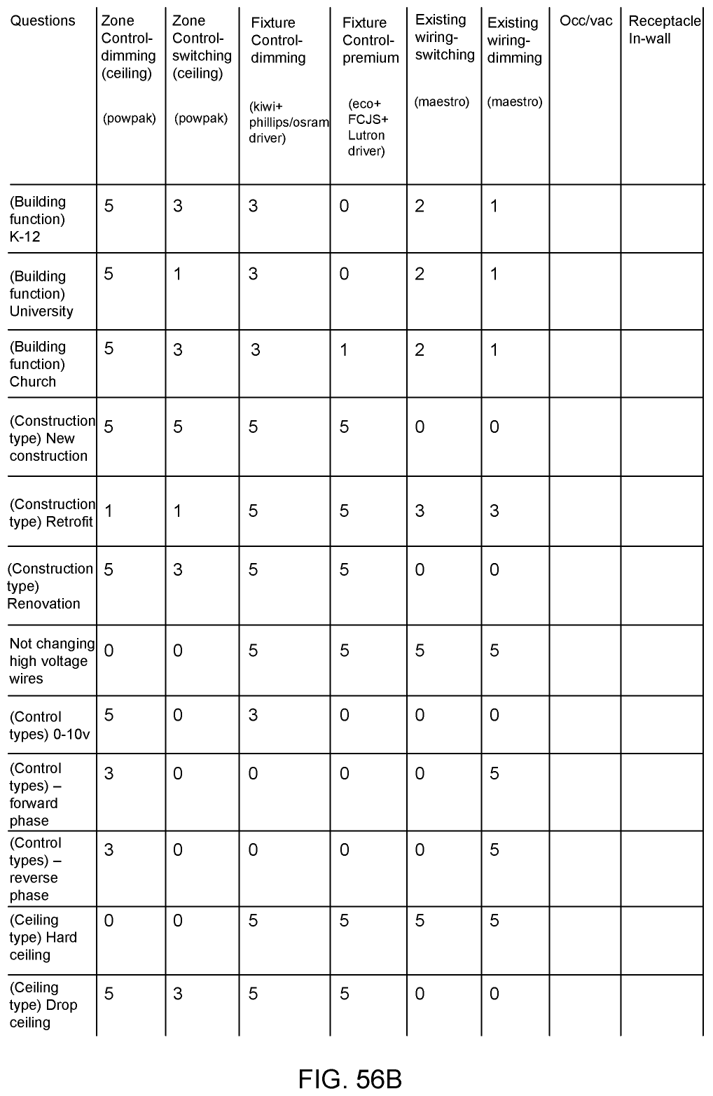

The control circuit of the computing device(s) executing the configuration tool may use the weights that correspond to the level of details shown in FIGS. 55A-55B and may apply the weights to a configuration matrix illustrated in FIGS. 56A-B. Based on the weights determined for each level of the details shown in FIGS. 55A-B and/or the matrix shown in FIGS. 56 A-B, the control circuit of the computing device(s) executing the configuration tool may provide one or more load control system configurations. For example, the control circuit of the computing device(s) executing the load control system configuration tool may provide one or more load control system configurations (e.g., top three most-commonly used configurations) that satisfy the inputs on the matrix from a database comprising previously configured and/or saved load control system configurations and/or projects.

As an example, as shown in FIGS. 56A-B, the control circuit of the computing device(s) executing the load control system configuration tool may determine one or more load control system configurations based on determined weights from the answers/inputs that the user provides on the different level details for the project (e.g., shown in FIGS. 55A-B). For example, the control circuit of the computing device(s) executing the load control system configuration tool may receive answers/inputs from the user (e.g., based on the first level details 5502) that the project is located in San Diego and has 25,000 square footage project. As described herein, the control circuit of the computing device(s) executing the load control system configuration tool may assign weights to the inputs/answers from the user on the first level details, such as first level details 5502. Based on the weights associated with the first level details, the control circuit of the computing device(s) executing the load control system configuration tool may input the weights to a table, such as a configuration matrix shown in FIGS. 56A-B. The control circuit of the computing device(s) executing the load control system configuration tool may provide one or more load control system configurations based on the matrix. The matrix shown in FIGS. 56A-B may be illustrated as an example, and the control circuit of the computing device(s) executing the load control system configuration tool may provide other weights for the load control details therein, and/or provide weights for other load control details.

As an example, the control circuit of the computing device(s) executing the load control system configuration tool may apply numerical weights predefined for the inputs/answers on each level of load control details. For example, the control circuit of the computing device(s) executing the load control system configuration tool may apply numerical weights predefined for the inputs/answers on the first level details. For example, the control circuit of the computing device(s) executing the load control system configuration tool may predefine greater numerical weights to more commonly implemented or more popular projects with similar square footage and location. For example, the control circuit of the computing device(s) executing the load control system configuration tool may determine that based on information available from the database, the most common projects in San Diego that has 25,000 square footage project may be a school (e.g., K-12, university), restaurants, or a church. The control circuit of the computing device(s) executing the load control system configuration tool may input a greater value (e.g., 5 in numeric scale) than a value assigned to an office (e.g., 0 or less than 5 numeric value). Based on the weights from the matrix, the control circuit of the computing device(s) executing the load control system configuration tool may filter lists of projects available at the database and provide one or more load control system configurations that are more commonly implemented or popular within a time period (e.g., top three commonly used) and that meet the use specified inputs.

As the control circuit of the computing device(s) executing the load control system configuration tool receives more inputs from the user about the project via additional level details, the control circuit of the computing device(s) executing the load control system configuration tool may assign and/or adjust weights and filter the one or more load control system configurations of the database. For example, the control circuit of the computing device(s) executing the load control system configuration tool may receive inputs from the user that the project is for an office and following Title 24-2016 Energy code. Based on the answers/inputs from the user from the additional level details (e.g., the second level details, the third level details, and so on), the control circuit of the computing device(s) executing the load control system configuration tool may continue to filter configurations out of the configurations to be provided to the user. The control circuit may also, or alternatively, update and/or revise the weights on the table (e.g., as illustrated in FIGS. 56A-B) and may revise/update one or more load control system configurations based on the adjusted weights.

A user (e.g., a contractor for commercial project) may deal with numerous back and forth communications with representatives and/or distributors, for example, to develop different load control system configurations (e.g., cost estimates associated with the configuration) of a project. Miscommunication may occur, especially at the early stage, where the user has less information about the project, and details about the project varies constantly. This may generate a lot of guesswork between the user and the representatives and/or distributors. The user and the representatives and/or distributors may have to communicate back and forth to clarify many details to make the load control system configurations more accurate, while the details about the project change. A control circuit of the computing device(s) executing the load control system configuration tool described herein may resolve this by providing a streamline process that is transparent to the user. The load control system configuration tool may be easily navigated and/or adjusted, while providing accurate load control system configurations based on the information/details that the user provides to the configuration tool as details change and become more refined.

A load control system configuration tool described herein may be or may include a load control system configuration tool software, which may include computer-based instructions. The load control system configuration tool software may include one more software programs, including for example, a graphical user interface (GUI) software and a software-based logic engine that may be executed by a control circuit of one or more computing devices. The GUI software may provide a GUI-based interface and/or GUI-based “window(s)” to a user and may allow the user to interact with the configuration tool. The software-based logic engine may provide features of the GUI software and features of the configuration tool in general as described herein, and may further include a database/database system for the storing of load control system configurations, load control details, design, layout, and/or configuration information, for example, as defined by the user and determined by the configuration tool. The configuration tool, in whole or in part, may reside in one or more computer readable tangible and non-transitory memory devices and may be executed by one or more control circuits from one or more memory devices.

The load control system configuration tool may further include one or more computing systems having one or more control circuits and/or graphic control circuits that may execute the load control system configuration tool software, in addition to other software, such an operating system(s) and/or database management system(s), to provide the features and functions described herein (hereinafter, reference to the load control system configuration tool providing the features and functions described herein may be understood to mean the computing system(s) executing software-based instructions, including the load control system configuration tool software, for example, to provide the features and functions described herein). Such computing system(s) may include one or more visual display screen(s)/terminal(s) and/or touch sensitive visual display screen(s) (herein after also referred to as a visual display) for the displaying of information to a user, and may include one or more input/output devices (e.g., a keyboard, a touch sensitive screen, a touch-sensitive pad, a mouse, a trackball, audio speaker, audio receiver, etc.) for the user to interact with/control the load control system configuration tool. The computing system(s) may further include one or more transceivers and/or other communication circuits and/or network devices for communicating over wired and/or wireless commination systems/networks. Example computing system(s) may include a personal computer (PC), a laptop, a tablet, a smart phone, a network server, etc. The load control system configuration tool may be a standalone tool/system and/or a system where the GUI software, logic engine, and database(s)/database management system(s), for example, execute on a computing system. The load control system configuration tool may be a distributed tool/system, or in other words, a system where the GUI software executes in whole or in part on a first computing system(s), the logic engine executes in whole or in part on another/second computing system(s), and the database(s)/database management system(s) execute in whole or in part on a third computing system(s) with each of the computing systems being networked over a wired and/or wireless communication system/network, and/or some combination thereof. The load control system configuration tool may be a web-based system, such that the logic engine and/or the database management system are executed on a remote computing device and information is communicated to/from a computing device executing GUI software locally. The load control system configuration tool may also interface via a communications system/network with one or more other systems (e.g., database(s)/database management system(s)) that may provide, for example, standard electrical devices and shade devices that a user may select and thus use to define and thus build/install the actual load control system.

For purposes of description only, user interactions with the load control system configuration tool will be described herein from the perspective of a keyboard and a mouse/mouse cursor (e.g., a pointer), and actuations of one more mouse buttons (e.g., the user using a mouse to move a cursor over a desired icon/feature of a GUI window and activating the feature/icon through one or more mouse clicks/actuations). Nonetheless, one will recognize that the configuration tool may not be limited to user interactions via a keyboard and mouse and a user may interact with the configuration tool in other manners including voice commands, touchscreen, etc. In addition, movement of a mouse pointer, actuation of a mouse buttons and/or key board keys may be viewed as the user entering commands to the configuration tool, and the configuration system detecting or receiving such commands or indications thereof.

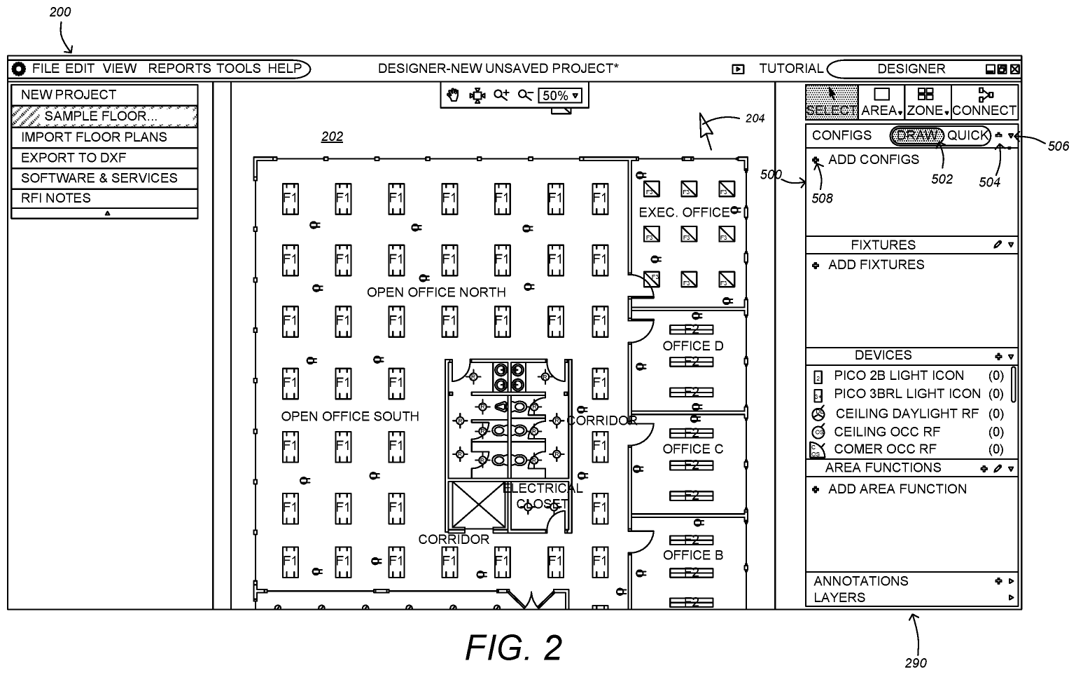

FIGS. 2-25 illustrate an example GUI-based window 200 that may be displayed on a visual display of one or more computing device(s) of a system (e.g., a design system) by a software (e.g., design software) to a user. The computing device(s) of the design system may execute the design software to allow for the design and/or configuration of a load control system (e.g., a building control system), such as the load control system 100 shown in FIG. 1.

The software (e.g., design software) may display a canvas 202 on which electrical devices (e.g., control devices of the load control system) may be illustrated. A user of the software may interact with the elements of the software using a cursor 204 (e.g., by manipulating a mouse or other input device to move the cursor). The canvas 202 may display a floorplan (not shown) and the control devices of the load control system may be located at the appropriate locations on the floorplan.

The software may display a palette 290 that may be located, for example, to the right of the canvas 202, as shown in FIG. 2. The palette 290 may allow and/or enable a user to define/configure electrical loads and/or fixtures (hereinafter referred to as fixtures), to define and/or configure control devices (hereinafter referred to as devices), and to define/configure as shades. The palette 290 may also allow the user to select defined fixtures, devices, and shades, and to place graphical representations (hereinafter generally referred to as icons, although other representations may be used) of selected fixtures, devices, and/or shades within canvas 202 for defining a graphical representation of a load control system. The canvas 202 may be a workplace and/or workspace on which a user may define, design, layout, and/or configure a graphical representation of a load control system by placing icons of fixtures, devices, and shades selected from the palette 290, and by further configuring such fixtures, devices, and shades (such configuration may include, for example, generating graphical representations of connections and/or associations between selected fixtures, devices, and shades). Hereinafter, the terms canvas, workplace, and workspace will be used interchangeably refer to canvas 202. In general, the fixtures, devices, and shades placed within the canvas 202 and the configuration thereof may define at least in part a desired load control system for a load control environment. Again, a user may interact with the window 200 (e.g., define, select, place, and configure fixtures, devices, and shades) using one or more of a mouse, trackball, touch sensitive screen, keyboard, speaker/receiver, etc.

As shown in FIG. 2, the palette 290 may be generated by a control circuit of one or more computing device(s). The palette 290 may include a configurations pane 500, which may allow a user to define and/or configure specific configurations (e.g., templates) for the load control system, to select instances of defined configurations, and to place the configurations (e.g., icons representing the configurations and/or icons representing the fixtures and devices of the configurations) within the canvas 202. The configurations pane 500 may include a draw/quick selection tool 502, an add configuration icon 504, and an expand contract icon 506. The add configuration icon 504 may allow a user to select and/or define one or more configurations to be added to the configurations pane 500. An add configuration icon 508 on the configurations pane 500 may also provide a similar function as the add configuration icon 504.

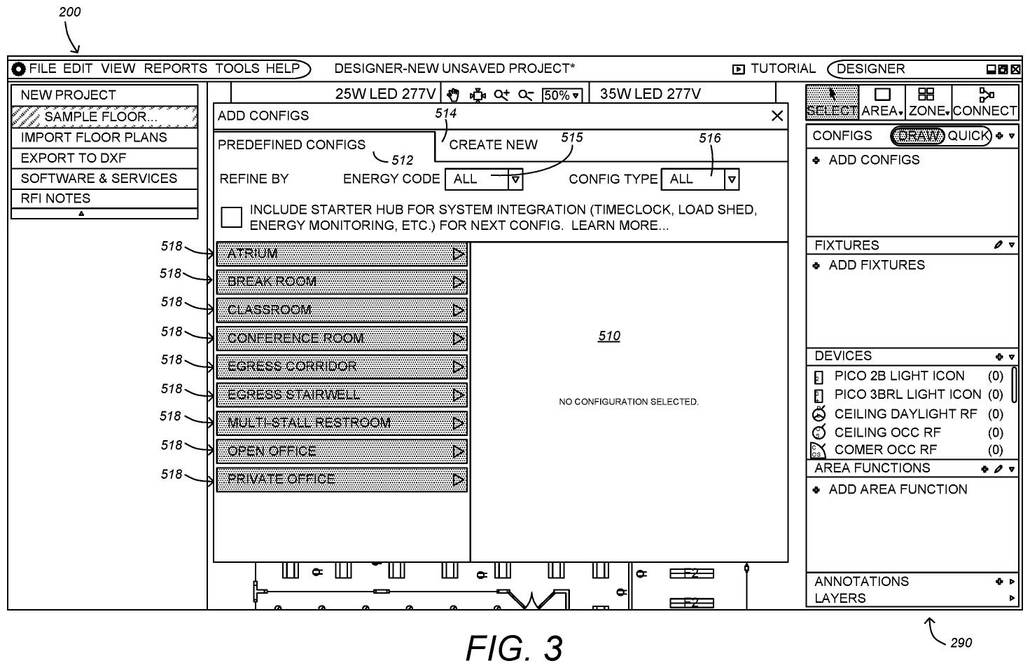

Upon selection of either of the add configuration icon 504 and/or the add configuration icon 508, the control circuit of the computing device(s) of the design system may display a configurations selection window 510 as shown in FIG. 3. The configurations selection window 510 may include a predefined configurations tab 512 that may allow for the selection of one or more predefined configurations and a create new tab 514 that may allow for the creation of additional configurations. When the predefined configurations tab 512 is selected, the configurations selection window 510 may display an energy code selection tool 515, a configuration type selection tool 516, and one or more room configuration types 518 (which may be collapsed as shown in FIG. 3). The configurations selection window 510 may display one or more possible configurations in response to selections of the energy code selection tool 515, the configuration type selection tool 516, and the room configuration types 518. For example, the energy code selection tool 515 may allow for the selection of one of a plurality of energy codes (e.g., ASHRA 90.1-2016, IECC-2015, Title 24-2016, etc.) to narrow down the possible configurations to be displayed on the configurations selection window 510. The configuration type selection tool 516 may allow for the selection of one or more configuration types (e.g., retrofit, new construction, etc.) to further narrow down the possible configurations.

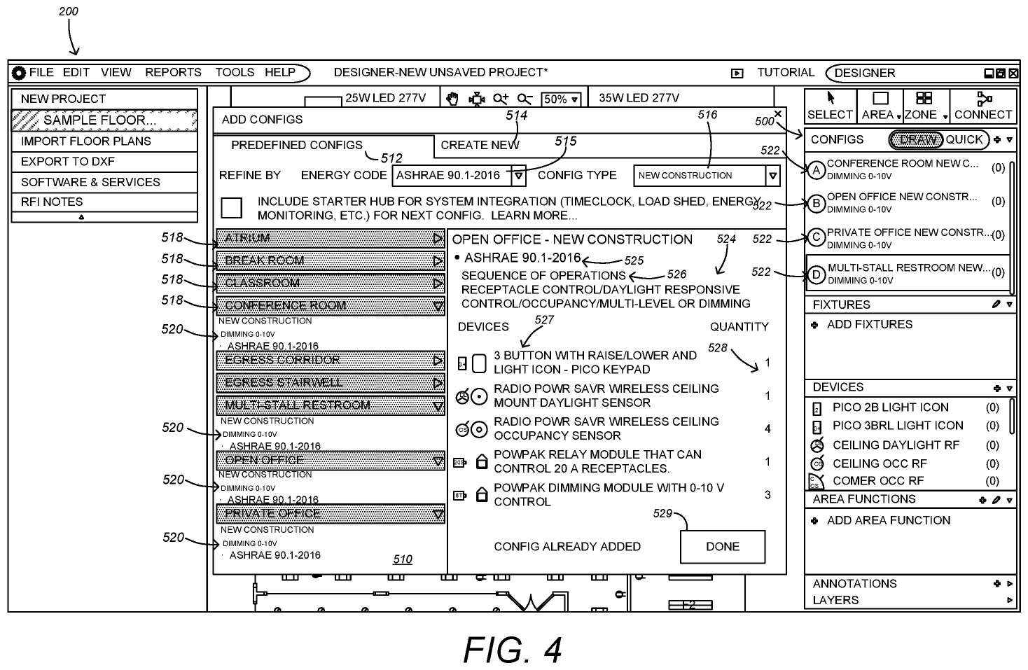

Once an option of the energy code selection tool 515 and an option of the configuration type selection tool 516 have been selected, the user may select one or more of the room configuration types 518 to display corresponding configurations 520 as shown in FIG. 4. Upon the selection of the configurations 520, corresponding configuration icons 522 may be added to the configurations pane 500. In addition, for the last selected one of the configurations 520, the configurations selection window 510 may display a configuration description pane 524. The configuration description panel 524 may display a title 525 that summarizes the selections of the energy code selection tool 515, the configuration type selection tool 516, and the room configuration types 518 for the selected configuration. The configuration description panel 524 may display a sequence of operations 526 that summarizes the various control requirements for the selected configuration, a list of devices 527 that may be recommended and/or required for the selected configuration, and a recommended quantity 528 of those devices. The configuration selection window 510 may close upon the selection of a done button 529 (e.g., when the user has added configuration icons 522 for all of the desired configurations to the configurations pane 500).

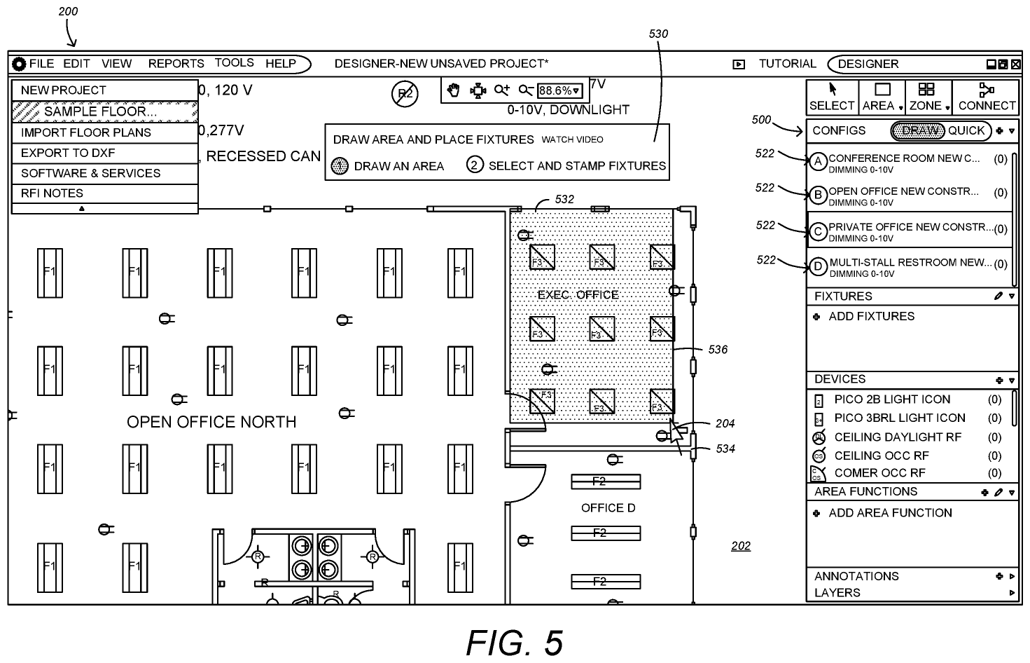

The configurations may be added to the canvas 202 by the control circuit of the computing device(s) of the design system upon selection of the configuration icons 522 in a draw configuration mode and a quick-add configuration mode. The control circuit of the computing device(s) of the design system may switch between the draw configuration mode and the quick-add configuration mode in response to the draw/quick selection tool 502 of the configurations pane 500. When one of the configuration icons 522 is selected in the draw configuration mode (e.g., the private office new construction configuration icon), the control circuit of the computing device(s) of design system may display a draw configuration prompt window 530 as shown in FIG. 5. The draw configuration prompt window 530 may instruct the user to draw an area in which the deploy the configuration. The user may use the cursor 204 to click on a first corner 532 of an area (e.g., an office) and drag the cursor towards a second opposing corner 534 of the office as shown in FIG. 5. The control circuit of the computing device(s) of the design system may display a rectangle 536 defining the area on the canvas 202.

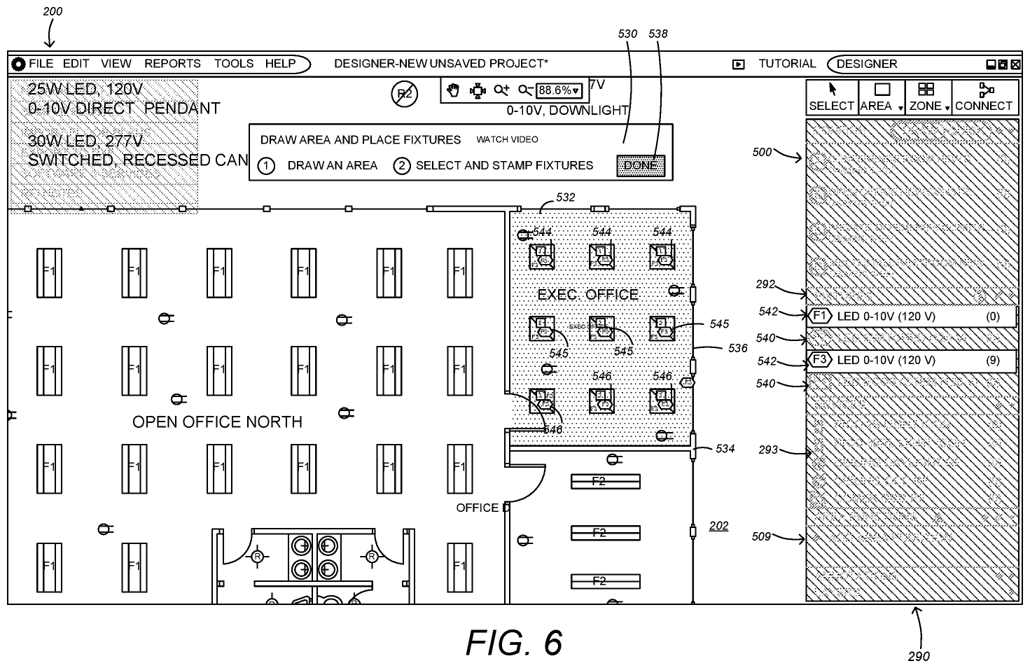

When the user clicks on the second corner 534 of the office using the cursor 204, the draw configuration prompt window 530 may instruct the user to select and place fixtures as shown in FIG. 6. The control circuit of the computing device(s) of the design system may block (e.g., automatically block) the panes of the palette 290 other than a fixture pane 292 (e.g., the configurations pane 500, a devices pane 293, an area functions pane 509, etc.) by “graying-out” those panes, which may prevent the user from selecting icons in the panes other than the fixture pane. The control circuit of the computing device(s) of the design system may also block icons of fixtures in the fixture pane 292 that are unable to be controlled by the load control devices that are a part of the selected configuration to prevent the user from selecting those fixture icons. For example, as shown in FIG. 6, the control circuit of the computing device(s) of the design system may grey-out first fixture icons 540 that are unable to be controlled by the load control devices that are a part of the selected configuration, which may maintain second fixture icons 542 that are not grayed-out to be selected by the user.

After the user has selected one of the second fixture icons 542 in the fixture pane 292, the user may place fixture icons 544, 545, 546 inside of the rectangle 536 that defines the area for the selected configuration on the canvas 202 as shown in FIG. 6. For example, the top row of fixture icons 544 may be connected to a first electrical circuit, the middle row of fixture icons 545 may be connected to a second electrical circuit, and the bottom row of fixture icons 546 may be connected to a third electrical circuit. When the user is done placing the fixture icons 544, 545, 546 on the canvas 202, the user may select a done button 538 on the draw configuration prompt window 530.

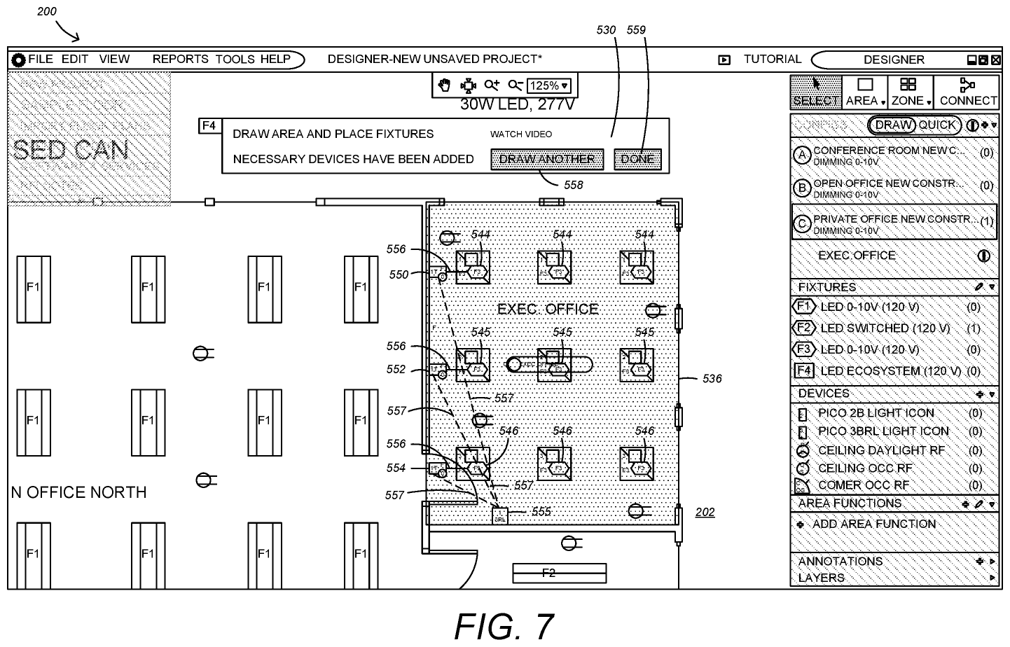

Upon the selection of the done button 538, the control circuit of the computing device(s) of the design system may place (e.g., automatically place) device icons, such as load control device icons 550, 552, 554 and a remote control device icon 552 inside of the rectangle 536 that defines the area for the selected configuration on the canvas 202 as shown in FIG. 7. The control circuit of the computing device(s) of the design system may be configured to determine the number of each device icon to place on the canvas 202 based on the quantities of the devices listed on the configuration description panel 524 of the configuration selection window 510 for the selected configuration. The control circuit of the computing device(s) of the design system may also determine the number of load control device icons 550, 552, 554 to place on the canvas 202 based on the number of fixture icons 544, 545, 546 and/or electrical circuits established by the fixture icons in the rectangle 536 that defines the area for the selected configuration. For example, as shown in FIG. 7, the control circuit of the computing device(s) of the design system may determine to place three load control device icons 550, 552, 554 since the user defined three electrical circuits for the fixture icons 544, 545, 546 in the rectangle 536 that defines the area for the selected configuration.

The control circuit of the computing device(s) of the design system may also create (e.g., automatically create) relationships between the fixtures and the devices and/or between the devices in response to the selection of the done button 538 on the draw configuration prompt window 530. For example, the control circuit of the computing device(s) of the design system may automatically draw lines 556 between each of the load control device icons 550, 552, 554 and at least one of the fixture icons 544, 545, 546 of the respective electrical circuits. The relationships defined by the lines 556 may be similar to the relationship defined by the line 234 between an icon (e.g., representing an electrical load) and another icon (e.g., representing a load control device), and may each represent an electrical connection for supplying power from the load control device to the electrical load and/or a communication link for allowing the load control device to control the electrical load. The control circuit of the computing device(s) of the design system may also automatically draw lines 557 between each of the load control device icons 550, 552, 554 and the remote control device icon 550. The relationships defined by the lines 557 may be similar to the relationship defined by a line between a third icon (not shown) and a fourth icon (not shown) and may each represent a wireless communication link (e.g., an association between wireless control devices). The control circuit of the computing device(s) of the design system may store in memory the information defining the relationships between the fixtures and the devices and/or between the devices of the selection configuration. The user may move the device icons with in the rectangle 536 after the control circuit of the computing device(s) of the design system automatically places the device icons on the canvas 202. When the user has completed configuring the system configuration in the present area, the user may select a draw another area button 558 to draw another area using the presently selected configuration or may select a done button 559 to choose another configuration icon 522 from the configuration pane 500 to place on the canvas 202.

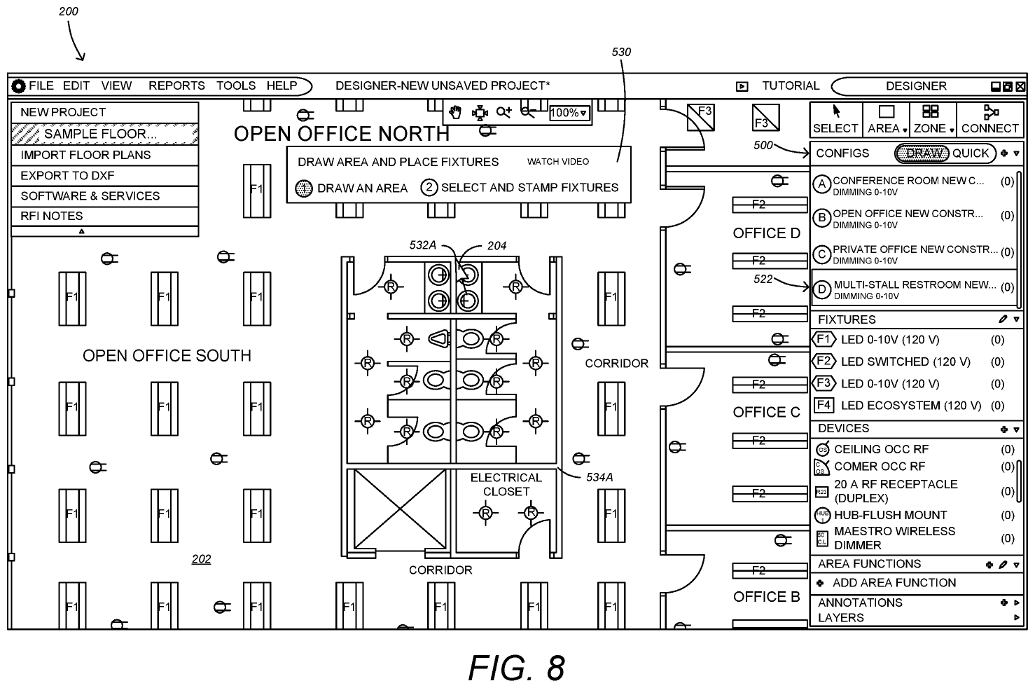

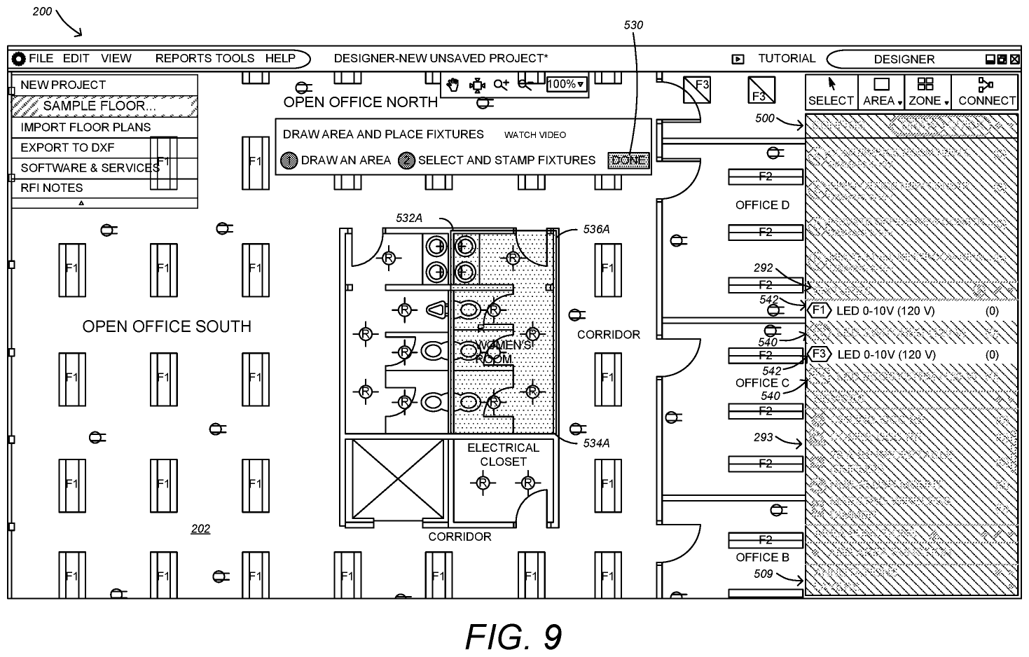

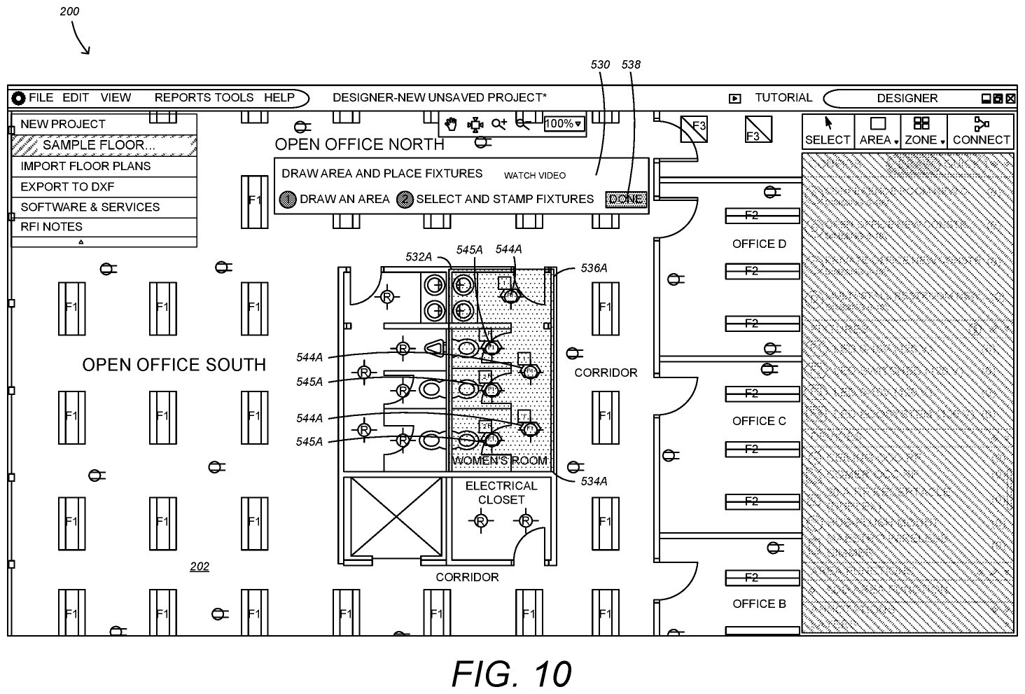

If the user selects the done button 559 from the draw configuration prompt window 530, the user may move the canvas 202 to show a different area of the floorplan and select another configuration icon 522, such as the multi-stall restroom new construction configuration, as shown in FIG. 8. The control circuit of the computing device(s) of the design system may display the draw configuration prompt window 530 on the display via the GUI. The user may use the cursor 204 to click on a first corner 532a of an area (e.g., a bathroom) and drag the cursor towards a second opposing corner 534a of the office to draw a rectangle 536a defining the area on the canvas 202 as shown in FIG. 9. The control circuit of the computing device(s) of the design system may once again block (e.g., automatically block) the panes of the palette 290 other than the fixture pane 292 to prevent the user from selecting icons in the configurations pane 500, the devices pane 293, an area functions pane 509, etc. The control circuit of the computing device(s) of the design system may also once again block icons of fixtures in the fixture pane 292 that are unable to be controlled by the load control devices that are a part of the selected configuration to prevent the user from selecting those fixture icons. The user may select the second fixture icons 542 that are unblocked and place fixture icons 544a, 545a inside of the rectangle 536a that defines the area for the selected configuration on the canvas 202 as shown in FIG. 10. For example, the fixture icons 544a may be connected to a different electrical circuit than the fixture icons 545a. When the user is done placing the fixture icons 544a, 545a on the canvas 202, the user may select the done button 538 on the draw configuration prompt window 530.

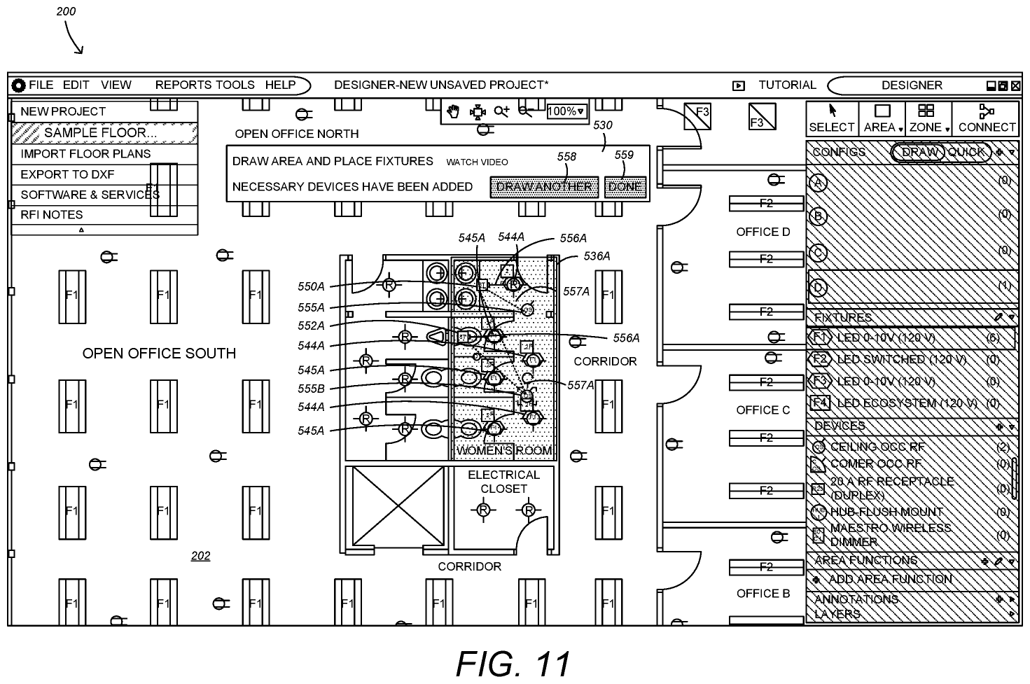

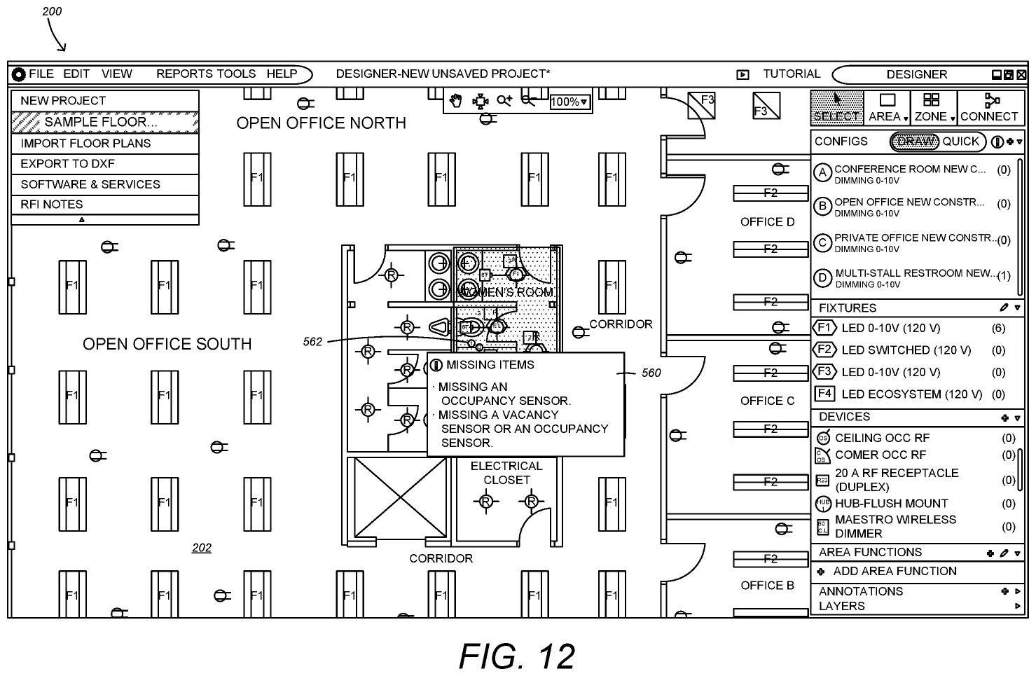

In response to receiving the selection of the done button 538, the control circuit of the computing device(s) of the design system may automatically place the load control device icons 550a, 552a and sensor device icon 555a, 555b inside of the rectangle 536a that defines the area for the selected configuration on the canvas 202 as shown in FIG. 11. The control circuit of the computing device(s) of the design system may be configured to determine the number of each device icon to place on the canvas 202 based on the quantities of the devices listed on the configuration description panel 524 of the configuration selection window 510 for the selected configuration. The control circuit of the computing device(s) of the design system may also determine the number of load control device icons 550a, 552a to place on the canvas 202 based on the number of fixture icons 544a, 545a and/or electrical circuits established by the fixture icons in the rectangle 536a that defines the area for the selected configuration. For example, as shown in FIG. 12, the control circuit of the computing device(s) of the design system may determine to place two load control device icons 550a, 552a since the user defined two electrical circuits for the fixture icons 544a, 545a in the rectangle 536a that defines the area for the selected configuration.

The control circuit of the computing device(s) of the design system may automatically create relationships between the fixtures and the devices and/or between the devices in response to the selection of the done button 538 on the draw configuration prompt window 530. For example, the control circuit of the computing device(s) of the design system may automatically draw lines 556a (e.g., similar to the lines 556 of FIG. 7) between each of the load control device icons 550a, 552a and at least one of the fixture icons 544a, 545a of the respective electrical circuits. The control circuit of the computing device(s) of the design system may also automatically draw lines 557a (e.g., similar to the lines 557 of FIG. 7) between each of the load control device 550a, 552a and each of the sensor devices 555a, 555b. The user may move the device icons with in the rectangle 536a after the control circuit of the computing device(s) of the design system automatically places the device icons on the canvas 202.

As previously mentioned, each configuration may include one or more different types of devices (e.g., a particularly load control device, a particular remote control device, and/or a particular sensor device) as defined by the list of devices 527 on the configuration description panel 524 of the configuration selection window 510. If the rectangle 536a excludes at least one of the required device types, the control circuit of the computing device(s) of the design system may display a warning window 560 as shown in FIG. 12. For example, the sensor device icons 555a, 555b may be deleted from the rectangle 536a as shown in FIG. 12. In addition, the control circuit of the computing device(s) of the design system may display a warning icon 562 in the rectangle 536a. If sensor device icons are added back to the rectangle 536a, the warning window 560 and/or the warning icon 562 may be removed. For example, the sensor device icon 555a (e.g., representing a ceiling-mounted occupancy sensor) may be added back to the rectangle 536a along with a sensor device icon 555c (e.g., representing a different type of occupancy sensor, such as a corner wall-mounted occupancy sensor). Even though the ceiling-mounted occupancy sensor may be specified in the list of devices 527 on the configuration description panel 524 of the configuration selection window 510 for the selected configuration, other types of occupancy sensors (e.g., such as the corner wall-mounted occupancy sensor) may satisfy the requirement for the device type of the selected configuration.

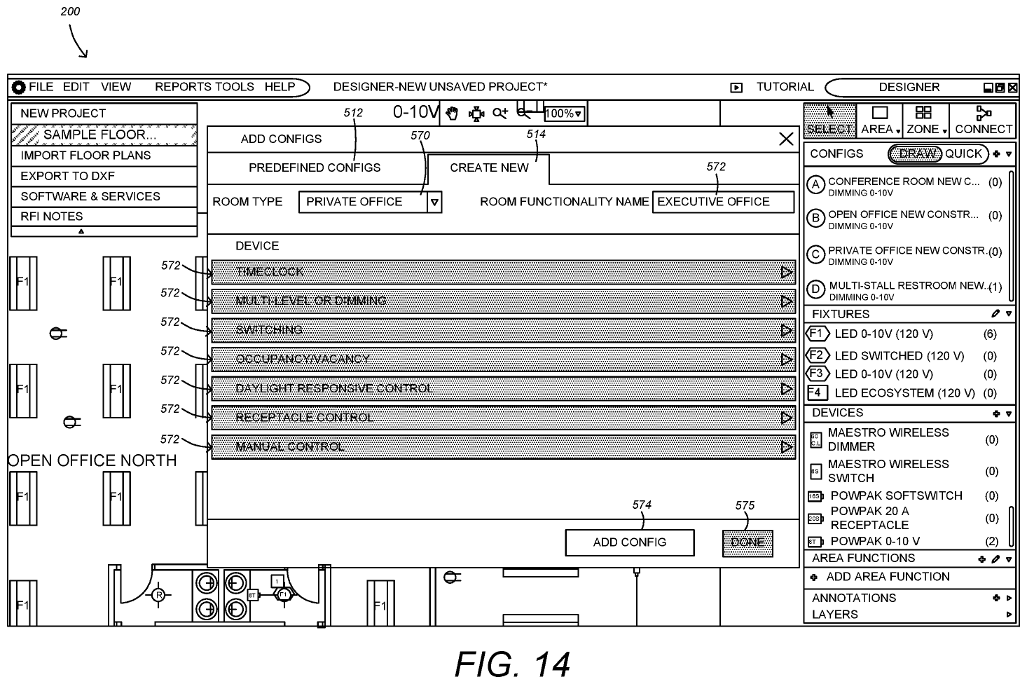

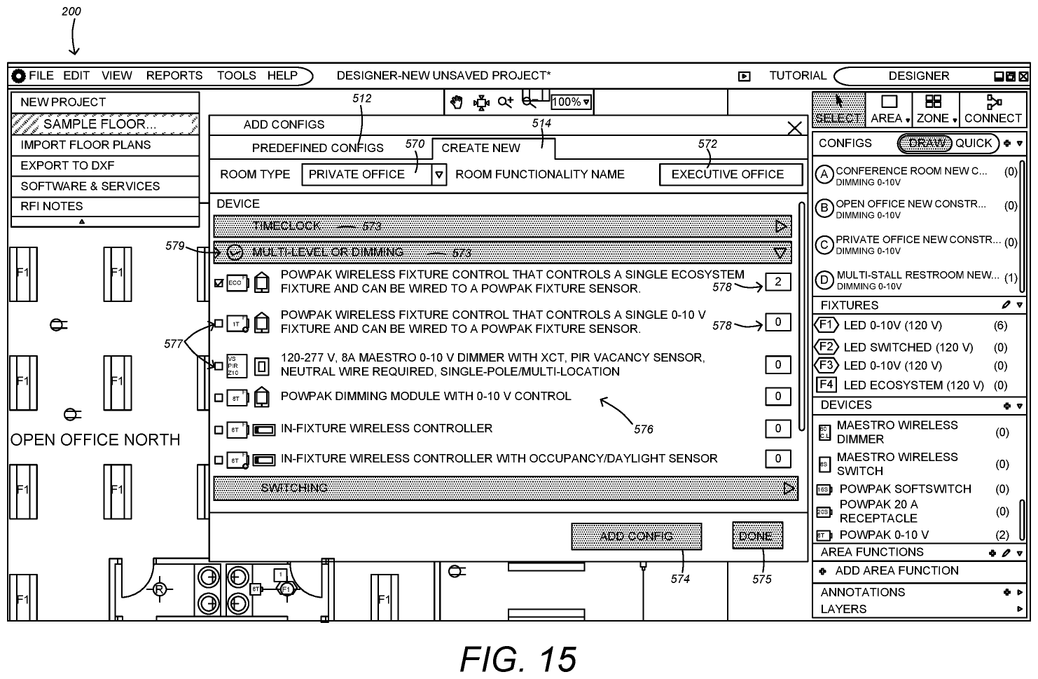

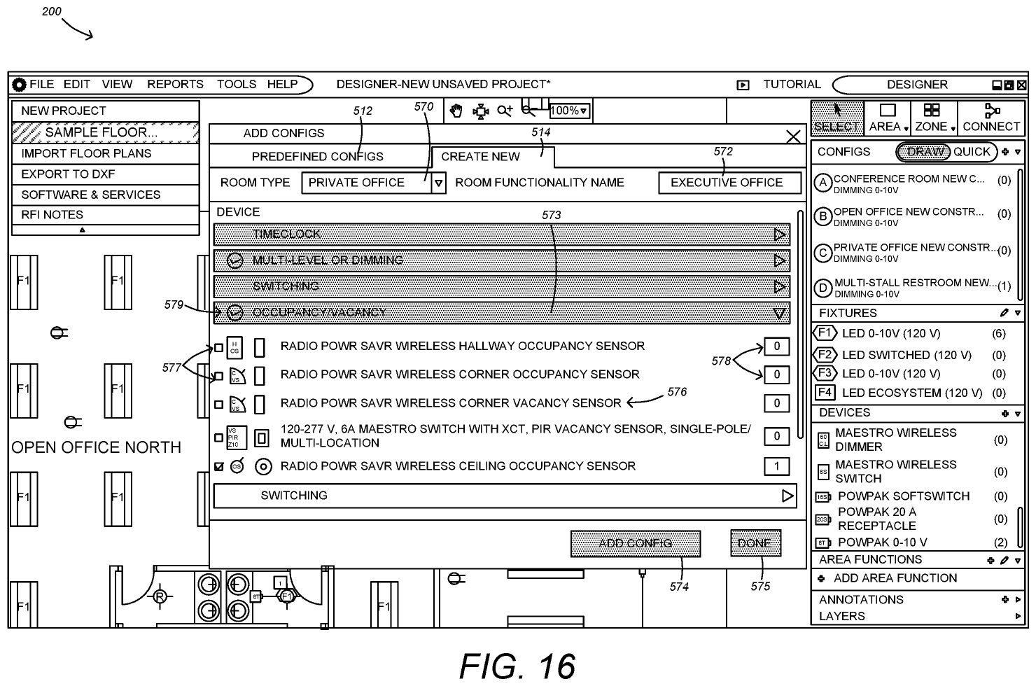

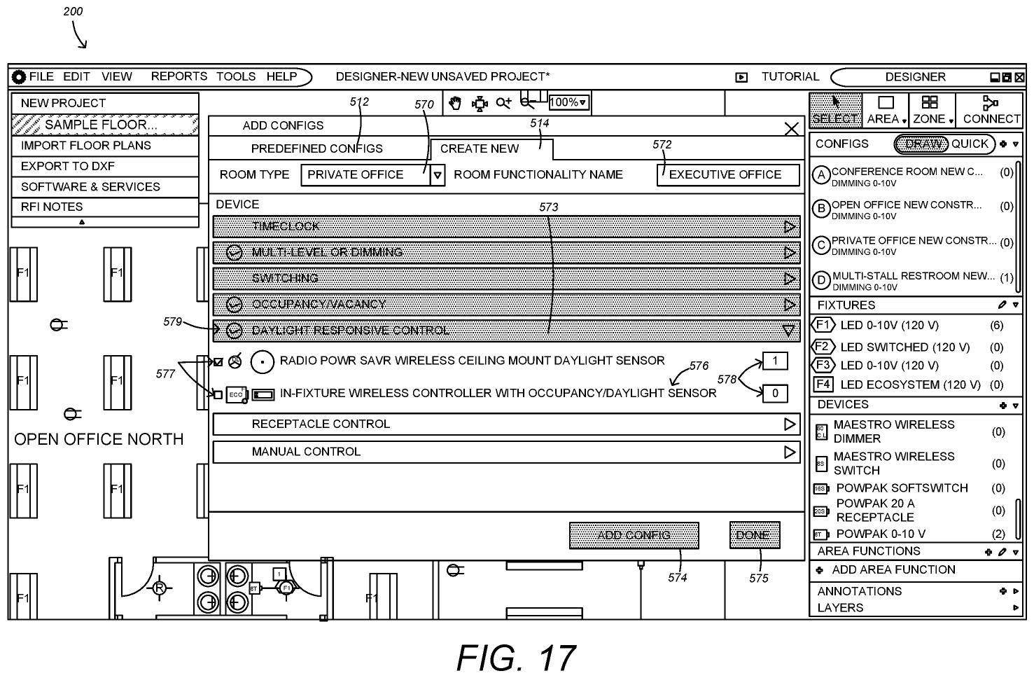

When the create new tab 514 of the configurations selection window 510 is selected, the configurations selection window 510 may display a room type selection tool 570, a room functionality name field 572, and one or more device types 573 (which may be collapsed) as shown in FIG. 14. The configurations selection window 510 may also display an add configuration button 574 and a done button 575. For example, the room type selection tool 570 may allow for the selection of one of a plurality of room types for which to create another configuration. The room functionality name field 572 may allow the user to enter a unique name and/or function associated with the configuration that is being created. When one of the device types 573 is selected (e.g., multi-level or dimming device type) as shown in FIG. 15, the window may expand to display a list of devices 576 of the selected device type that may be added to the configuration being created. Each device in the list of devices 576 may have a respective check box 577 and a respective quantity field 578. The user may select one of the devices of the list of devices 576 by checking the respective check box 577 and may adjust the recommended quantity for that device by entering a number in the respective quantity field 578. When at least one of the devices of the list of devices 576 of the selected device type 573 is checked, a check icon 579 may be displayed next to the name of the selected device type. The user may select another device type (e.g., occupancy/vacancy device type) to display the list of devices 576 for that device type as shown in FIG. 16. The user may select another device type (e.g., daylight responsive control device type) to display the list of devices 576 for that device type as shown in FIG. 17. When the user is done configuring the current load control system configuration, the user may click on the add configuration button 574 to add the configuration to the configuration pane 500 and create another configuration having additional load control details or may click on the done button 575 to add the configuration to the configuration pane 500 and close the configurations selection window 510.

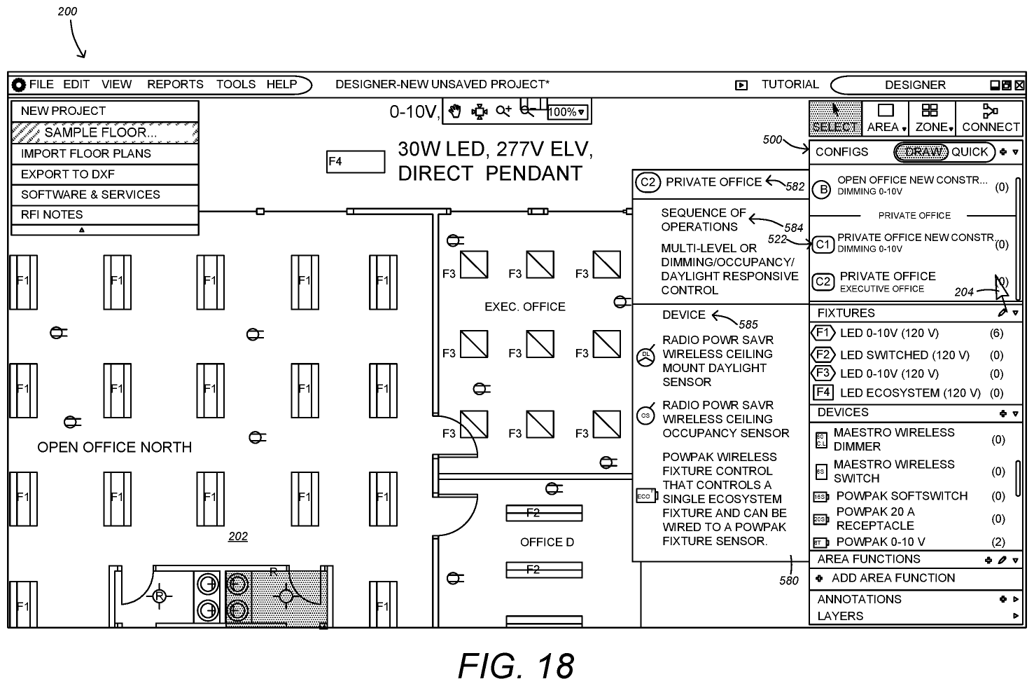

If the user hovers the cursor 204 over one of the configuration icons 522 in the configuration pane 500 for a predetermined amount of time identified by the control circuit of the computing device(s) of the design system (e.g., the configuration icon for the created executive office configuration), the control circuit of the computing device of the design system may display a configuration info window 580 as shown in FIG. 18. The configuration info window 580 may display a room type section 582, a sequence of operations section 584, and a devices section 585 for the configuration icon 522 over which the cursor is hovering.

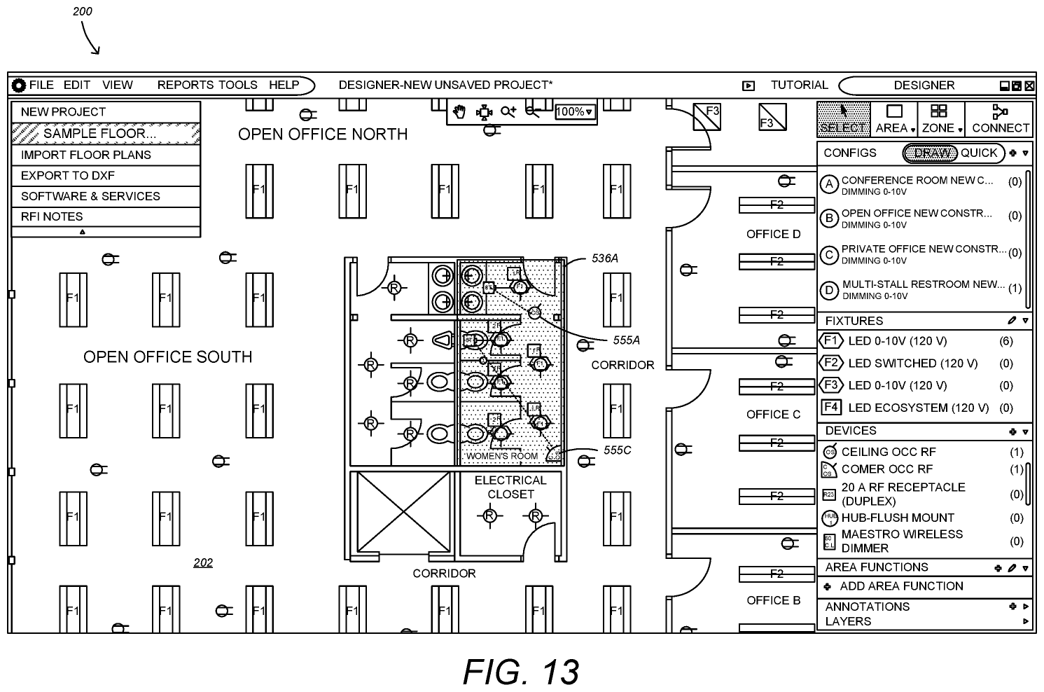

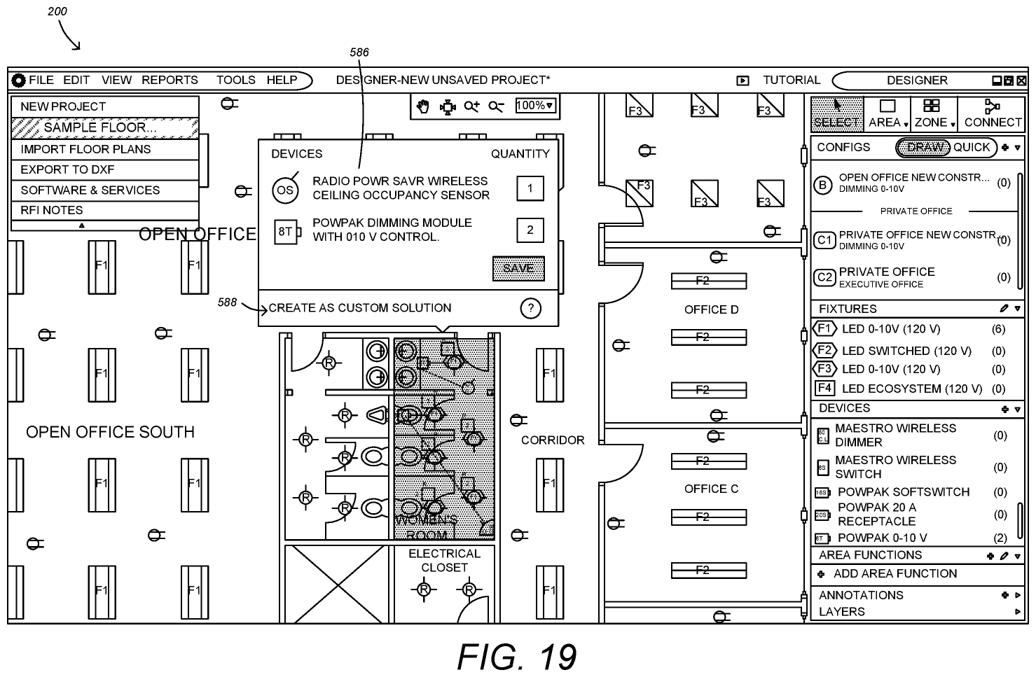

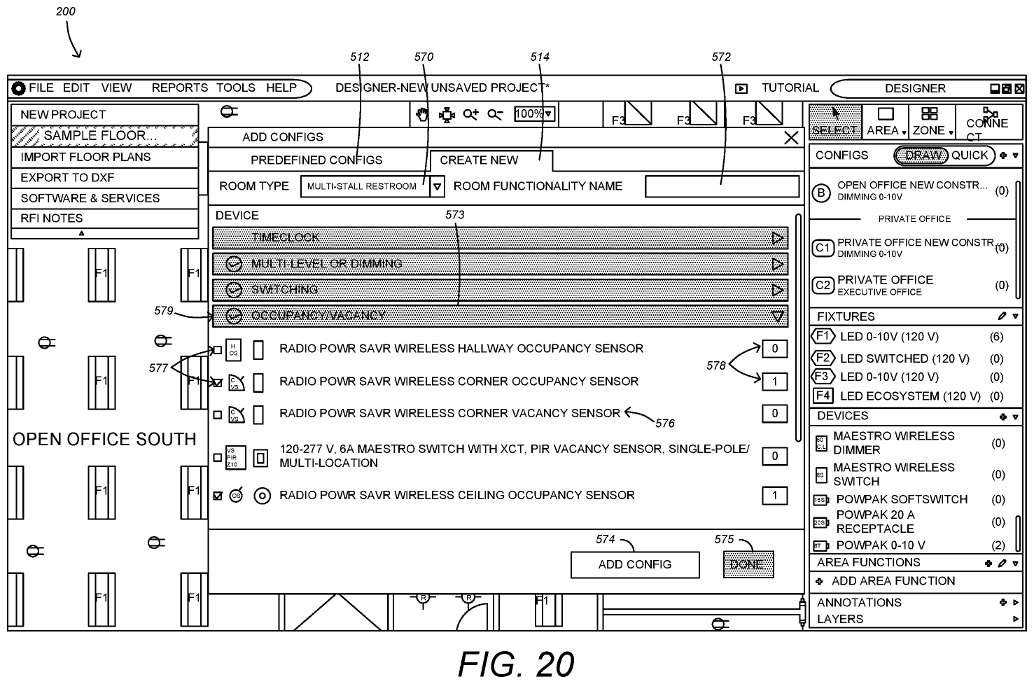

As previously described with reference to FIG. 13, the user may edit the type of devices in one of the configurations on the canvas 202, for example, by adding the sensor device icon 555c representing the corner wall-mounted occupancy sensor. Referring to FIG. 19, the user may save an edited configuration in memory of the computing device(s) of the control system as a configuration by right-clicking on the area, which may cause a configuration edit window 586 to be generated by the control circuit of the computing device(s) of the design system as shown in FIG. 19. The configuration edit window 586 may display a “create as custom configuration” option 588. In response to a selection of the “create as custom configuration” option 588, the control circuit of the computing device(s) of the design system may display the create new tab 514 of the configurations selection window 510 with the devices of the edited configuration selected as shown in FIG. 20.

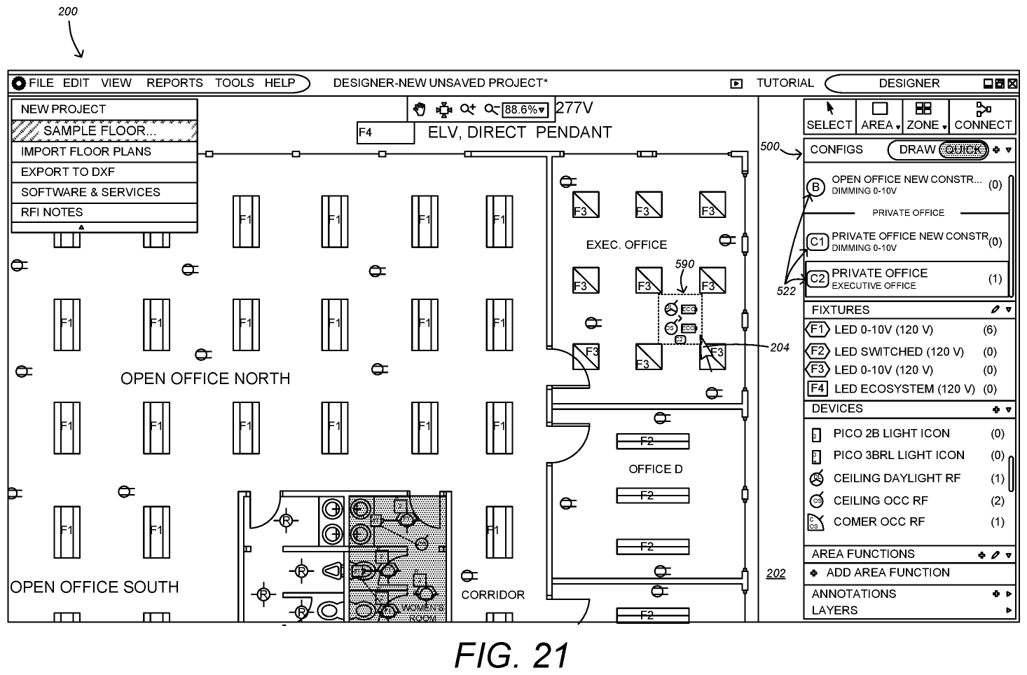

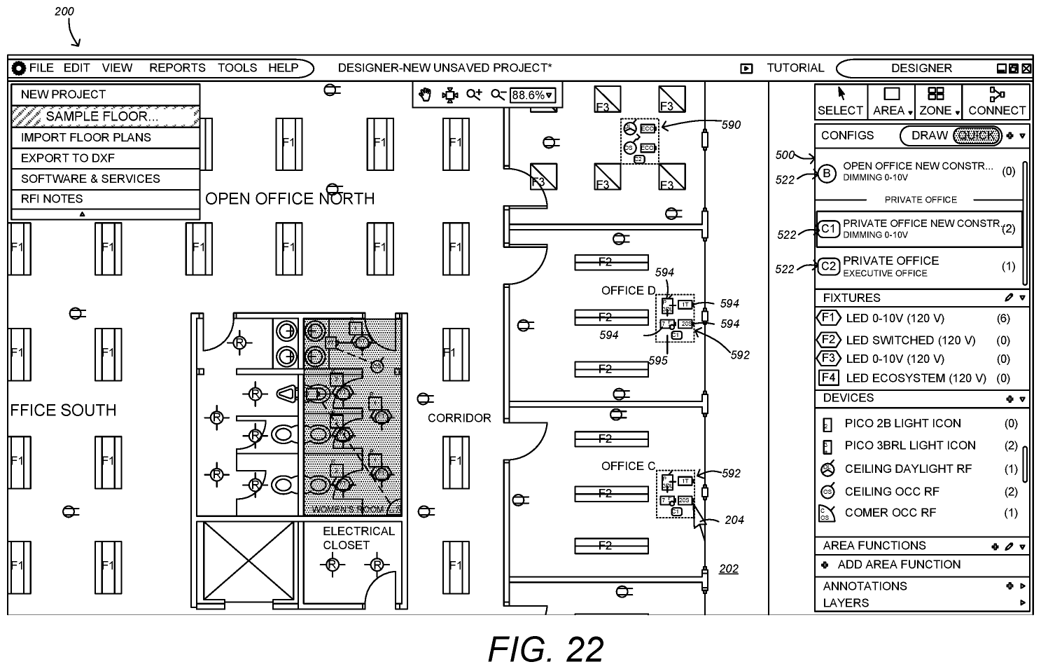

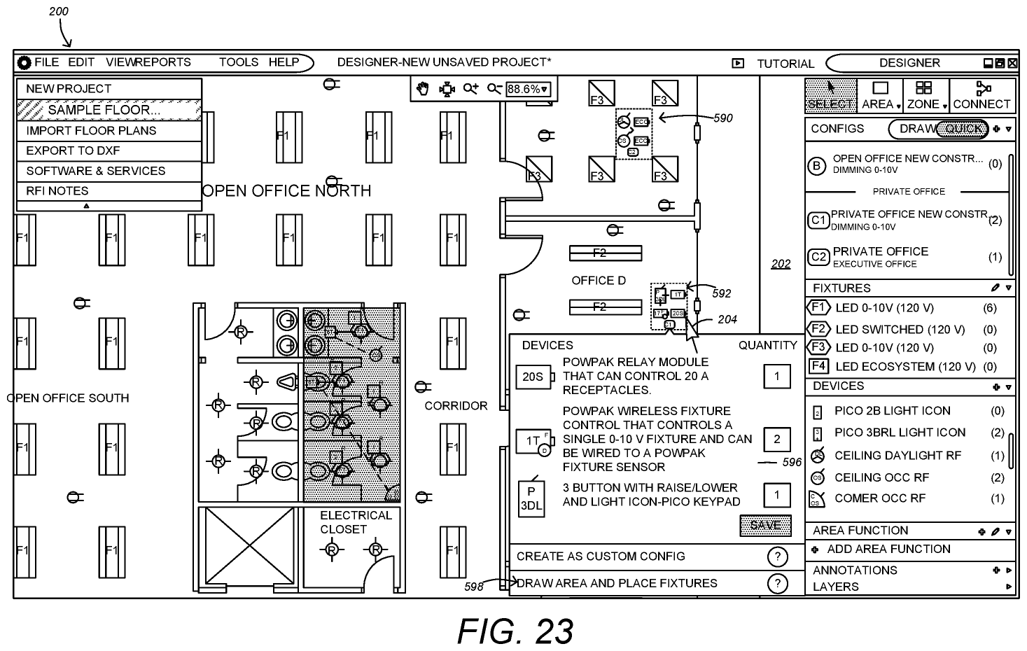

The user may switch to the quick-add configuration mode using the draw/quick selection tool 502 of the configurations pane 500. When one of the configuration icons 522 is selected when the control circuit of the computing device(s) of the design system is operating in the quick-add configuration mode (e.g., the configuration icon for the created executive office configuration), the user may be able to place one or more configuration group icons 590 for the selected configuration on the canvas 202 using the cursor 204 as shown in FIG. 21. The user may select another one of the configuration icons 522 when the control circuit of the computing device(s) of the design system is operating in the quick-add configuration mode (e.g., the configuration icon for the private office new construction configuration) and place one or more configuration group icons 592 for the selected configuration on the canvas 202 as shown in FIG. 22. Each configuration group icon 590, 592 may include device icons 594 (e.g., the load control device icons, the remote control device icons, and/or the sensor device icons) for the selected configuration located inside of a respective frame 595. The user may resize the frame 595 of each configuration group icon 590, 592 to make the frame bigger or smaller. The user may move the device icons 594 around inside of each frame 595. The user may right-click on one of the configuration group icons 592 to cause the control circuit of the computing device(s) of the design system to display a configuration edit window 596 to appear as shown in FIG. 23. The configuration edit window 596 may display a “draw area and place fixtures” option 598. In response to a selection of the “draw area and place fixtures” option 598, the control circuit of the computing device(s) of the design system may switch to the draw configuration mode to allow the user to draw the area for the selected configuration (e.g., as shown in FIG. 5) and place fixture icons for the area (e.g., as shown in FIG. 6).

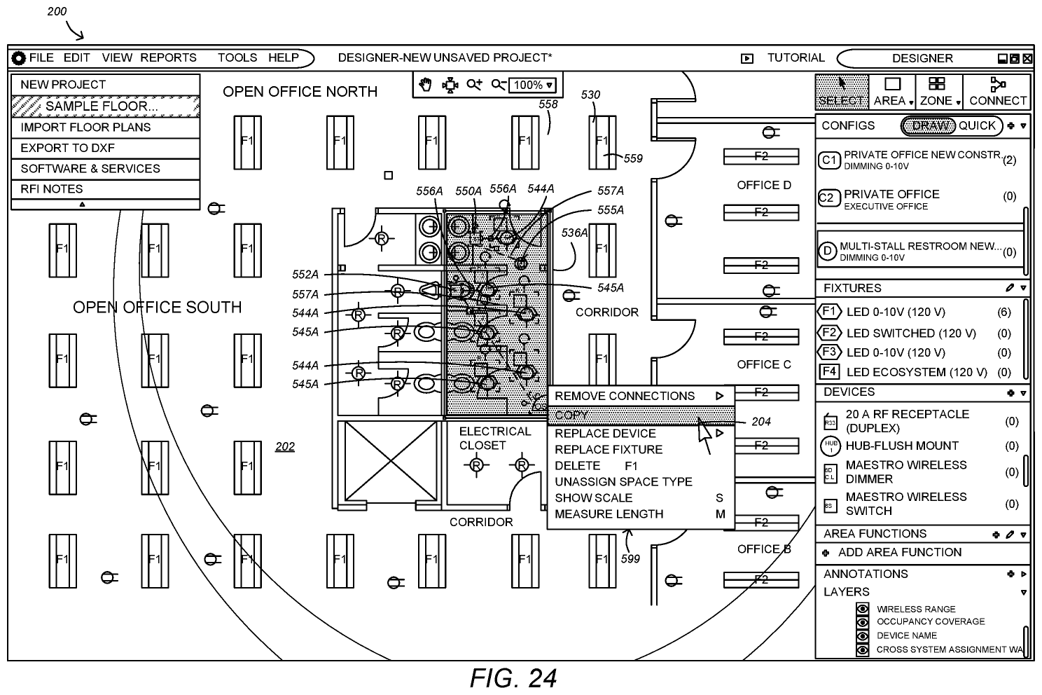

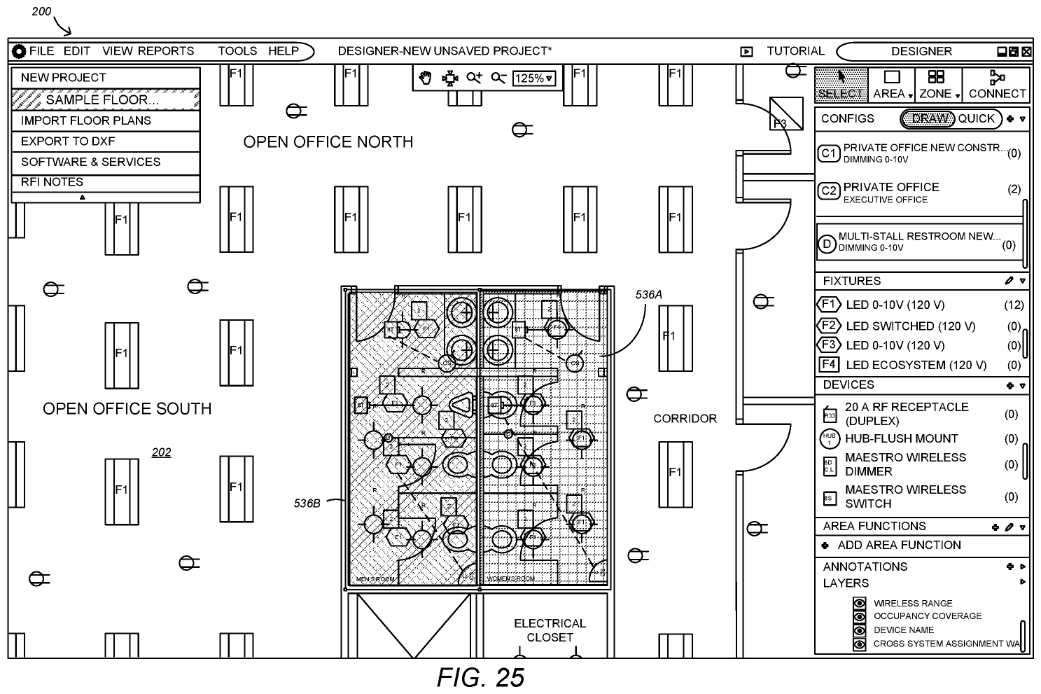

The user may also copy a configuration (e.g., the areas, fixture icons, and device icons associated with the configuration) on the canvas 202. As shown in FIG. 24, the user may select an entire configuration on the canvas 202 using the cursor 204 and right-click on the selected configuration to cause the control circuit of the computing device(s) of the design system to display an options menu 599 on the display via the GUI. The user may select “copy” from the options menu 599 to cause a copy 536b of the rectangle 536a to be displayed on the canvas 202. The user may move the copy 536b of the rectangle 536a to a desired location, for example, over another bathroom on the canvas 202 as shown in FIG. 25.

The load control system configurations generated by the computing device(s) of the design system, including the load control details, described herein may be imported to a load control system configuration tool. The control circuit of the computing device(s) executing the configuration tool may further edit the load control system configurations (e.g., including the load control details) based on information from the user. Alternatively, or additionally, as will be described hereinafter, the load control system configurations, including the load control details defined therein, that may be generated by the computing device(s) executing the load control system configuration tool may be imported to the designer software executing on the computing device(s) of the design system, and the user may change the load control details via the designer software. For example, computing device(s) in a design system may generate load control system configurations, or portions thereof, for being imported to the load control system configuration tool executed by computing device(s) in the load control system configuration tool.

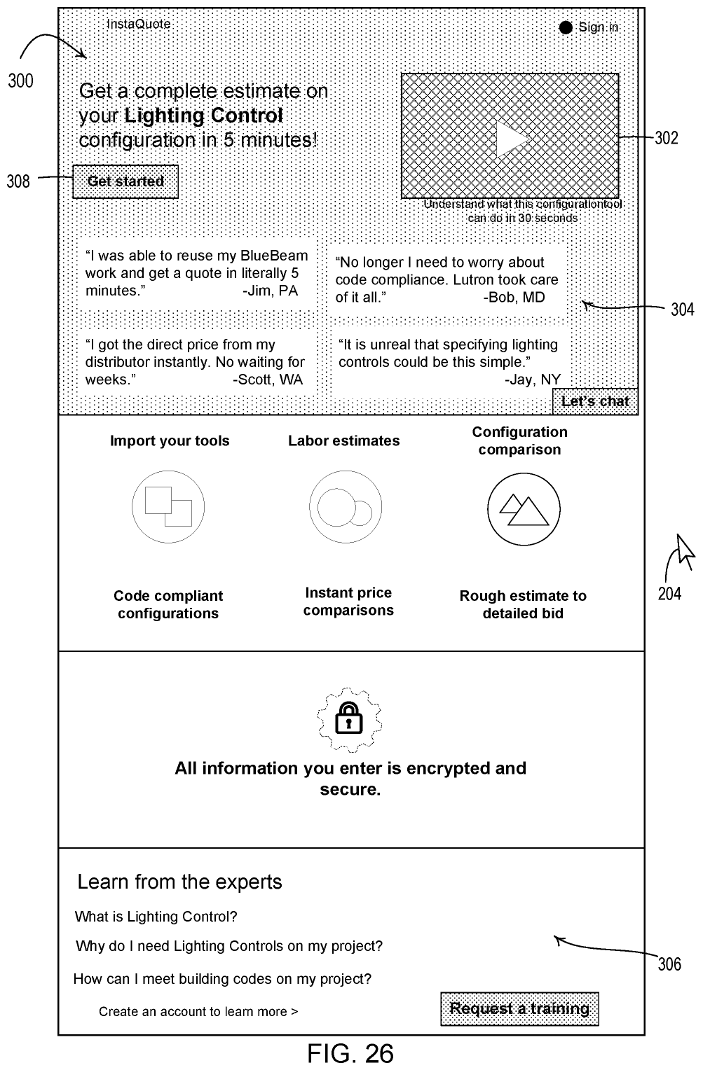

FIGS. 26-43C illustrate example graphical representations of a user interface that may be displayed on a visual display of a computing device executing a load control configuration system by a load control system configuration tool, e.g., a GUI software such as a load control system configuration tool software, for providing one or more load control system configurations. The load control system configurations may include details about control devices in a load control system (e.g., a building control system) for a project. As described herein, the load control details may include a list of devices, such as control devices (e.g., control-source devices and/or control-target devices), electrical loads, and/or connections between the devices. The control circuit of a network device may execute the load control configuration tool from instructions stored in memory. The control circuit executing the load control configuration tool may receive different levels of information in the load control details from a user and use the load control details from the load control system configurations to identify the devices and/or electrical loads to be implemented in a load control system or in a project to enable proper functionality in the load control system.

The load control details included in the load control system configurations may include associations between the devices (e.g., selecting and/or controlling the devices, such as control-source devices and/or control-target devices). For example, the load control details in the load control system configurations may include an estimated number of lighting fixtures for a space based on information about the size of the space/project form the user. The load control details in each of the load control system configurations may also include control-source devices, such as remote controls and/or sensors, associated with the lighting fixtures in the space. The load control details in each of the load control system configurations may include associations between each of the control-target devices and the control-source devices to allow for communications (e.g., load control instructions) between the devices for enabling load control. The load control details in each of the load control system configurations may include control instructions that correspond to a triggering event for controlling a control-target device. The triggering event may be an event identified at a control-source device (e.g., actuation of a button press, a sensor event, or another event at a control-source device). The triggering event may be a timer event identified at a control-source device, a system controller, and/or the control-target device. As described hereinafter, the load control system configurations may include corresponding load control details based on information about building functions, room types, lighting fixtures, building types, construction types, number of rooms/offices, and/or other information provided to the load control system configuration tool.

The load control system configuration tool (e.g., load control system configuration tool software) may be used by, for example, an electrical contractor, to quickly determine load control system configurations comprising load control details of a load control system for a project or a job prior to sale and installation. The load control system configuration tool may provide one or more load control system configurations based on the information about the project. The load control system configurations may include load control details about the project that identify control devices to be implemented for the project to function properly. The load control system configuration tool may also provide control-source devices for controlling the load control devices and/or control instructions for the control to be performed at the load control devices in response to different triggering events. The load control system configuration tool may provide an estimated cost and/or bill of materials for the project.

As shown in FIG. 26, the control circuit of the computing device(s) executing the load control system configuration tool may initially display an introduction screen 300 including an introduction of the configuration tool. The control circuit of the computing device(s) executing the configuration tool may provide an interactive tool, such as a cursor 204, and allow interaction between a user and the elements of the configuration tool. The load control system configuration tool may include information about the configuration tool. The introduction screen 300 may include an introductory video section 302 about the configuration tool. The introduction screen 300 may include feedback/review sections 304 from other users about the configuration tool. The introduction screen 300 may include resource sections 306, such as training resources. The training resources in the resource section 306 may include one or more resources for the user to use and learn more about the load control system 100 shown in FIG. 1, such as a lighting control, building codes, etc. The user may navigate the introduction screen 300 of the configuration tool. The control circuit of the computing device(s) executing the load control system configuration tool may begin processing information provided by a user to generate the load control details when the user clicks a button 308. Again, the control circuit of the computing device(s) executing the configuration tool may provide other interactive tools, such as a mouse, trackball, touch sensitive screen, keyboard, speaker/receiver, etc. The control circuit of the computing device(s) executing the configuration tool may allow the user to interact with the configuration tool, such as the introduction screen 300, to receive load control details on a project.

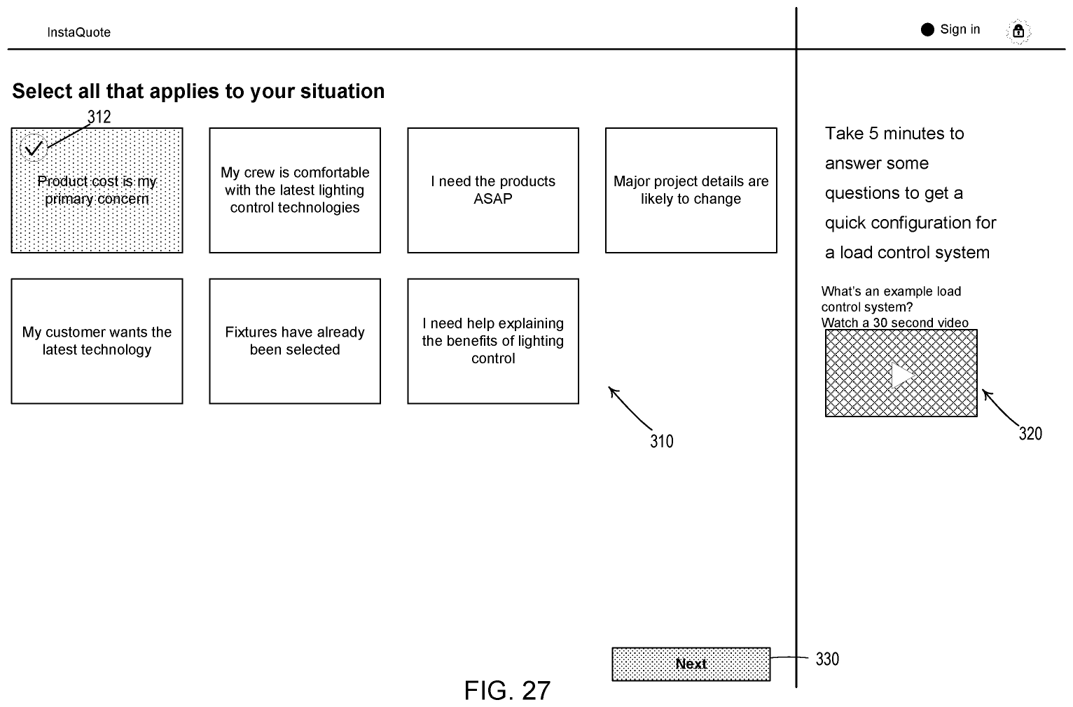

The load control system configuration tool may ask the user one or more questions about the project. Some load control details may be provided by the user in response to questions about the project provided to the user in the load control system configuration tool. Additional load control details may be generated in response to the load control details provided by the user. As illustrated in FIG. 27, the control circuit of the computing device(s) executing the configuration tool may ask the user to choose one or more tiles 310 that describes the situation about the project. The one or more tiles 310 may represent situations about the project. The control circuit of the computing device(s) executing the configuration tool may ask situations of the project including, but not limited to, budget flexibility, schedule flexibility, project detail flexibility, expertise on the latest lighting control technologies, expertise of the workers to handle the latest lighting control technologies, customer preferences on installing the latest lighting control technologies, information about the preexisting fixtures in the project, etc. The control circuit of the computing device(s) executing the configuration tool may receive one or more selections of tiles 310 that are applicable to the user/for the project. The control circuit of the computing device(s) executing the configuration tool may indicate the user selection on the applicable tiles via highlighting the box and/or providing an indicator, such as a check mark 312 shown in FIG. 27. The control circuit of the computing device(s) executing the configuration tool may update the selection that the user made on the tiles if the user deselects one or more selected tiles. For example, the user may select the tile again to deselect the tiles. The control circuit of the computing device(s) executing the configuration tool may provide additional resource sections 320 for the user to learn about products. The additional resource sections 320 may include, but not limited to an instructional video, a link to website, a tutorial webpage, and/or an instant chat with an expert. The control circuit of the computing device(s) executing the configuration tool may advance the configuration process based on the user selecting one or more tiles 310 that describe the situation of the project. For example, the control circuit of the computing device(s) executing the configuration tool may receive an input that indicates that the user clicked a next button 330.

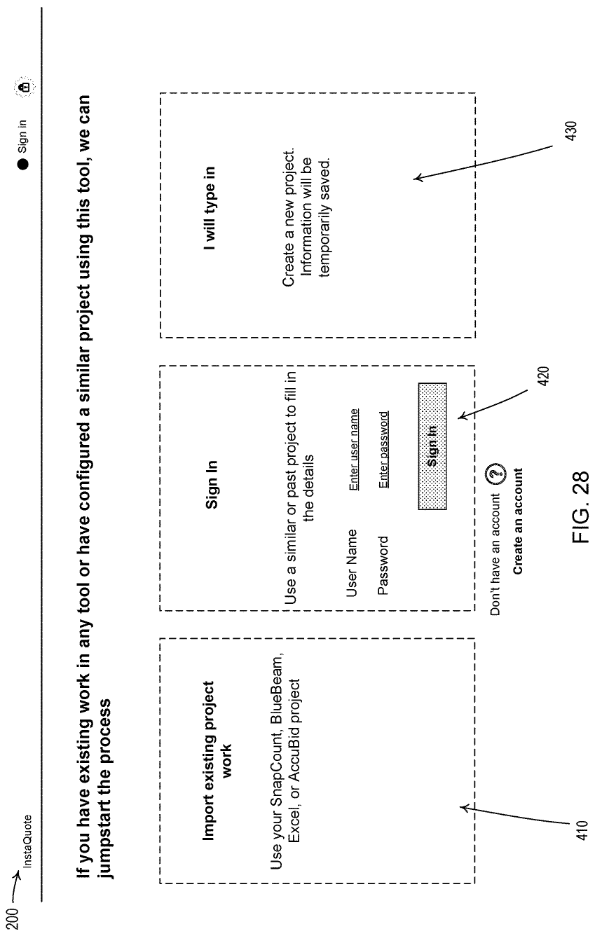

The control circuit of the computing device(s) executing the load control system configuration tool may expediate the configuration process of generating one or more load control system configurations if the user has any existing work saved in any formats or have estimated a similar project using the configuration tool previously, as shown in FIG. 28 and/or a configuration generated by a designer software as described herein. The control circuit of the computing device(s) executing the configuration tool may import load control details of an existing project work (e.g., comprising load control details for a load control system configuration) in a block 410, if available. The existing project work (e.g., comprising existing load control details for a load control system configuration) may be in any formats, such as SnapCount, BlueBeam, Excel, AccuBid project, etc. The control circuit of the computing device(s) executing the configuration tool may receive the existing project work uploaded by the user on the window 200, e.g., via drag and drop. The control circuit of the computing device(s) executing the configuration tool may generate the load control details for one or more load control system configurations based on the uploaded existing project work. Accordingly, the user may skip providing details from the existing project work into the control circuit of the computing device(s) executing the configuration tool, and thereby, may save time and/or may avoid potential mistakes. The control circuit of the computing device(s) executing the configuration tool may use the load control details of the uploaded project work and may consider the existing work to perform (e.g., automatically perform) the configuration process and update/revise the load control details of the load control system configurations.

The control circuit of the computing device(s) executing the load control system configuration tool may ask the user if the user has configured a similar project using the configuration tool in a block 420. The control circuit of the computing device(s) executing the configuration tool may load the load control details of a previously configured project generated by the configuration tool when the user enters proper credentials. The user may skip reentering the details used on the previous project. Accordingly, the user may avoid providing one or more details from the previous similar project work onto the control circuit of the computing device(s) executing the configuration tool, and thereby, may save time and/or may avoid potential mistakes. The control circuit of the computing device(s) executing the load control system configuration tool may use the uploaded previous similar project work to perform (e.g., automatically perform) the configuration process and generate the load control details of one or more load control system configurations.

The control circuit of the computing device(s) executing the load control system configuration tool may ask the user to manually type in details about the project by creating a project (e.g., another project) in a block 430. As described herein, the control circuit of the computing device(s) executing the configuration tool may ask one or more questions about the project. The control circuit of the computing device(s) executing the configuration tool may generate the load control details of one or more load control system configurations as the configuration tool receives more information about the project. The more information that the control circuit of the computing device(s) executing the load control system configuration tool receives, the more accurate or complete the load control details of the load control system configurations may be.

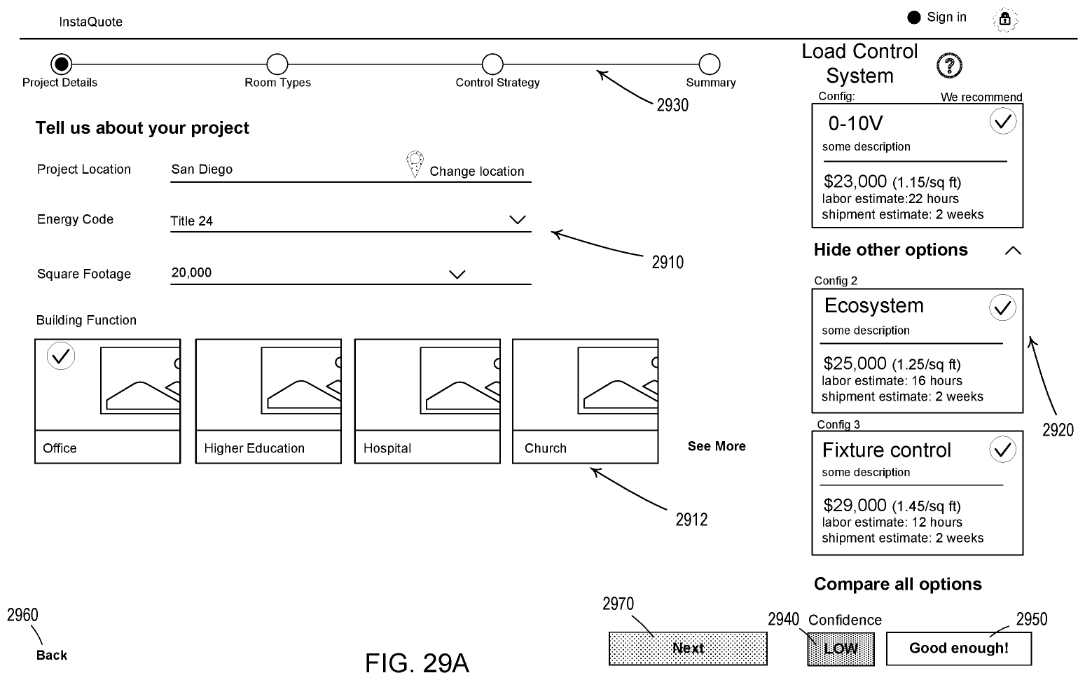

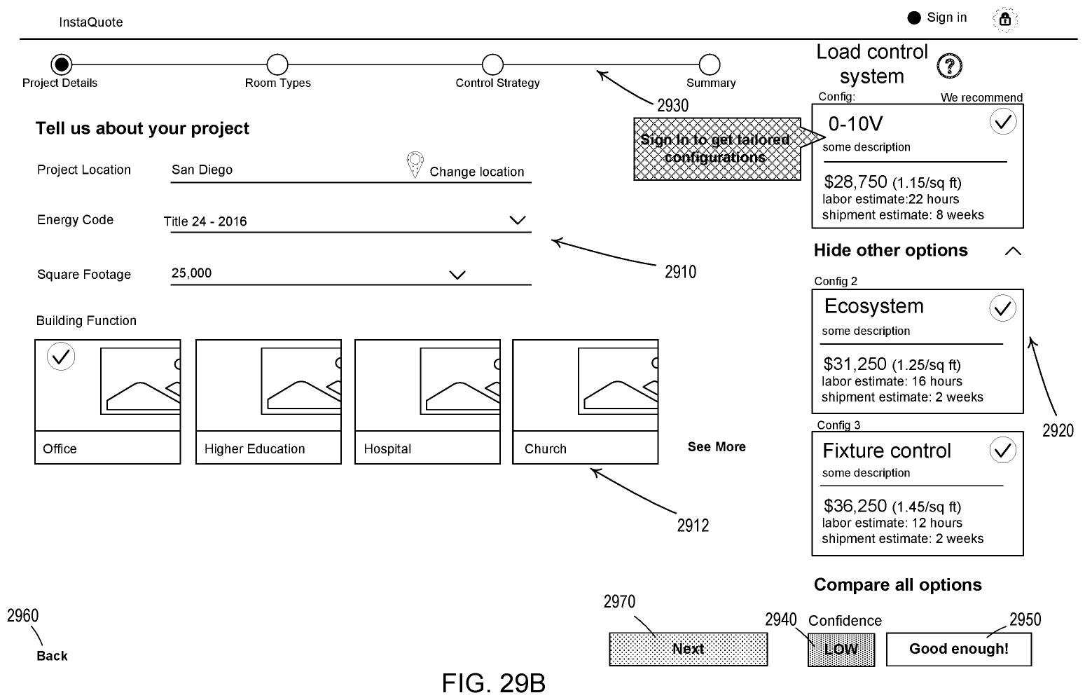

As described herein, the control circuit of the computing device(s) executing the load control system configuration tool may ask one or more questions to the user about details of the project (e.g., as the user selects creating project shown in FIG. 28). As illustrated in FIGS. 29A-29B, the control circuit of the computing device(s) executing the configuration tool may ask the user details in a project details section 2910. As described above, the details about the project may be or may include different level details. For example, as described herein and as shown in FIGS. 55A-B, the control circuit of the computing device(s) executing the configuration tool may have first level details 5502, second level details 5504, third level details 5506, fourth level details 5508, fifth level details 5510, and so on. The control circuit of the computing device(s) executing the configuration tool may ask about first level detail project information in the project details section 2910, such as the project location, energy code, square footage of the project, building function, and/or the like. For example, the first level details may be or may include the first level details 5502 shown in FIG. 55A. As described herein, the control circuit of the computing device(s) executing the configuration tool may assign greater value weights (e.g., the highest weights) to the answers/inputs that correspond to the first level details than the answers/inputs that correspond to the additional level details (e.g., the second level details, the third level details, and so on). Based on the answers/inputs from the user that correspond to the first level details about the project, the control circuit of the computing device(s) executing the configuration tool may autogenerate additional load control details of one or more load control system configurations.

As described herein, the control circuit of the computing device(s) executing the configuration tool may assign greater value weights and lower value weights to the answers/inputs within the same level details. For example, the control circuit of the computing device(s) executing the configuration tool may assign greater value weights to the answers/inputs that correspond to the energy code and/or the square footage of the project in the first level details. Based on receiving the first level details about the project, or a subset of the first level details that may be predefined for generating initial results, the control circuit of the computing device(s) executing the configuration tool may generate one or more load control system configurations (e.g., using the table shown in FIGS. 56A-B). The first level details, or a subset thereof, may be predefined for generating initial results due to their answers/inputs being capable of filtering out larger numbers of configurations. As such, the weights may be assigned to a given load control detail or answer/input based on the number of configurations that may be filtered out in response to the load control detail or answers/inputs. The greater the number of configurations to be filtered out, the greater the weight that may be assigned.

As described herein, the load control system configurations may include load control details for the project to function properly. The load control system configurations may include recommended load control systems (e.g., system configurations) that are suitable for the project and to the user based on the information provided by the user. For example, the control circuit of the computing device(s) executing the configuration tool may generate one or more load control system configurations that include load control details and/or associated recommendations based on past project data associated with the user (e.g., using favorites or common characteristics associated with previous projects). As described hereinafter, the control circuit of the computing device(s) executing the configuration tool may update the generated load control system configurations, such as the load control details and/or associated recommendations, in response to and/or based on more information about the project provided by the user. The control circuit of the computing device(s) executing the configuration tool may ask about the project details on building function in building function tiles 2912. The control circuit of the computing device(s) executing the configuration tool may provide one or more examples of the building function. The control circuit of the computing device(s) executing the configuration tool may receive the user selection of the appropriate building function tiles for the project.

Based on receiving the information from the user (e.g., the size and/or function of the building associated with the project), the control circuit of the computing device(s) executing the configuration tool may estimate (e.g., roughly estimate) a number and/or type of rooms associated with the project. For example, the control circuit of the computing device(s) executing the configuration tool may generate the load control system configurations that include the number and/or the types of room based on information from previous projects in a database. From there, the control circuit of the computing device(s) executing the configuration tool may configure (e.g., update and/or revise) the load control system configurations based on inputs/answers from the user. The control circuit of the computing device(s) executing the load control system configurations may include quantities and/or types of lighting fixtures and controls that are to be implemented for the size and/or function of the building for the project. For example, as shown in FIGS. 29A and 29B, the control circuit of the computing device(s) executing the configuration tool may provide one or more load control system configurations 2920 (e.g., 0-10V, ecosystem, fixture control, etc.), and each of the load control system configurations may include the estimated number of and/or type of rooms. Based on the information available, the control circuit of the computing device(s) executing the load control system configurations may provide labor time estimates to complete the project, shipment of devices in the load control system configurations, and/or cost estimates of the project.

Depending on the answers/details that the user provides about the project, the control circuit of the computing device(s) executing the load control system configuration tool may provide one or more load control system configurations at the configuration blocks 2920 tailored to the project. The configuration blocks 2920 may include recommended load control system(s) suitable for the project and control devices that may be implemented for the recommended load control system to function properly. The load control details of the load control system configurations may also include an estimated cost associated with the recommended projects (e.g., based on the list of control devices to be implemented for the recommended load control system to function properly). For example, the control circuit of the computing device(s) executing the configuration tool may also display cost per square footage, labor estimate, and/or shipment estimate on the configuration blocks 2920.

As shown in FIG. 29A, the control circuit of the computing device(s) executing the configuration tool may generate one or more load control system configurations at the configuration blocks 2920. For example, as described herein, the control circuit of the computing device(s) executing the configuration tool may generate one or more load control system configurations based on the lists of configurations available at a database. The one or more load control system configurations may be the e.g., top three commonly implemented or more popular system configurations that meet the use specified inputs over a period of time. As shown in FIG. 29A, the control circuit of the computing device(s) executing the configuration tool may generate a first load control system configuration having a 0-10V load control system configuration, a second load control system configuration, such as ecosystem load control system configuration, and/or a third load control system configuration, such as a fixture control load control system configuration at the configuration block 2920.

The configuration blocks 2920 may display a first load control system configuration having a 0-10V load control system configuration. As the control circuit of the computing device(s) executing the configuration tool knows the devices to be implemented to enable proper functionality using the first load control system configuration (e.g., the 0-10V load control system configuration), the control circuit of the computing device(s) executing the configuration tool may calculate and provide a cost estimate of $23,000. The control circuit of the computing device(s) executing the configuration tool may further provide a cost-breakdown related to the first load control system configuration using a database (e.g., comprising labor cost, material costs per locations, and/or the like). For example, the control circuit of the computing device(s) executing the configuration tool may provide that the project may cost $1.15 per square footage, may have 22 hours of estimated labor, and may have 8 weeks for shipment estimate. Alternatively, or additionally, the control circuit of the computing device(s) executing the configuration tool may recommend a second load control system configuration, such as an ecosystem load control system configuration, with a cost estimate of $25,000 (e.g., having an estimate of $1.25 per square footage, labor estimate of 16 hours, and/or shipment estimate of 2 weeks). Alternatively, or additionally, the control circuit of the computing device(s) executing the configuration tool may recommend a third load control system configuration, such as a fixture control load control system configuration, with a cost estimate of $29,000 (e.g., having an estimate of $1.45 per square footage, labor estimate of 12 hours, and/or shipment estimate of 2 weeks).

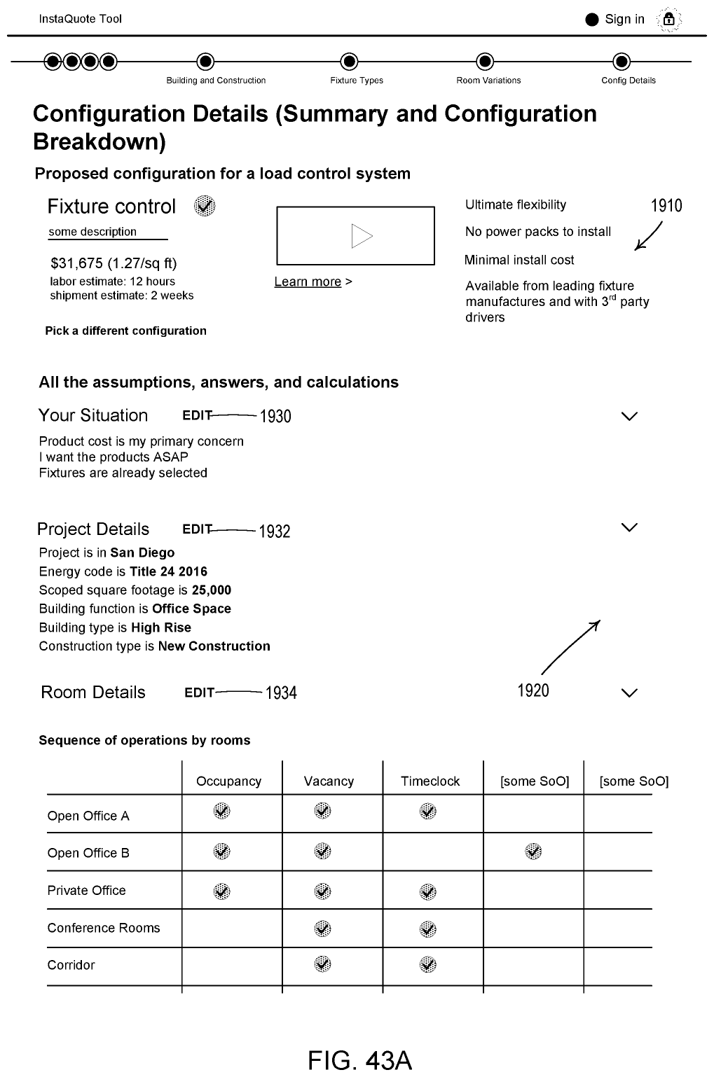

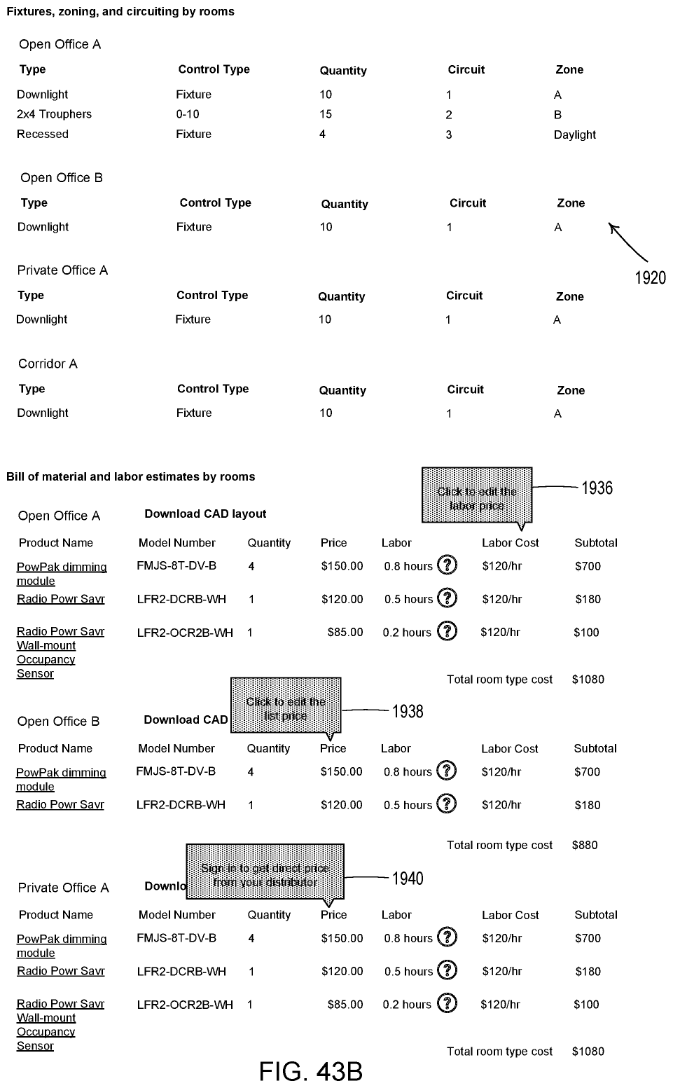

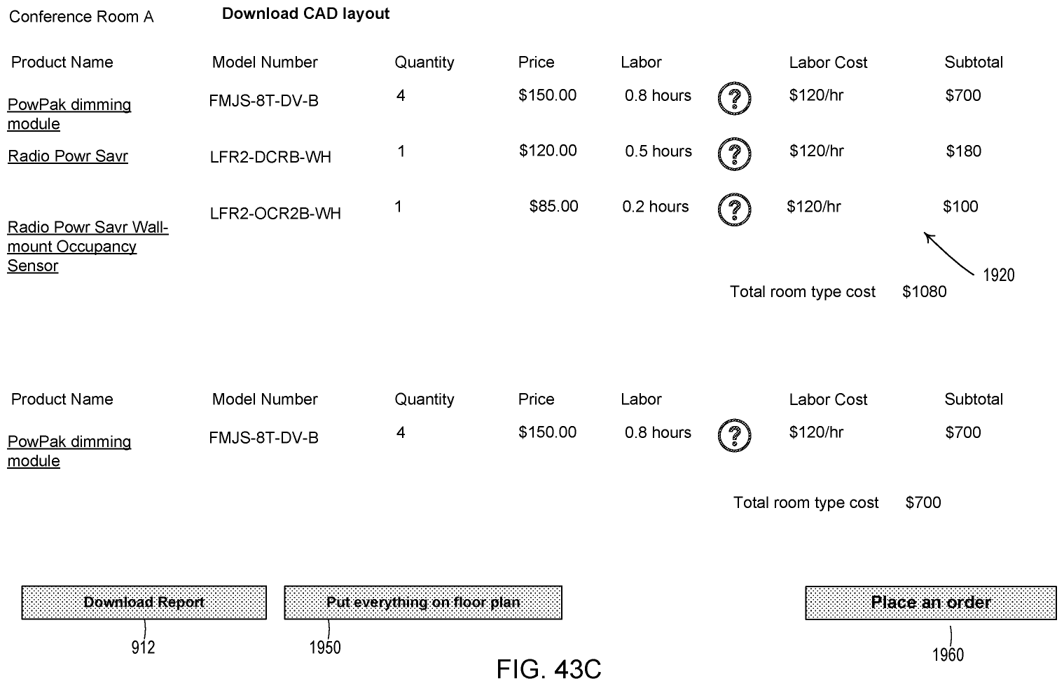

As the user provides answers/details about the project, the control circuit of the computing device(s) executing the load control system configuration tool may update the one or more load control system configurations in the configuration blocks 2920 accordingly (e.g., as shown in FIG. 29B). As illustrated in FIG. 29B, the user may provide answers/details that the project location may be in San Diego, the energy code may be Title 24-2016 (e.g., changed from Title 24 shown in FIG. 29A), and/or the square footage for the project may be 25,000 (e.g., changed from 20,000 square footage shown in FIG. 29A). Based on this information, the control circuit of the computing device(s) executing the load control system configuration tool may generate (e.g., or update) load control system configurations on the configuration blocks 2920, as shown in FIG. 29B. Each of the load control system configurations may include (e.g., recommend) different types of control devices, such as LED drivers and controls (e.g., which will be described hereinafter and shown in FIGS. 43B and 43C). As shown in FIG. 29B, the control circuit of the computing device(s) executing the configuration tool may recommend the 0-10V load control system configuration (e.g., the first load control system configuration) with updated devices to be implemented for the recommended system and/or with an updated estimate of $28,750. This configuration may cost $1.15 per square footage, may have 22 hours of estimated labor, and 8 weeks for shipment estimate. Alternatively or additionally, the control circuit of the computing device(s) executing the configuration tool may recommend the ecosystem load control system configuration (e.g., the second load control system configuration) with updated devices to be implemented for the recommended system and/or with an estimate of $31,250 (e.g., having an estimate of $1.25 per square footage, labor estimate of 16 hours, and/or shipment estimate of 2 weeks). Alternatively, or additionally, the control circuit of the computing device(s) executing the configuration tool may recommend the fixture control load control system configuration (e.g., the third load control system configuration) with updated devices to be implemented for the recommended system and/or with an estimate of $36,250 (e.g., having an estimate of $1.45 per square footage, labor estimate of 12 hours, and/or shipment estimate of 2 weeks).

The control circuit of the computing device(s) executing the load control system configuration tool may narrow down or refine the one or more load control system configurations in the configuration blocks 2920 as the user answers more questions about the project (e.g., via additional level details shown in FIGS. 55A-B). The control circuit of the computing device(s) executing the configuration tool may update one or more load control system configurations and the load control details (e.g., devices, control instructions, price estimates, etc.) based on receiving more answers from the user. The control circuit of the computing device(s) executing the configuration tool may update one or more load control system configurations in the configuration blocks 2920 simultaneously as the user provides more information on the project (e.g., as shown in FIG. 29B). Alternatively, or additionally, the control circuit of the computing device(s) executing the load control system configuration tool may update one or more load control system configurations in the configuration blocks 2920 when the user moves on to the next page/window of the configuration process.

The control circuit of the computing device(s) executing the load control system configuration tool may use a decision tree (e.g., as shown in FIGS. 55A-B) and/or a table or a configuration matrix (e.g., as shown in FIGS. 56A-B) to provide/update the load control details of the one or more load control system configurations provided to the user. As shown in FIGS. 56A-B, depending on the information/details about the project, the control circuit of the computing device(s) executing the load control system configuration tool may assign weights to each information/detail that the user provides, e.g., using the configuration matrix. For example, as described herein, the control circuit of the computing device(s) executing the load control system configuration tool may assign weights to the answers/inputs that correspond to different level details and/or within each level of details. Based on the determined weights, the control circuit of the computing device(s) executing the load control system configuration tool may apply the weights to the configuration matrix. The control circuit of the computing device(s) executing the load control system configuration tool may use the matrix/table illustrated in FIGS. 56A-B, or a similar matrix/table for the applicable load control details and may use a database of information associated with details about completed projects in the past. The control circuit of the computing device(s) executing the load control system configuration tool may provide one or more load control system configurations for the user based on the information/details provided (e.g., via the decision tree illustrated in FIGS. 55A-B and/or the matrix illustrated in FIGS. 56A-B).

The control circuit of the computing device(s) executing the load control system configuration tool may have a status indicator 2930 on the window 200, as shown in FIGS. 29A-29B. The status indicator 2930 may indicate how far along the user is with the configuration process. The control circuit of the computing device(s) executing the configuration tool may provide to the user information about the current status/position of the configuration process and may also provide future question types for the configuration process to the user. As illustrated in FIG. 29A, the control circuit of the computing device(s) executing the configuration tool may provide an indication that the user is currently in the project detail position, e.g., according to the status indicator 2930. The control circuit of the computing device(s) executing the load control system configuration tool may ask questions (e.g., additional level details about the project) about room types and control strategy in the next pages/windows, e.g., according to the status indicator 2930. When the user is done with the questions on the current page/window of the configuration process and moves on to the next questions located on the next page/window, the control circuit of the computing device(s) executing the configuration tool may update the status indicator 2930 accordingly.

The control circuit of the computing device(s) executing the load control system configuration tool may also have a confidence indicator 2940 (referred to as ‘confidence’). The confidence indicator 2940 may indicate the strength of the one or more load control system configurations provided by the control circuit of the computing device(s) executing the configuration tool based on the answers received from the user. The confidence indicator 2940 may be a sliding scale that includes low, medium, and high level scales. As shown in FIGS. 29A and 29B, based on the project details, the control circuit of the computing device(s) executing the configuration tool may provide low confidence indicator to the user. As described herein, the control circuit of the computing device(s) executing the configuration tool may update and change the confidence indicator 2940 as the user provides more details/information about the project (e.g., by providing answers/inputs on additional level details). That is, as the control circuit of the computing device(s) executing the configuration tool has more data, the control circuit of the computing device(s) executing the load control system configuration tool may provide more accurate load control system configurations. For example, the load control system configurations provided in 2920 may match with the actual details associated with the project as the control circuit of the computing device(s) executing the configuration tool has more information. The confidence indicator 2940 may be a numeric indicator (not shown) or any other indications to indicate the strength of the recommendation. The control circuit of the computing device(s) executing the load control system configuration tool may update the confidence indicator 2940. The control circuit of the computing device(s) executing the configuration tool may update the confidence indicator 2940 simultaneously as the user provides more information depending on the amount of information provided and the type of information provided. Certain project details may give a greater level of confidence than others. Alternatively, or additionally, the control circuit of the computing device(s) executing the configuration tool may update the confidence indicator 2940 when the user moves on to the next page/window of the configuration process.

The control circuit of the computing device(s) executing the load control system configuration tool may provide a finish button 2950 (referred to as ‘Good enough! ’), where the control circuit of the computing device(s) executing the configuration tool skips to a summary section, which will be described hereinafter. The user may have the already entered information about the project details and may want to receive general load control system configurations. The user may choose to select the finish button 2950 to jump to the end of the process and review the summary of the load control system configurations available based on the information provided. If the user selects the finish button 2950, the load control system configuration tool may skip to the summary section and may display the summary of the load control system configurations based on the information provided. The control circuit of the computing device(s) executing the configuration tool may allow the user to edit the summary section by filling additional details on the summary window/page if the user has additional information about the project. The control circuit of the computing device(s) executing the load control system configuration tool may update the load control system configurations accordingly.

The control circuit of the computing device(s) executing the load control system configuration tool may provide a back button 2960 and a next button 2970, as illustrated in FIGS. 29A-29B. The control circuit of the computing device(s) executing the configuration tool may display previous page of the configuration process if the user selects the back button 2960. The control circuit of the computing device(s) executing the configuration tool may display next page of the configuration process if the user selects the next button 2970.

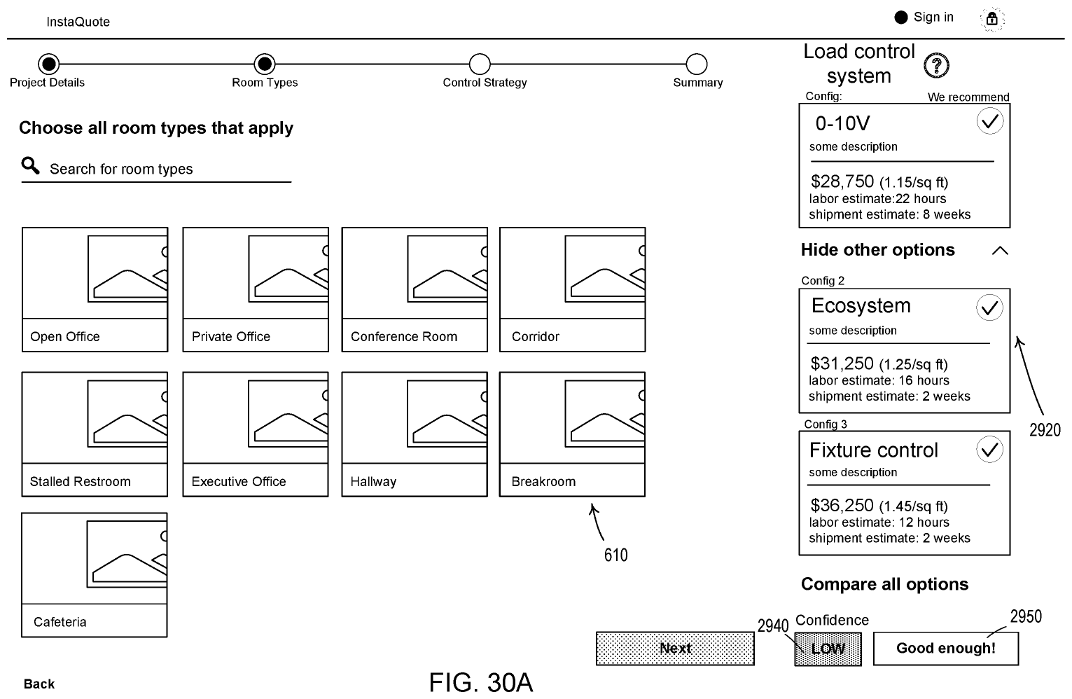

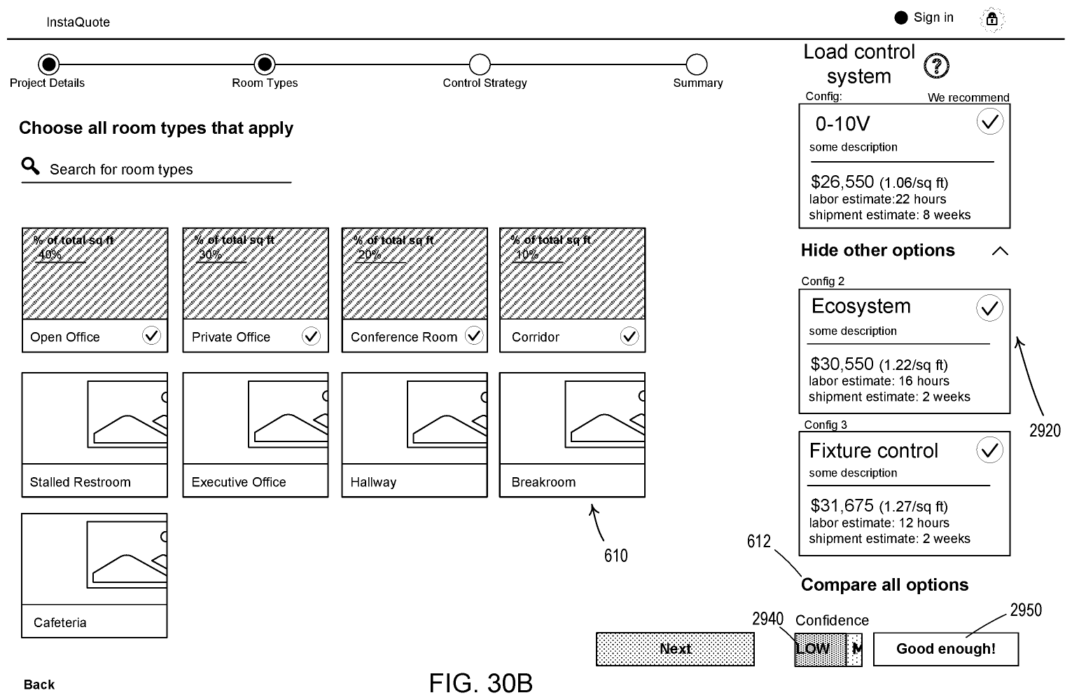

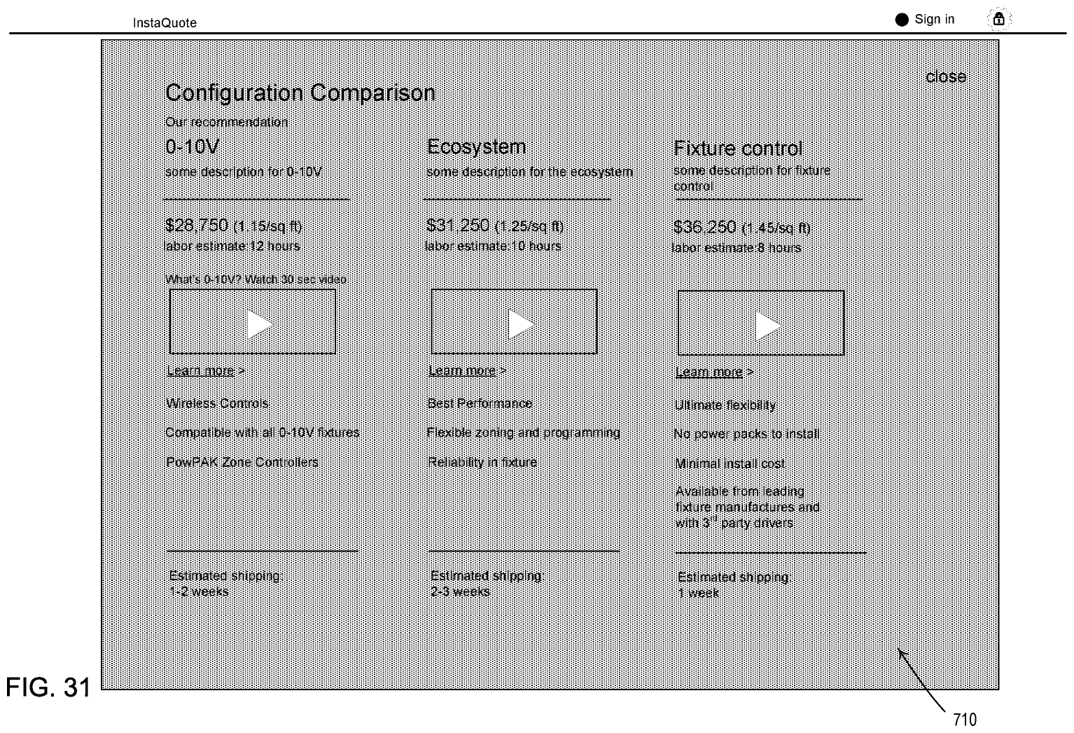

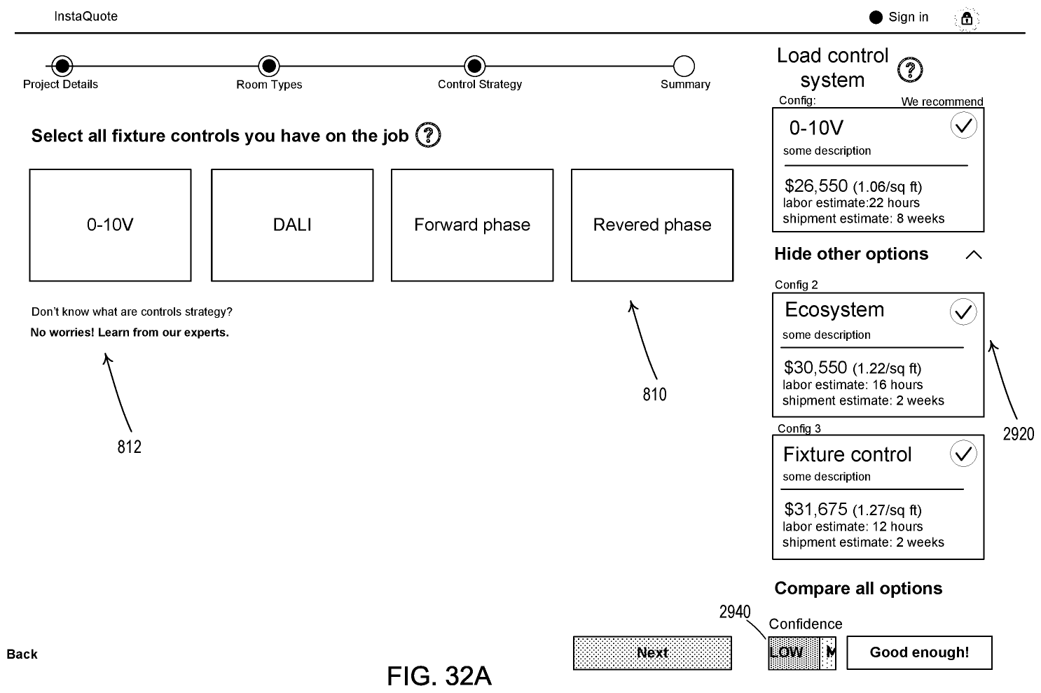

The control circuit of the computing device(s) executing the load control system configuration tool may ask questions about room types for the project. As shown in FIGS. 30A-30B, the control circuit of the computing device(s) executing the load control system configuration tool may ask the user to select one or more room type tiles 610 for the project. As described herein, the control circuit of the computing device(s) executing the configuration tool may go to the summary section without receiving any further answered questions from the user if the user does not have such information or wishes to skip to the summary section or if the user selects the finish button 2950 located on a window/page (e.g., lower right corner of the window).

The control circuit of the computing device(s) executing the load control system configuration tool may ask details about the rooms associated with the project. The control circuit of the computing device(s) executing the configuration tool may receive inputs from the user about the details for one or more room types that apply to the project. As shown in FIG. 30A, the room types may include, but are not limited to, open office, private office, conference room, corridor, stalled restroom, executive office, hallway, breakroom, and/or cafeteria. As shown in FIG. 30B, the control circuit of the computing device(s) executing the configuration tool may receive the selection from the user on open office, private office, conference room, and corridor room types for the project. The selections provided by the user may match the building function associated with the project. The control circuit of the computing device(s) executing the configuration tool may ask the user to further details about the selected room types applicable to the project. As shown in FIG. 30B, the control circuit of the computing device(s) executing the configuration tool may ask the user to indicate percentage of the total square footage associated with each selected room type. The control circuit of the computing device(s) executing the configuration tool may receive the indication from the user that the open offices has 40% of the total square feet, the private offices has 30% of the total square feet, the conference rooms has 20% of the total square feet, and the corridor has 10% of the total square feet (e.g., as shown in FIG. 30B).

Based on the information about the room types for the project, the control circuit of the computing device(s) executing the load control system configuration tool may update one or more load control system configurations in the configuration blocks 2920. As shown in FIG. 30B, the control circuit of the computing device(s) executing the load control system configurations may be adjusted to account for additional details about the project. The control circuit of the computing device(s) executing the load control system configuration tool may have a better idea about the number and types of rooms based on the answers/details from the user (e.g., as shown in FIGS. 30A and 30B). The control circuit of the computing device(s) executing the configuration tool may adjust the details on the load control system configurations. As the control circuit of the computing device(s) executing the configuration tool updates the load control system configurations, the control circuit of the computing device(s) executing the configuration tool also updates (e.g., provides better estimates) load control details associated with the configurations, such as control devices (e.g., control-target devices, control-source devices), fixtures, and/or the like, to be implemented for the recommended load control system, control instructions based on the devices in the system, cost, and/or labor. For example, if the private office is 30% of total square feet and the configuration tool has information about the total square feet involved in the project, the control circuit of the computing device(s) executing the configuration tool may determine a number for total square feet of private office. Based on the size of a typical private office, the control circuit of the computing device(s) executing the configuration tool may determine an approximate number of private offices. From that, the control circuit of the computing device(s) executing the configuration tool may configure the number of fixtures and the control-source devices for enabling control in the private office to function properly. The control circuit of the computing device(s) executing the configuration tool may further configure or determine the number of control-target devices controlling the fixtures in the private office and/or control-source devices associated with the fixtures in the private offices. Based on the number of control-target devices and the control-source devices associated with the number of fixtures in the private office, the control circuit of the computing device(s) executing the configuration tool may associate the devices to communicate control information and/or generate control instructions for the control-target devices. For example, the control circuit of the computing device(s) executing the control tool may configure the communication of control information from control-source devices to associated control-target devices by storing device identifiers of associated devices to enable communication between the devices. The control circuit of the computing device(s) executing the configuration tool may repeat the configuration process for each room type (e.g., open office, conference room, and corridor as shown in FIG. 30B) and refine/update the load control system configurations.

The control circuit of the computing device(s) executing the load control system configuration tool may update the one or more load control system configurations in the configuration blocks 2920 to account for additional details about the project. As shown in FIG. 30B, the control circuit of the computing device(s) executing the configuration tool may update and display one or more configuration blocks 2920. The control circuit of the computing device(s) executing the configuration tool may update the details on the 0-10V configuration (e.g., the first load control system configuration). For example, the control circuit of the computing device(s) executing the configuration tool may update the load control details associated with the first load control system configuration and may show updates on the cost estimates from $28,750 (e.g., as shown in FIG. 30A) to $26,550 (e.g., as shown in FIG. 30B). Alternatively, or additionally, the control circuit of the computing device(s) executing the configuration tool may update the load control details on the ecosystem configuration (e.g., the second load control system configuration) and may show the cost estimates updating from $31,250 (e.g., as shown in FIG. 30A) to $30,550 (e.g., as shown in FIG. 30B). Alternatively, or additionally, the control circuit of the computing device(s) executing the configuration tool may update the load control details on the ecosystem configuration (e.g., the third load control system configuration) and may show the cost estimates updating from $36,250 (e.g., as shown in FIG. 30A) to $31,675 (e.g., as shown in FIG. 30B).

In addition, or alternatively, based on the information about the room types, the control circuit of the computing device(s) executing the load control system configuration tool may update the confidence indicator 2940, as the configuration tool has more information about the project. As shown in FIG. 30B, the confidence indicator 2940 may increase from low (as shown in FIG. 30A) to low-medium scale. As described herein, the more information the control circuit of the computing device(s) executing the configuration tool has, or the more important the information that is obtained, the more accurate the one or more load control system configurations in the configuration blocks 2920 may be for the user.

The control circuit of the computing device(s) executing the load control system configuration tool may have a compare button 612 (refer to as ‘Compare all options’) to compare one or more load control system configurations in the configuration blocks 2920. If the user selects the compare button 612, the control circuit of the computing device(s) executing the configuration tool may display comparison charts 710 for one or more (e.g., all) of the load control system configurations available to the user, as shown in FIG. 31. The comparison charts 710 may be displayed in another screen that is overlaid on top of the FIG. 30A or FIG. 30B. Alternatively, or additionally, the comparison charts 710 may be displayed in another page (not shown). The comparison charts 710 may include one or more load control system configurations from the configuration blocks 2920 available to the user based on the given information. The comparison charts 710 may include the load control details associated with the load control system configurations. The load control details may include, but not limited to one or more recommended load control system configurations for the project, estimated cost, labor estimate, estimated shipping information associated with each of the recommended load control system configurations. The comparison chart 710 may also include a video describing the recommended load control system configurations and/or descriptions corresponding to one or more recommended load control system configurations. For example, the comparison chart 710 may include a video describing the recommended lighting fixtures in the load control system configurations and/or descriptions corresponding to the lighting fixtures.

The control circuit of the computing device(s) executing the load control system configuration tool may return to the configuration tool when the user clicks close button to close the comparison chart. For example, the control circuit of the computing device(s) executing the load control system configuration tool may go back to the previous page before the user hit the compare button 612.

The control circuit of the computing device(s) executing the load control system configuration tool may ask questions to the user about controls strategy for fixtures associated with the project. For example, the control circuit of the computing device(s) executing the load control system configuration tool may receive the user selection on control strategy that allow communication between the control devices (e.g., unidirectional, bi-directional, etc.). As shown in

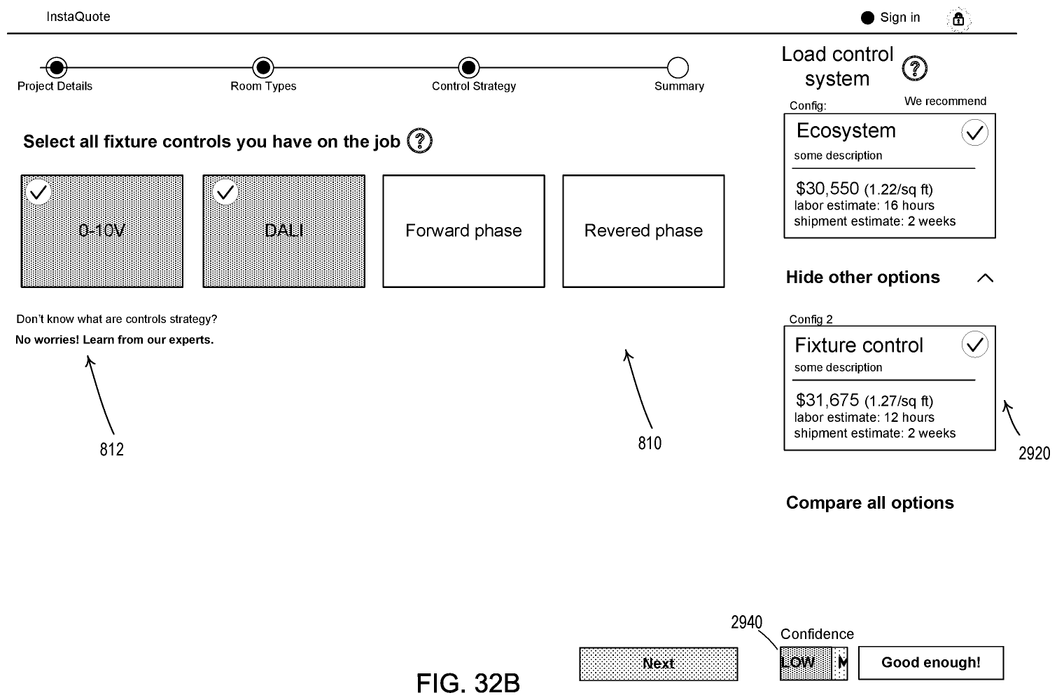

FIGS. 32A-32B, the control circuit of the computing device(s) executing the configuration tool may ask the user to select one or more fixture control tiles 810 that are applicable to the project. The fixture control tiles 810 that are displayed may be based on the project details entered in the project details section 2910 shown in FIGS. 29A and 29B and the room information entered in the one or more room type tiles 610 shown in FIGS. 30A and 30B. The fixture control tiles 810 may include, but are not limited to 0-10V, digital addressable lighting interface (DALI), forward phase, and/or reversed phase control.

The control circuit of the computing device(s) executing the load control system configuration tool may provide additional resources for the user to learn about the control strategies, e.g., via a learning button 812. The user may click on the learning button 812 to learn more about the control strategy.

The control circuit of the computing device(s) executing the configuration tool may update one or more load control system configurations in the configuration blocks 2920 as the user selects and provides information about the controls strategy. According to FIG. 32B, the control circuit of the computing device(s) executing the configuration tool may receive inputs that the user selects 0-10V and DALI as the fixture controls strategy for the project. Based on such information, the control circuit of the computing device(s) executing the control circuit of the computing device(s) executing the configuration tool may adjust one or more load control system configurations in the configuration blocks 2920. According to FIG. 32B, the control circuit of the computing device(s) executing the configuration tool may update the load control system configurations and show two configuration blocks 2920 tailored to the project details. For example, the control circuit of the computing device(s) executing the configuration tool may know that the first load control system configuration (e.g., the 0-10V load control system configuration) is unsuitable for the project based on the information received from the user. The control circuit of the computing device(s) executing the configuration tool may update the load control details associated with the load control system configurations (e.g., load control devices to be implemented for the load control system to function properly).

The control circuit of the computing device(s) executing the load control system configuration tool may update the confidence indicator 2940 based on the additional information on the controls strategy. As shown in FIG. 32B, the control circuit of the computing device(s) executing the configuration tool may slide the confidence level in the confidence indicator 2940 more toward to medium scale.

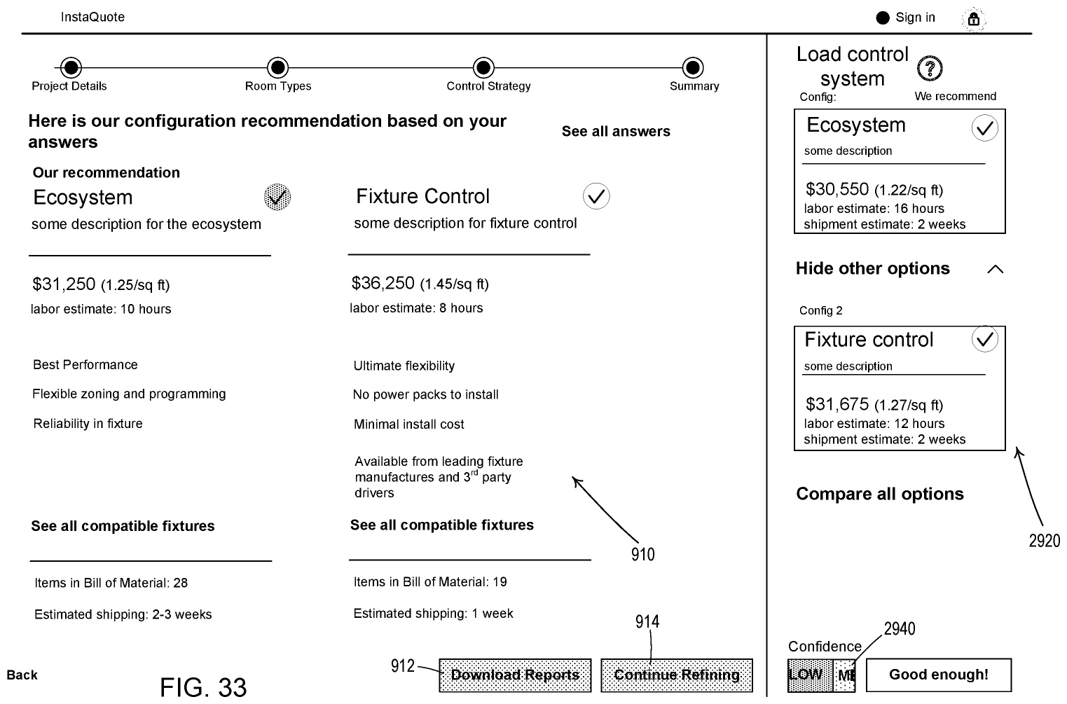

The control circuit of the computing device(s) executing the configuration tool may provide a summary based on the information provided by the user. FIG. 33 illustrates an example summary window/page of the one or more load control system configurations suitable for the project based on the information provided by the user. The summary window/page may display one or more load control system configurations as recommended configurations 910 based on the information provided by the user in previous pages. The control circuit of the computing device(s) executing the load control system configuration tool may provide the recommended configurations 910 associated with the load control system configurations available to the user. The one or more recommended configurations 910 may be the same as the one or more load control system configurations 2920.

The control circuit of the computing device(s) executing the load control system configuration tool may provide a report button 912, where the user may download the summary that includes one or more recommended configurations 910. The report may be in an excel, PDF, etc. The user may also print the summary window/page. On the printed page, the control circuit of the computing device(s) executing the configuration tool may include an indication, such as a QR code, a reference number, etc. The control circuit of the computing device(s) executing the configuration tool may use the indication to look up the configuration process associated with the indication without the user having to save the process separately (e.g., save locally or save in server) or create login credentials. The indication may allow the user to pick up where the user left off and may skip providing the same repetitive details about the project (e.g., and the user may save time and/or may avoid potential mistakes).

The control circuit of the computing device(s) executing the configuration tool may allow the user to refine the project by selecting a refine button 914 (e.g., similar to next button 2970 shown in FIGS. 29A-29B). The user may have more information about the project or receive updates on the project. By selecting the refine button 914, the user may provide additional details about the project, and the control circuit of the computing device(s) executing the configuration tool may provide more accurate load control system configurations with the load control details (e.g., load control devices tailored to the projects based on information from the user) for the project based on updating/revising the load control system configurations.

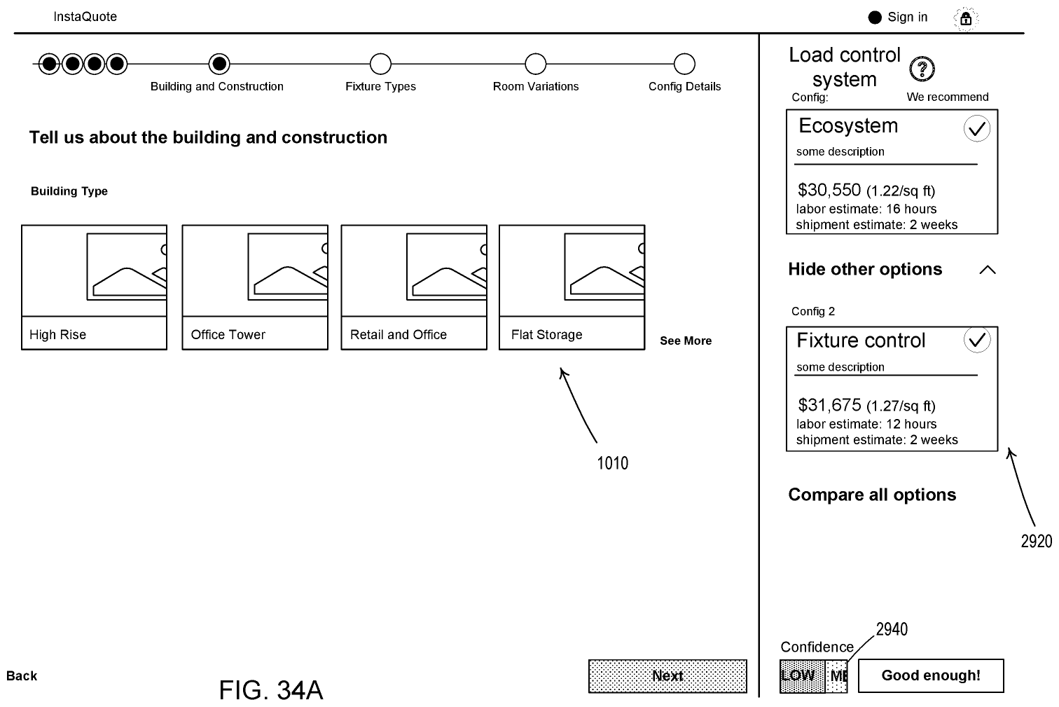

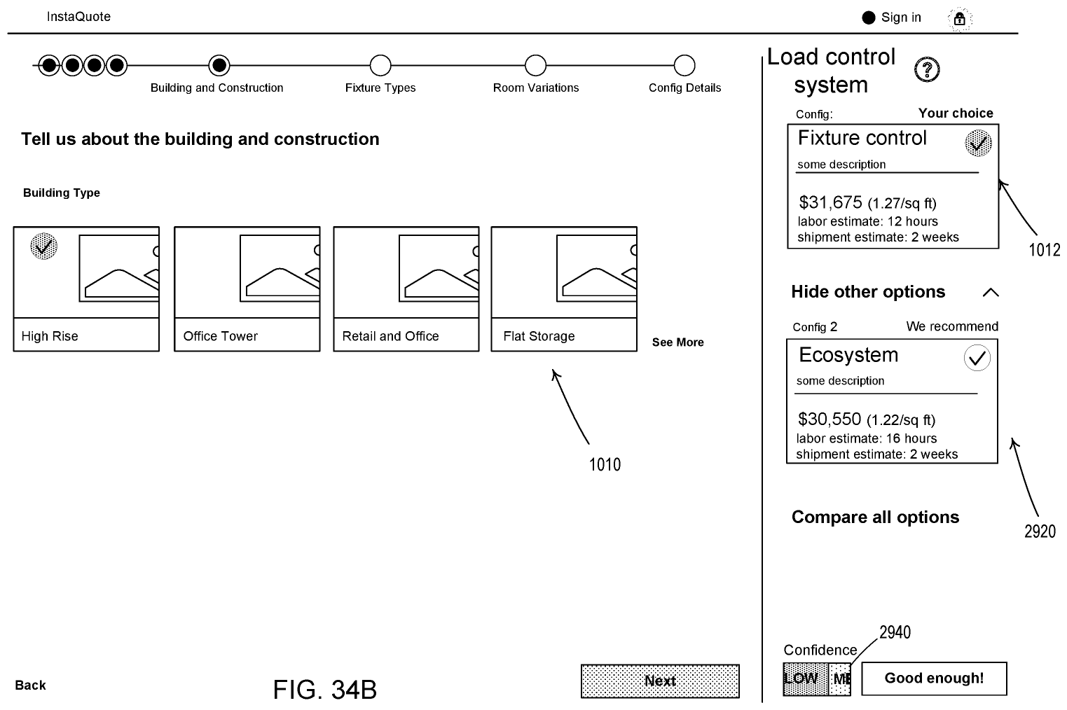

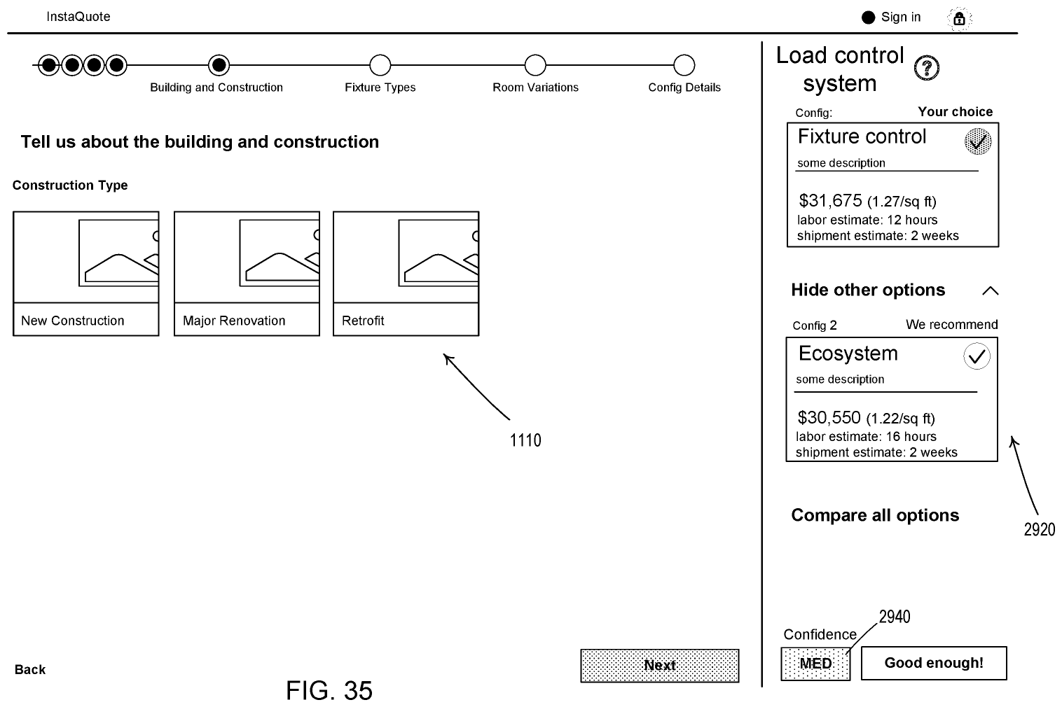

The control circuit of the computing device(s) executing the load control system configuration tool may ask additional questions to the user about the project. The control circuit of the computing device(s) executing the load control system configuration tool may ask about building type and/or construction type, as illustrated in FIGS. 34A-34B. As shown in FIG. 34A, the control circuit of the computing device(s) executing the load control system configuration tool may ask the user to select one or more building type tiles 1010 based on the building function associated with the project. The building type tiles 1010 may include, but are not limited to a high rise, an office tower, a retail and office, a flat storage building types. The control circuit of the computing device(s) executing the configuration tool may update the load control system configurations in the configuration blocks 2920 and the confidence indicator 2940 as the user provides additional details about the project.

The control circuit of the computing device(s) executing the load control system configuration tool may allow the user to choose a load control system configuration from the load control system configurations in the configuration blocks 2920. The selected load control system configuration may be considered as a preferred load control system configuration to the user. According to FIG. 34B, the user may select fixture control load control system configuration as the preferred configuration 1012. The control circuit of the computing device(s) executing the load control system configuration tool may place the preferred configuration 1012 above one or more other configuration blocks 2920. The control circuit of the computing device(s) executing the load control system configuration tool may save the preferred configuration 1012 and may continue to show the preferred configuration 1012 throughout the load control system configuration process. The user may deselect the preferred configuration 1012 by clicking on the selected preferred configuration.

The control circuit of the computing device(s) executing the load control system configuration tool may ask the user about construction type associated with the project, if such information is available to the user. FIG. 35 illustrates an example, where the user selects a construction type from one or more construction type tiles 1100. The construction type tiles 1100 may include, but not limited to a new construction, a major renovation, a retrofit construction, etc. As the control circuit of the computing device(s) executing the configuration tool receives more information about the building type and/or construction type associated with the project from the user and user inputs, the control circuit of the computing device(s) executing the configuration tool may update the load control system configurations in the configuration blocks 2920 and the confidence indicator 2940 accordingly. For example, if the user indicates that the project construction type is a retrofit construction, the control circuit of the computing device(s) executing the load control system configuration tool may know that the load control system configurations may implement wireless communication technology in order for the load system to function properly and may remove (e.g., narrow down) the second load control system configuration (e.g., the ecosystem load control system, which may be wired system) from the load control system configurations in the configuration blocks 2920. For example, as described herein, the control circuit of the computing device(s) executing the load control system configuration tool may provide a greater value weight to wireless communication than wired communication and apply the weights using the decision tree analysis shown in FIGS. 55A-B. The control circuit of the computing device(s) executing the load control system configuration tool may input the weights to the table/matrix, such as the matrix shown in FIGS. 56A-B. Based on the user selection of retrofit construction for the construction type, the control circuit of the computing device(s) executing the load control system configuration tool may refine/update the one or more load control system configurations based on the previous projects in the database.

Alternatively, or additionally, if the user indicates that the project construction type is a new construction or a major renovation, the control circuit of the computing device(s) executing the load control system configuration tool may know that the load control system configurations may use wired and/or wireless communication technologies in order for the load control system configurations to function properly. The control circuit of the computing device(s) executing the load control system configuration tool may include and/or remove control devices and/or communication devices based on the load control system configurations. The control circuit of the computing device(s) executing the load control system configuration tool may adjust the load control system configurations and/or other details associated with the load control system configurations (e.g., costs, labor estimate, shipment estimates, etc.) in the configuration blocks 2920 accordingly. As shown in FIG. 35, the confidence indicator 2940 may also be updated from low-medium scale to medium scale as the configuration tool receives more details about the project from the user.

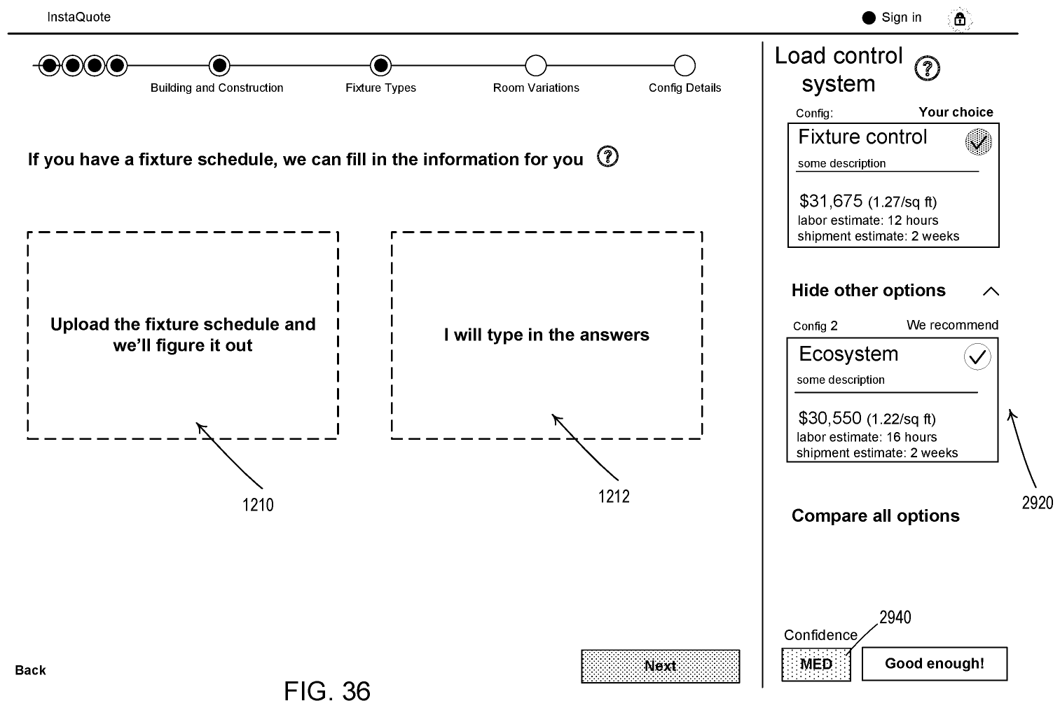

The control circuit of the computing device(s) executing the load control system configuration tool may ask about fixture type. The control circuit of the computing device(s) executing the load control system configuration tool may ask the user to upload the fixture schedule, if one is available, or type in the fixture schedule manually, as shown in FIG. 36. The control circuit of the computing device(s) executing the configuration tool may revise/update the load control system configurations based on the provided fixture schedule. For example, the control circuit of the computing device(s) executing the configuration tool may have more accurate details (e.g., more accurate than the estimations on the number of fixtures completed by the load control system configuration tool as described herein) associated with the load control system suitable for the project. The fixture schedule may indicate a specific number of fixtures for the project (e.g., instead of an estimated number of the fixtures provided by the configuration tool as described above). The control circuit of the computing device(s) executing the configuration tool may update the load control system configuration as it knows the number of fixtures for the project. The control circuit of the computing device(s) executing the configuration tool may update the control devices, such as control-target devices, control-source devices, and/or communication types between the devices, to send control instructions based on the fixture schedule received by the user. The control circuit of the computing device(s) executing the configuration tool may know specific number of devices to be implemented for the load control system to function properly. The control circuit of the computing device(s) executing the configuration tool may generate load control system configurations to control other devices to be implemented for the project (e.g., as the configuration tool may have insufficient information associated with the controls).

If the user uploads the fixture schedule in a box 1210, via dragging the file and dropping in the box 1210 (e.g., drag and drop) or upload a file, the control circuit of the computing device(s) executing the load control system configuration tool may configure the details about the fixtures and may adjust the one or more load control system configurations in the configuration blocks 2920 and the confidence indicator 2940 accordingly. If the user selects manually typing the fixture schedule by selecting a fixture schedule block 1212, the control circuit of the computing device(s) executing the load control system configuration tool may ask additional questions about the details of the fixture schedule.

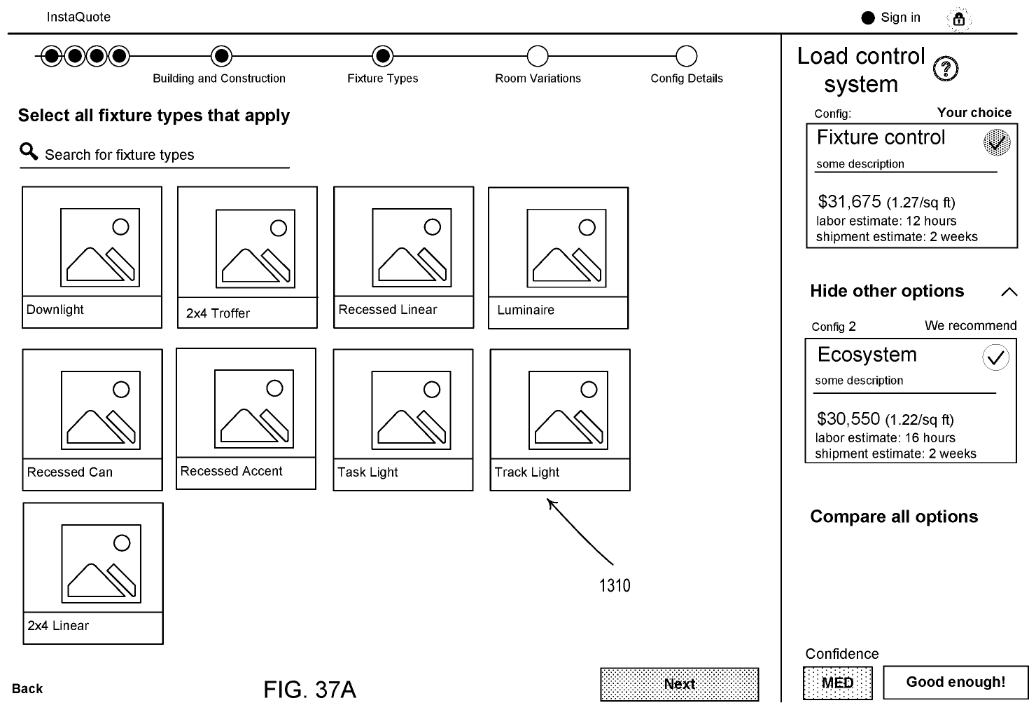

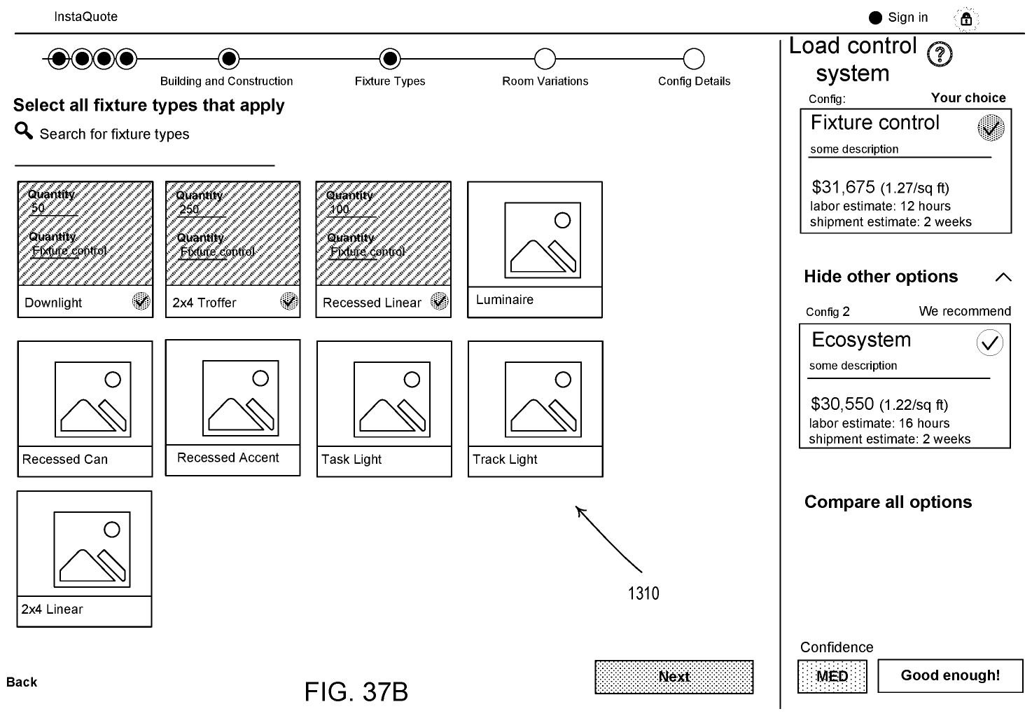

The control circuit of the computing device(s) executing the load control system configuration tool may ask the user to select fixture types associated with the project from fixture type tiles 1310, as shown in FIGS. 37A-37B. The fixture type tiles 1310 may include, but not limited to downlight, 2×4 troffer, recessed liner, luminaire, recessed can, recessed accent, task light, tract light, and/or 2×4 liner. The user may select one or more fixtures applicable to the project, and the control circuit of the computing device(s) executing the configuration tool may update the one or more load control system configurations and the confidence indicator, if applicable.

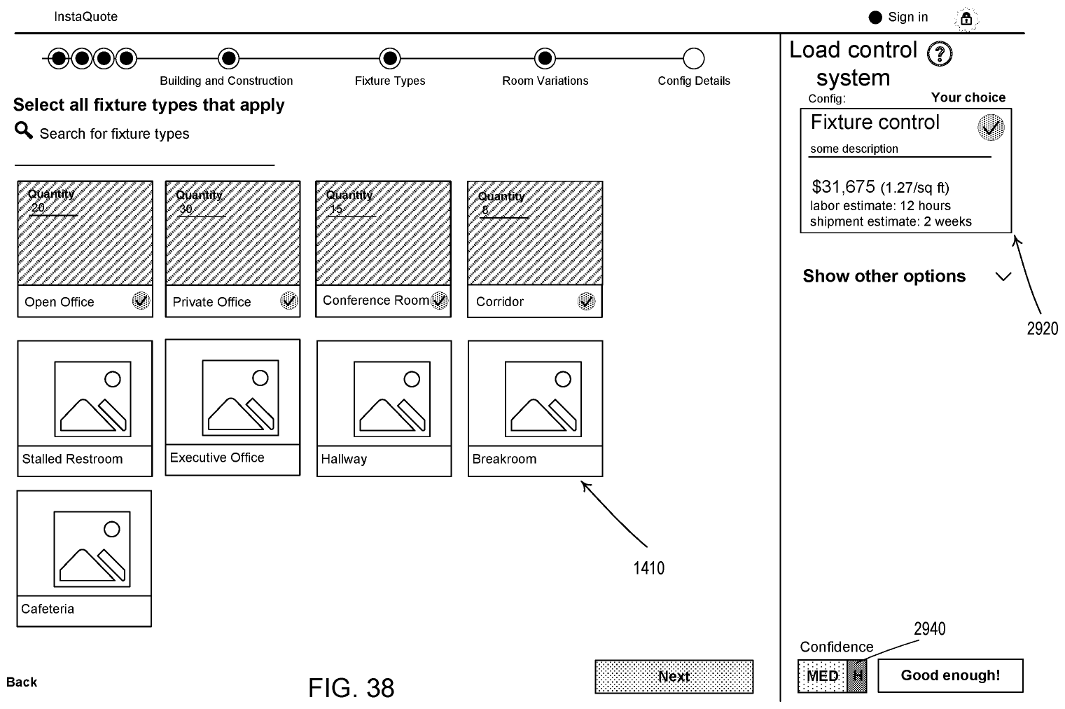

If the user selects one or more fixture type tiles 1310, the control circuit of the computing device(s) executing the load control system configuration tool may ask the user to enter quantities of each of the selected fixture type. For example, as illustrated in FIG. 37B, the user may select 50 downlight fixtures with fixture control, 250 2×4 troffer fixtures with fixture control, and 100 recessed linear fixtures with fixture control for the project. By indicating that each fixture type is to be control by fixture control, the control circuit of the computing device(s) executing the load control system configuration tool may refine/update (e.g., narrow down) the load control system configurations in the configuration blocks 2920 to one load control system configuration as shown in FIG. 38. For example, the control circuit of the computing device(s) executing the configuration tool may update the load control details associated with the load control system configurations (e.g., load control devices, LED drivers, communication types, other control-target devices, control-source devices, and/or the like devices to be implemented for the load control system configuration to function properly in a load control system).

The control circuit of the computing device(s) executing the load control system configuration tool may ask about room variations associated with the project. As illustrated in FIG. 38, the control circuit of the computing device(s) executing the load control system configuration tool may ask the user to select one or more room type tiles 1410. The room type tiles 1410 may include, but are not limited to an open office, a private office, a conference room, a corridor, a stalled restroom, an executive office, a hallway, a breakroom, a cafeteria, etc. The room type may be based on the building function associated with the project. The user may choose each room type for the project by selecting one or more tiles 1410 associated with the project. As described herein, the additional details about specific information about the number and type of rooms (e.g., rather than estimations by the control circuit of the computing device(s) executing the load control system configuration tool) may lead to greater accuracy, e.g., by narrowing down the load control system configurations in the configuration blocks 2920 accordingly. For example, as the control circuit of the computing device(s) executing the configuration tool know the number and the type of rooms, the control circuit of the computing device(s) executing the load control system configurations may update the devices to be implemented in the space to function properly. The control circuit of the computing device(s) executing the configuration tool may also ask the user to provide quantities for selected room types (e.g., rather than percentages as entered in previous screens). According to FIG. 38, the user may indicate 20 open space offices, 30 private offices, 15 conference rooms, and 8 corridors for the project. By providing additional details about the project via the room variations, the control circuit of the computing device(s) executing the load control system configuration tool may refine, update, and/or narrow down the load control system configurations in the configuration blocks 2920 to one load control system configuration, such as fixture control load system shown in FIG. 38. The control circuit of the computing device(s) executing the load control system configuration tool may update the confidence indicator 2940 to medium-high scale based on the information provided by the user.

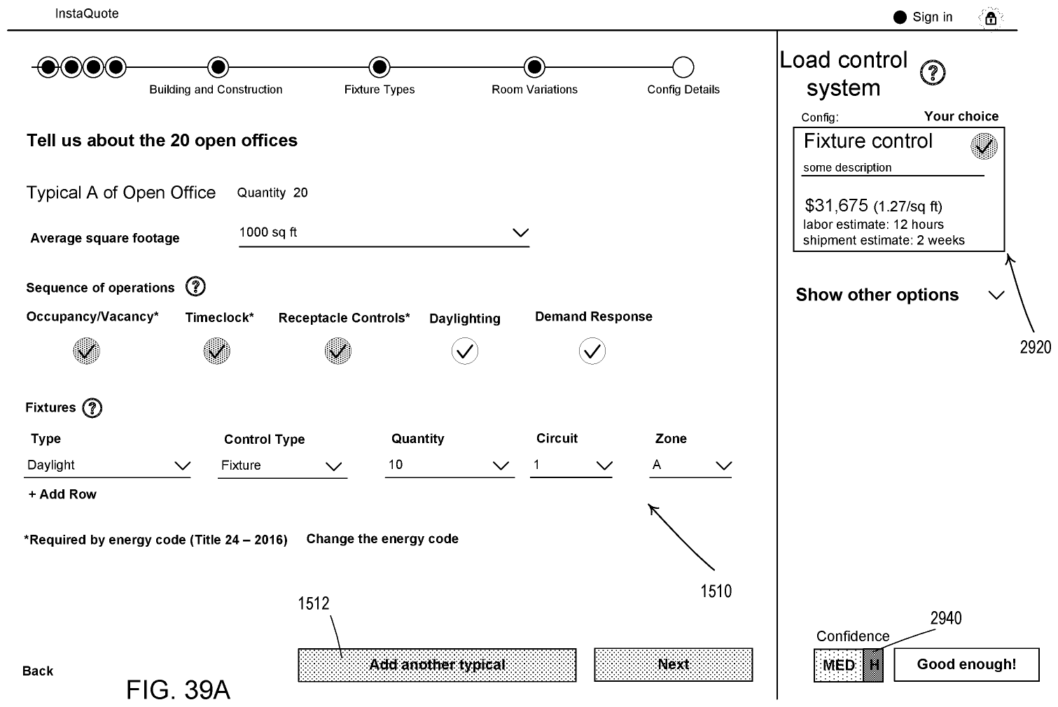

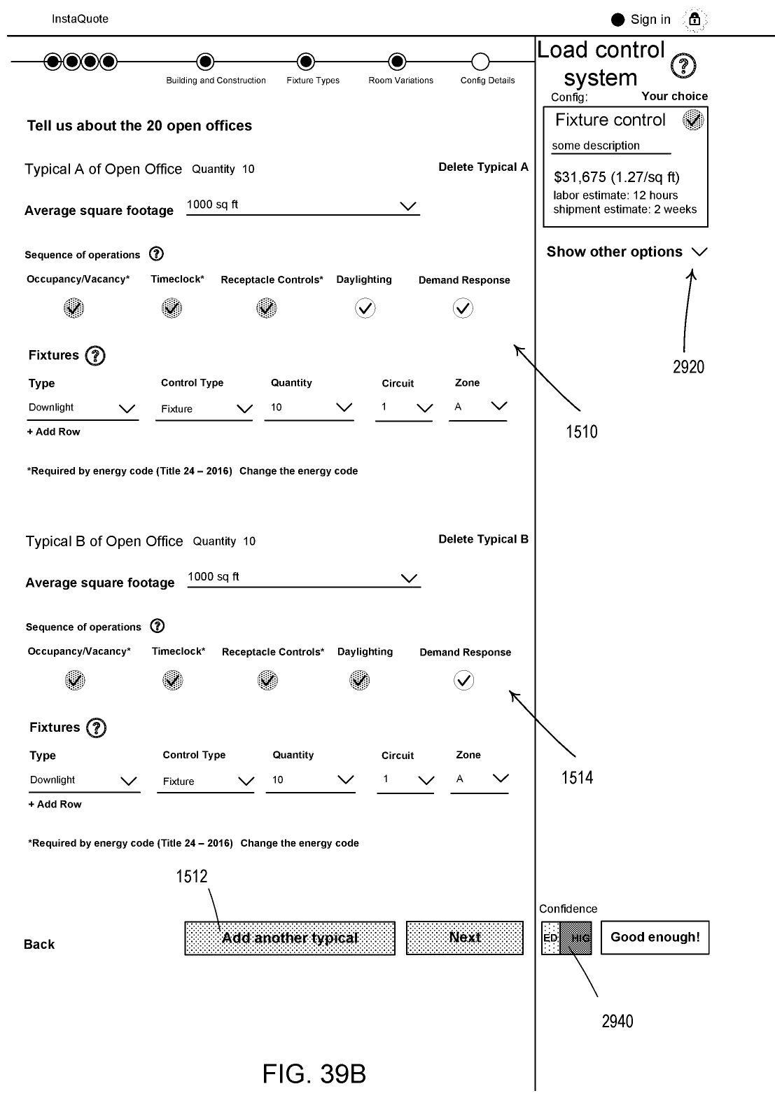

The control circuit of the computing device(s) executing the load control system configuration tool may ask additional question about each room type that the user has previously selected. For each room type that the user has selected, the control circuit of the computing device(s) executing the load control system configuration tool may ask the user to determine whether each room type will have the same/similar type of layout or have multiple types of layout. FIG. 39A illustrates example questions associated with a first room layout (referred to as Typical A) for the open offices. The control circuit of the computing device(s) executing the load control system configuration tool may ask one or more additional questions in sections 1510 about the open offices. The one or more additional question sections 1510 may include, but not limited to quantity of the open office with a particular layout, average square footage for each open office room, triggering events, fixtures being installed in each open office room, required energy code, etc. By default, the control circuit of the computing device(s) executing the load control system configuration tool may display that each of the selected room type have the same layout and/or same load control details. As shown in FIG. 39A, the control circuit of the computing device(s) executing the configuration tool may display that each of the 20 open offices have the same layout (Typical A layout).

The control circuit of the computing device(s) executing the load control system configuration tool may display an add-typical button 1512. The control circuit of the computing device(s) executing the configuration tool may create a second room layout (referred to as Typical B) if the user selects the add-typical button 1512. The user may create multiple room layouts and may provide additional details about each room layout. As shown in FIG. 39B, the user may provide additional details about each room layout by filling out one or more question sections 1510, 1514 associated with each layout (e.g., question section 1510 for Typical A open office and question section 1514 for Typical B open office). According to FIG. 39B, the user may have 10 Typical A open office spaces with 1,000 square footage, occupancy/vacancy, timeclock, and receptacle controls as sequence of operations, 10 downlight fixtures in one circuit in Zone A settings. The user may also have 10 typical B open office spaces with 1,000 square footage, occupancy/vacancy, timeclock, receptacle controls, and daylighting as sequence of operations, 10 downlight fixtures in one circuit in Zone A settings, as shown in FIG. 39B. The control circuit of the computing device(s) executing the configuration tool may update the devices to be implemented on the load control system configuration associated with the load control system. The control circuit of the computing device(s) executing the load control system configuration tool may update the confidence indicator 2940 by sliding toward to high scale, as shown in FIG. 39B.

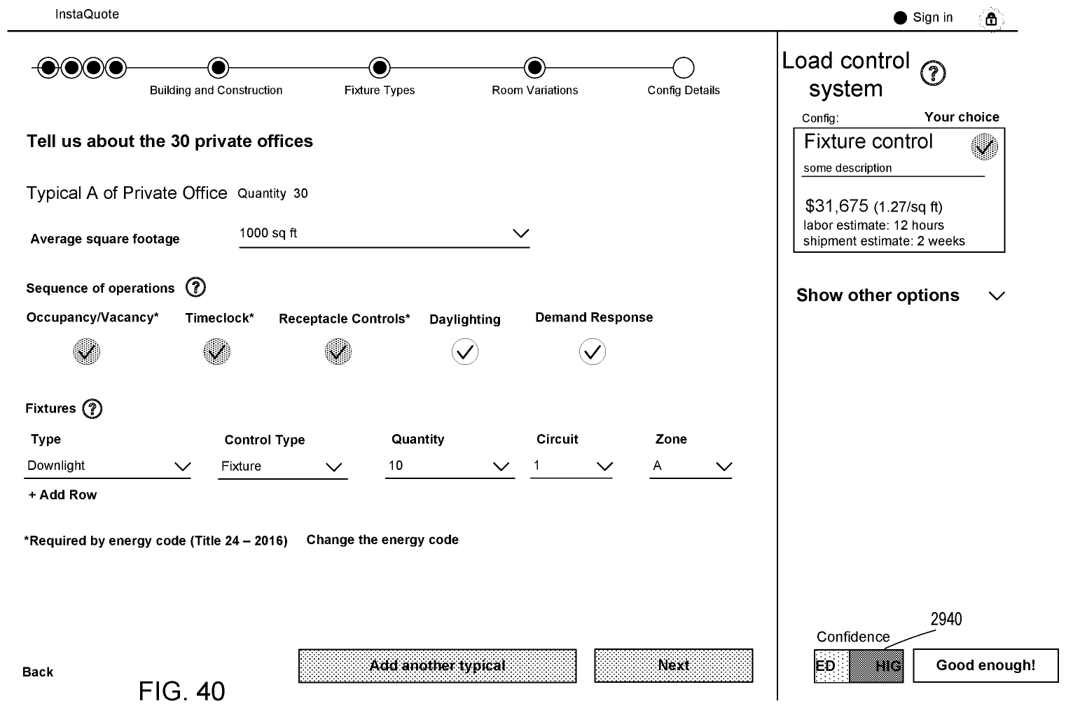

Similarly, the control circuit of the computing device(s) executing the load control system configuration tool may repeat the process as described herein for each room type that the user selected. FIG. 40 illustrates an example layout configuration for private offices. According to FIG. 40, the user may indicate that each of the 30 private offices have same room layout. Again, as more details have been provided to the control circuit of the computing device(s) executing the load control system configuration tool, the confidence indicator 2940 may be adjusted accordingly. As described herein, the configuration tool may update the devices, such as the load control devices, other control-target devices, the control-source devices, the communication types, the control information, and/or the like, to be implemented on the load control system configuration to function properly. As shown in FIG. 40, the confidence indicator 2940 may slide toward high scale.

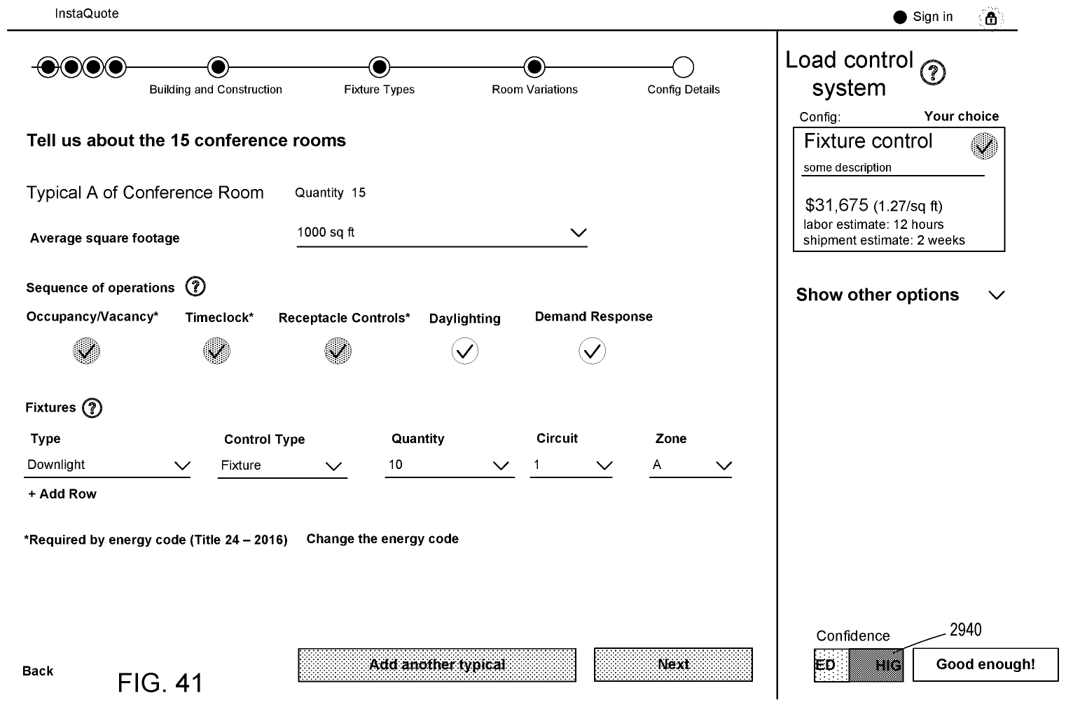

Similarly, the control circuit of the computing device(s) executing the load control system configuration tool may repeat the process as described herein for each room type that the user selected. FIG. 41 illustrates an example layout configuration for conference rooms. According to FIG. 41, the user may indicate that 15 conference rooms have same room layout. Again, as more details have been provided to the control circuit of the computing device(s) executing the load control system configuration tool, the confidence indicator 2940 may be adjusted accordingly. As shown in FIG. 41, the confidence indicator 2940 may slide more toward high scale.

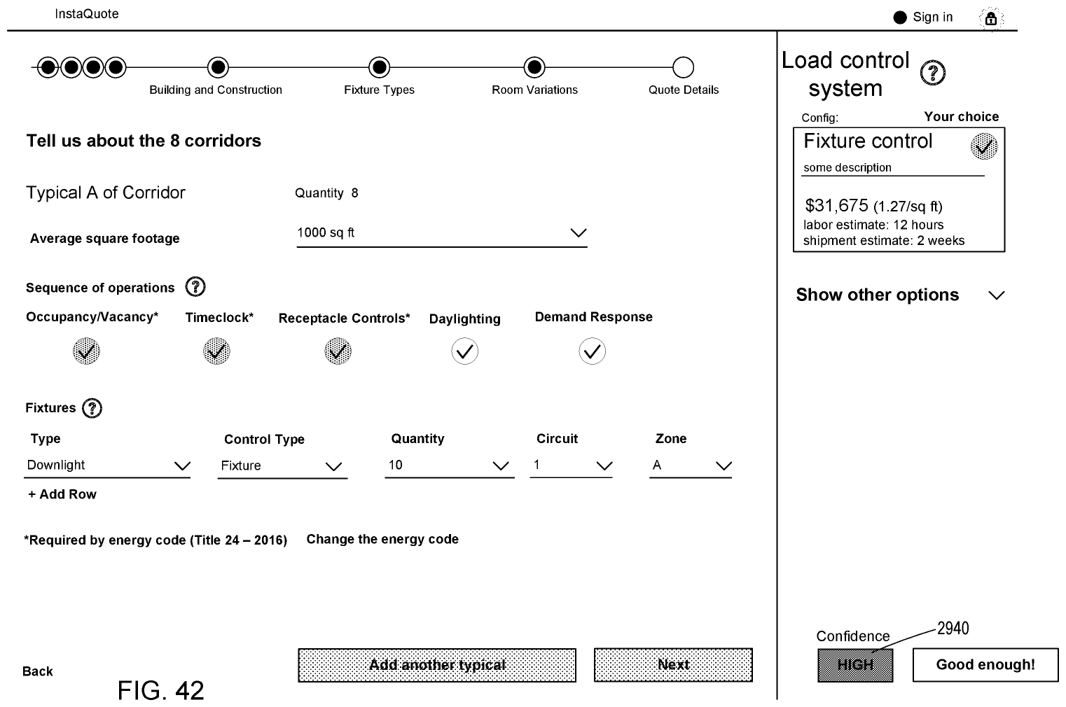

Similarly, the control circuit of the computing device(s) executing the load control system configuration tool may repeat the process as described herein for each room type that the user selected. FIG. 42 illustrates an example layout configuration for corridors. According to FIG. 42, the user indicates that each of the 8 corridors have same room layout. Again, as more details have been provided to the control circuit of the computing device(s) executing the load control system configuration tool, the confidence indicator 2940 may be adjusted accordingly. As shown in FIG. 42, the confidence indicator 2940 may be adjusted to high scale.

The control circuit of the computing device(s) executing the load control system configuration tool may provide detailed summary report to a user based on the information provided about the project. FIGS. 43A-43C illustrate an example detailed summary report having load control system configuration, such as load control details and/or devices to be implemented to function properly. For example, the detailed summary report may include a proposed configuration section 1910 that may be or may include the load control system configuration. As shown in FIGS. 43A-43C, the detailed summary report may provide assumptions, answers, and calculation section 1920 that the control circuit of the computing device(s) executing the load control system configuration tool made based on the information from the user during the configuration process. The assumptions, answers, and calculation section 1920 includes previously provided/answered questions about the projects, such as the breakdown of the situation, project details, room details, material estimates, labor estimates, etc. The user may choose one or more different configurations, if more than one configuration are displayed at the proposed configuration section 1910.

The control circuit of the computing device(s) executing the configuration tool may update the load control system configuration based on receiving the user input to change one or more previous details/information about the project. For example, the control circuit of the computing device(s) executing the configuration tool may receive the user selection of one or more edit buttons 1930, 1932, 1934. As shown in FIG. 43A, the user may edit the situation of the project via selecting the edit button 1930, project details via selecting the edit button 1932, and/or room details via selecting the edit button 1934. By adjusting one or more details on the summary section, the control circuit of the computing device(s) executing the load control system configuration tool may update the proposed configuration section 1910 accordingly.

The control circuit of the computing device(s) executing the configuration tool may receive the user input for adjusting one or more material estimates and/or labor estimates, e.g., via edit buttons 1936, 1938, 1940, as shown in FIG. 43B. If the user has different estimate on material and/or labor estimates, the user may edit the labor cost estimates via selecting the edit button 1936 and/or edit the material estimates via selecting the edit buttons 1938, 1940. By adjusting one or more details on the summary section, the control circuit of the computing device(s) executing the configuration tool may update the proposed configuration section 1910 accordingly.

The control circuit of the computing device(s) executing the load control system configuration tool may provide a report button 912, where the control circuit of the computing device(s) executing the configuration tool may provide a copy of the summary for the user to download the summary. As described herein, the summary may include the proposed configuration section 1910, as shown in FIG. 43C. The report may be in an excel, PDF, etc. The control circuit of the computing device(s) executing the configuration tool may allow the user to print the summary window/page. On the printed page, the control circuit of the computing device(s) executing the load control system configuration tool may include an indication, such as a QR code, a reference number, etc. The control circuit of the computing device(s) executing the load control system configuration tool may use the indication to look up the configuration process associated with the indication without the user having to save the process separately (e.g., save locally or in cloud) or creating login credentials as described herein. The indication may allow the user to pick up where the user left off and may skip providing the same repetitive details about the project (e.g., that saves time and/or avoids potential mistakes).

The control circuit of the computing device(s) executing the load control system configuration tool may provide an export button 1950. The control circuit of the computing device(s) executing the configuration tool may transfer one or more (e.g., all) types of information about the project onto a floorplan or other system (e.g., designer software described herein) when the user selects the export button 1950. The control circuit of the computing device(s) executing the load control system configuration tool may be configured to export the load control system configuration that includes load control details about the project and load the information on to the floorplan and/or other system, such as the designer software. The proposed or selected configurations generated by the control circuit of the computing device(s) executing the load control system configuration tool may be selected by the user (e.g., by dragging and dropping) for being inserted into one or more rooms or other spaces of the floorplan and/or designer software. The load control information (e.g., control-source devices, control-target devices, control type, associated devices for enabling communications for load control, room location, etc.) may be uploaded to a server, a system controller, and/or load control devices themselves for enabling load control and load control communications in the load control system. The configurations may include automatically generated associations between devices (e.g., control-source devices, control-target devices, and/or communication devices to allow control instructions to transmit/receive between the devices) or the user may select the associated devices for a given space. For example, a remote control device in a room may be automatically associated with the lighting fixtures in the room.

As shown in FIG. 43C, the control circuit of the computing device(s) executing the load control system configuration tool may provide an order button 1960. The control circuit of the computing device(s) executing the load control system configuration tool may provide an option to the user to place an order based on the load control system configuration (e.g., including the load control details and/or the devices to be implemented on the load control system to function properly) and recommendations provided by the load control system configuration tool. The user may skip contacting a distributor or a third-party vendor separately to order the materials. The control circuit of the computing device(s) executing the load control system configuration tool may place the order directly to the manufacturer. Alternatively, or additionally, the control circuit of the computing device(s) executing the load control system configuration tool may provide a link to the user to place the order.

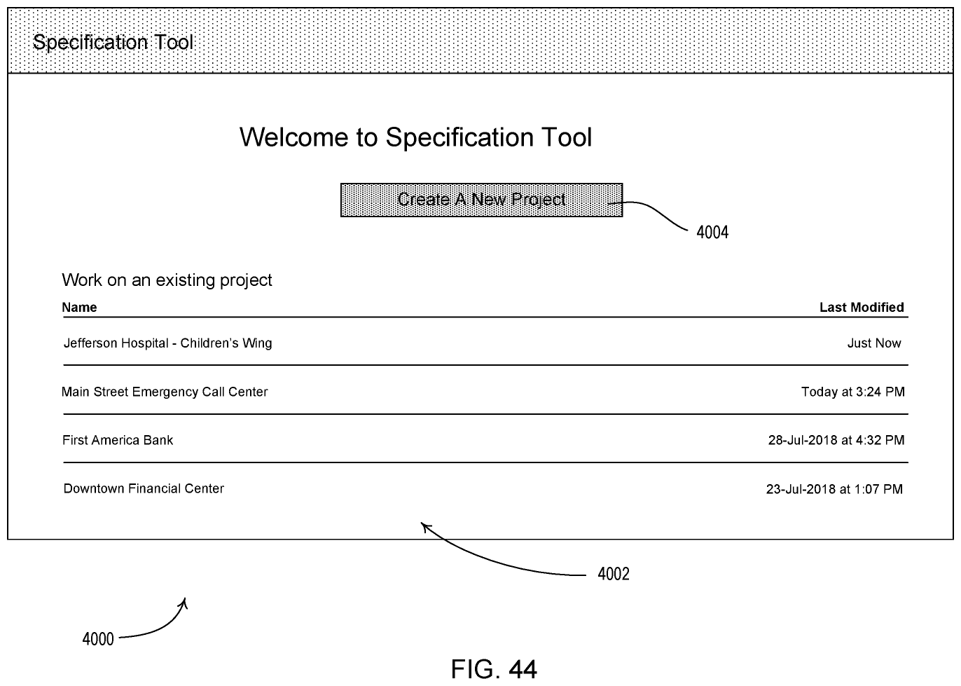

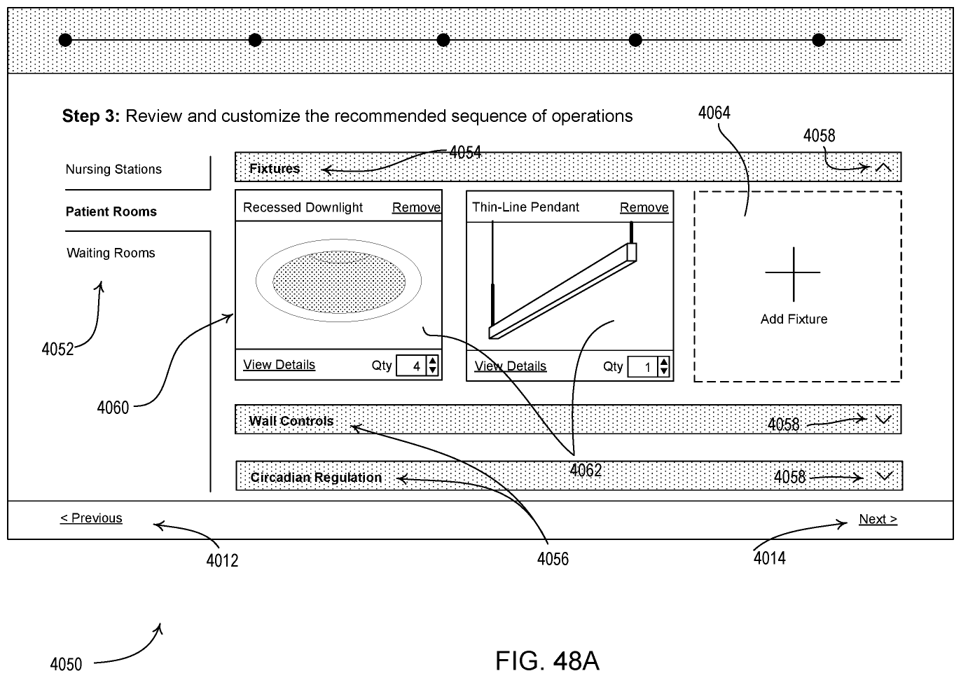

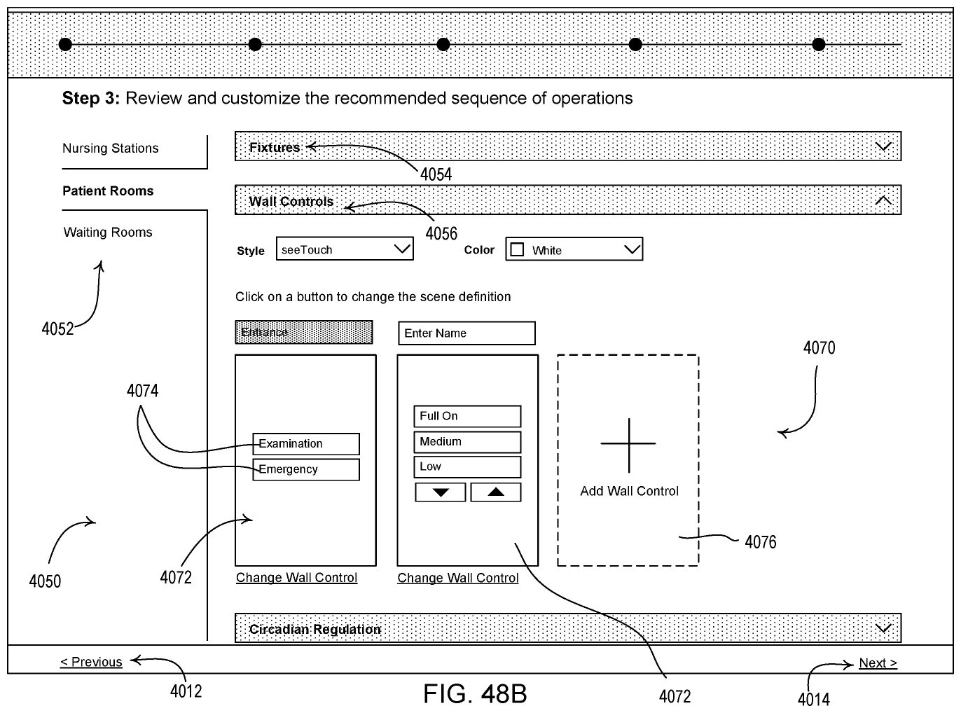

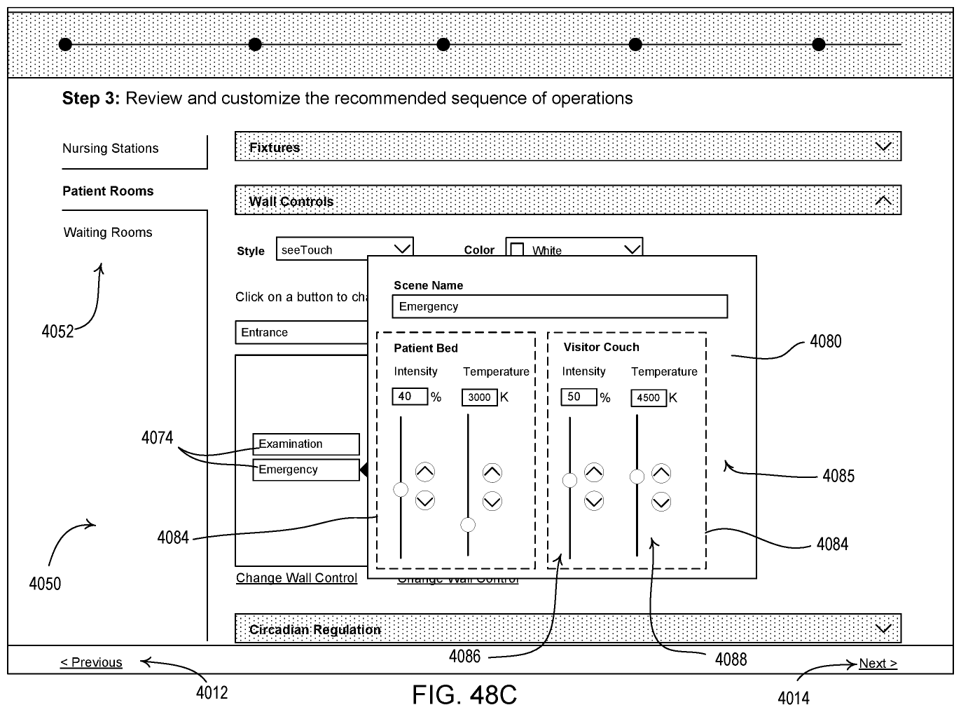

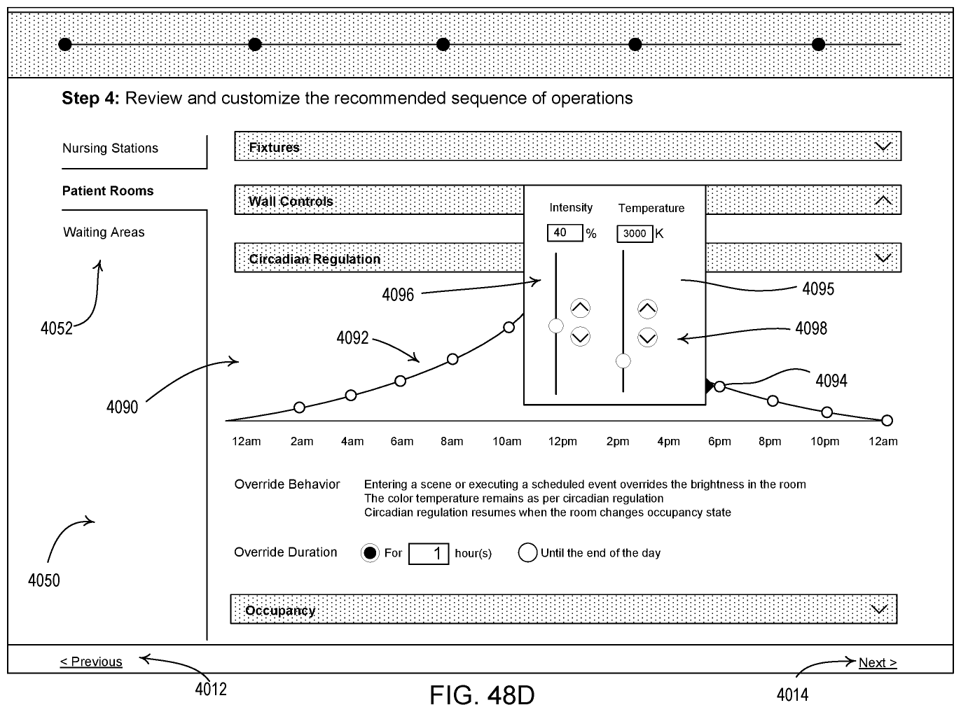

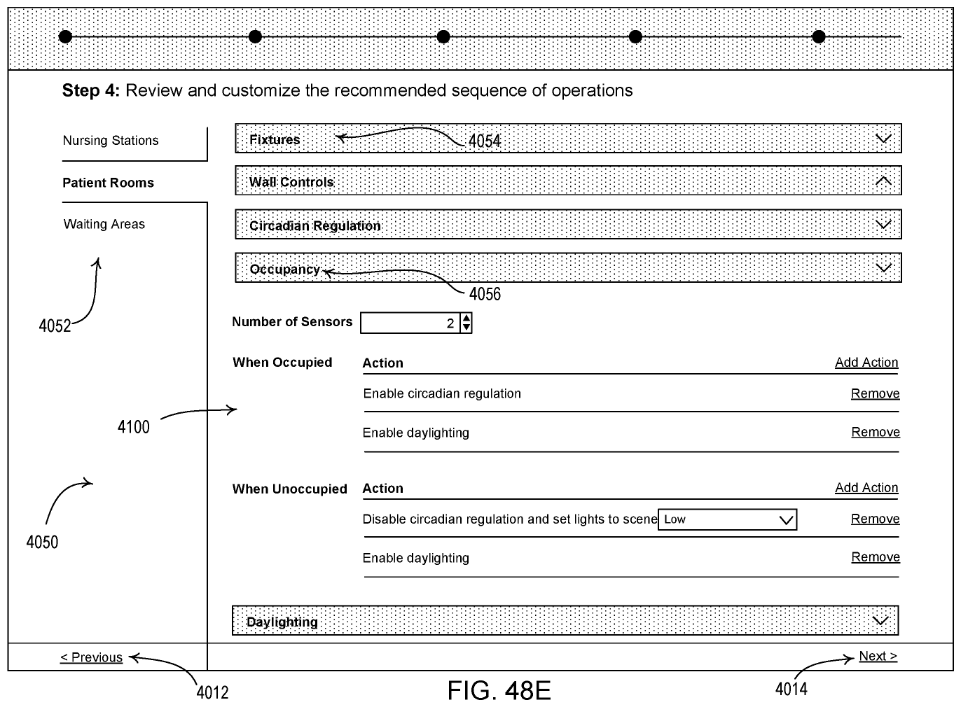

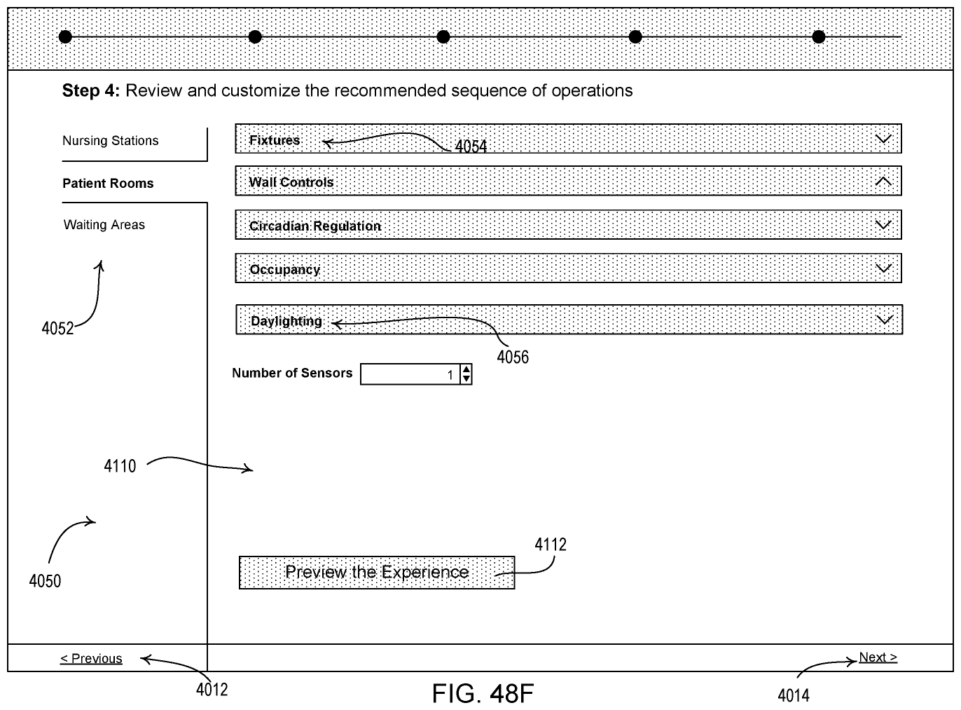

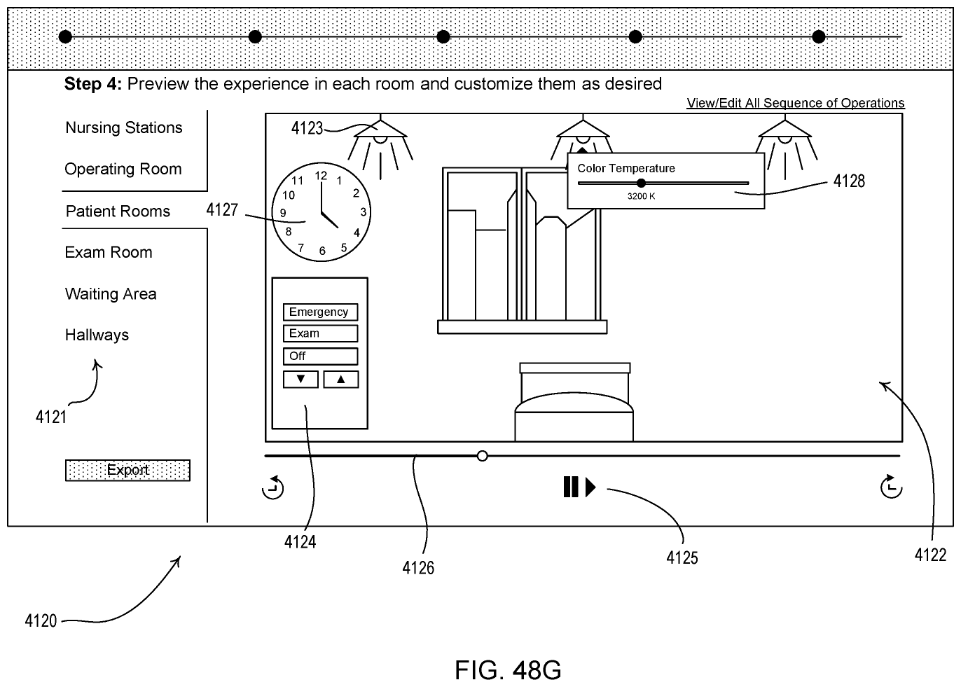

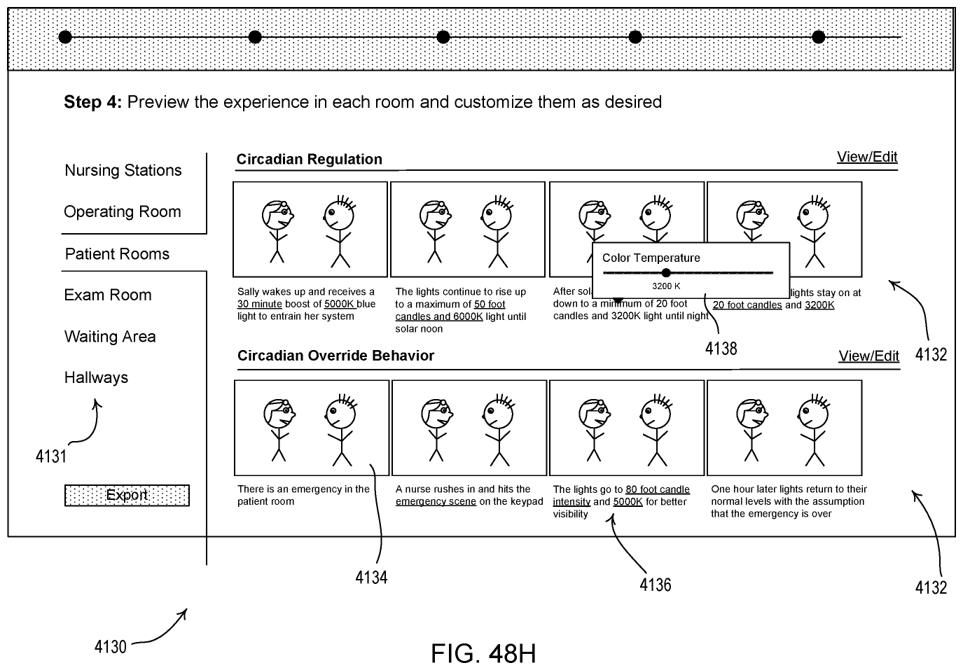

FIGS. 44-50 illustrate another example graphical representations of a user interface that may be displayed on a visual display of a computing device(s) executing the load control system configuration tool, e.g., a GUI software such as a load control system configuration tool software, for configuring load construction instructions defined for controlling load control devices in a load control system according to the identified load control system configurations. For example, the control circuit of the computing device(s) executing the load control system configuration tool shown in FIGS. 44-50 may allow the user to change default settings of the load control details (e.g., default control instructions defined for controlling the load control devices) that may be generated based on the identified load control details (e.g., control devices, communication types, etc.) for a given configuration. In response to user input, the control circuit of the computing device(s) executing the load control system configuration tool may configure/modify the default settings of the control-source devices when one or more triggering events occurs. The control circuit may change intensities at which lighting control devices may be adjusted and/or color temperatures of the lighting control devices, such as lighting fixtures, when a triggering event is detected. For example, in response to user input, the control circuit of the computing device(s) executing the load control system configuration tool may adjust the lighting fixture proximate to a patient bed to have 40% intensity and 3000K color temperature when the user actuates a button for emergency (e.g., as illustrated in FIGS. 48C). In response to user input, the control circuit of the computing device(s) executing the load control system configuration tool may adjust the lighting fixture to have 40% intensity and 3000K color temperature at designated time of day for configured duration when the user actuates a button for circadian regulation (e.g., as illustrated in FIG. 48D). In response to user input, the control circuit of the computing device(s) executing the load control system configuration tool may adjust control-target devices, such as lighting fixtures, to operate when occupancy sensors in a room detects movement or vacancy (e.g., as illustrated in FIGS. 48E) or when daylight sensors in a room detects daylight (e.g., as illustrated in FIGS. 48F). The control circuit of the computing device(s) executing the load control system configuration tool may adjust load control details and/or load control instructions based on configurations done by the user and/or one or more triggering events shown in FIGS. 44-50.

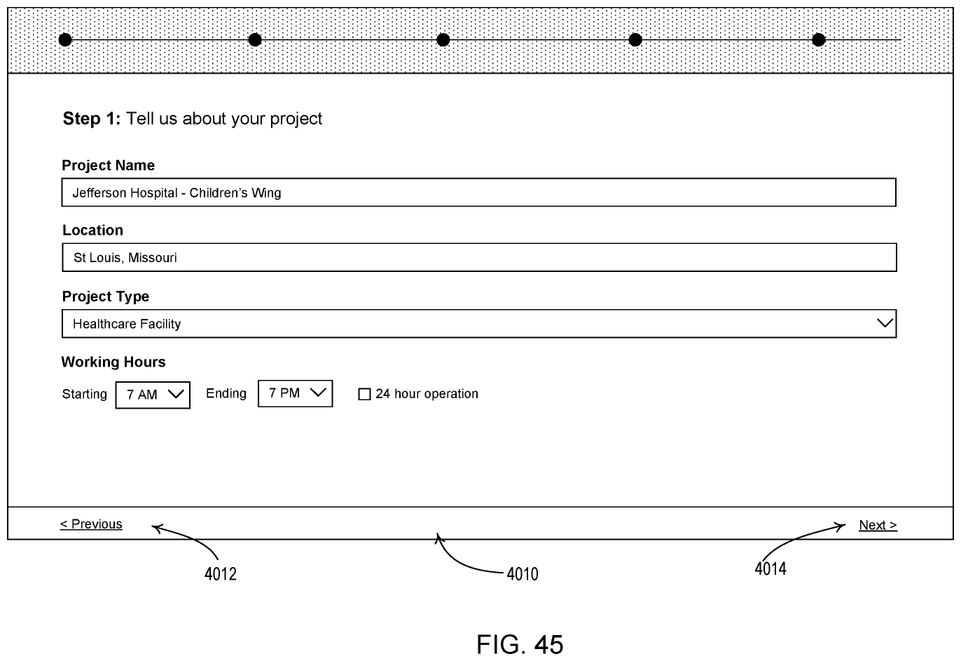

As shown in FIG. 44, the control circuit of the computing device(s) executing the load control system configuration tool may initially display a starting screen 4000, which may allow the user (e.g., the lighting designer) to continue working on an existing project by selecting a project from a list of exiting projects 4002 or start working on a project by selecting a “Create A New Project” button 4004. In response to receiving an input of the selection of the “Create A New Project” button 4004 on the starting screen 4000, the control circuit of the computing device(s) executing the load control system configuration tool may display a project details screen 4010 (e.g., as shown in FIG. 45). The project details screen 4010 allows the user to enter some basic project information, such as the project name, location, type, and/or working hours (e.g., similar to the project details section 2910 shown in FIGS. 29A and 29B). The control circuit of the computing device(s) executing the configuration tool may allow the user to navigate back to the last page (e.g., the starting screen 4000) if the user selects select a “Previous” button 4012 and/or navigate to the next page if the user selects a “Next” button 4014.

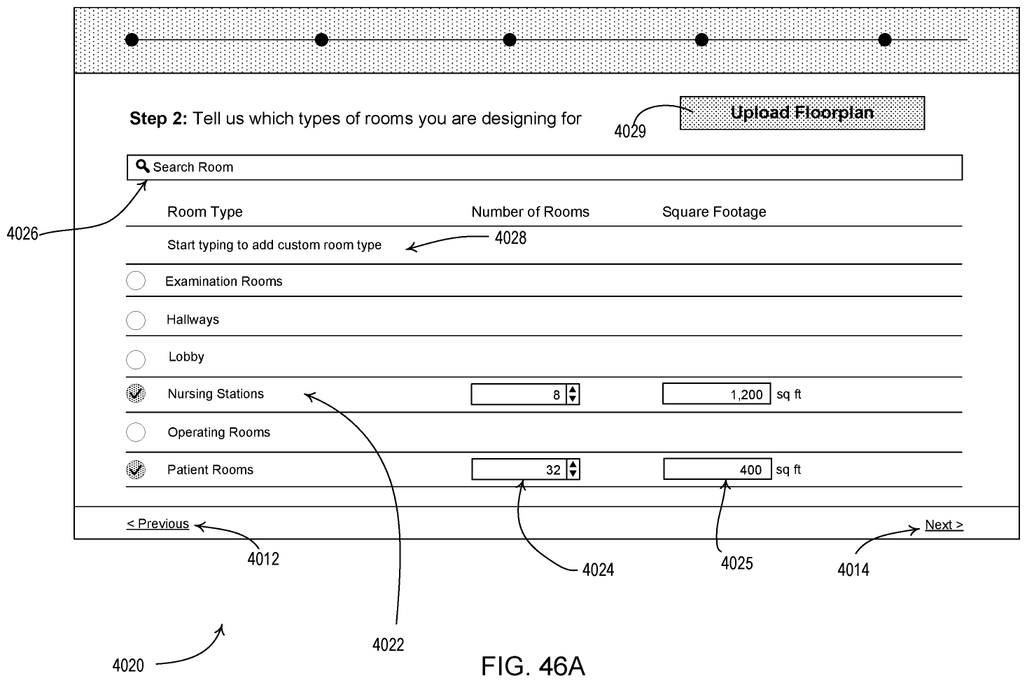

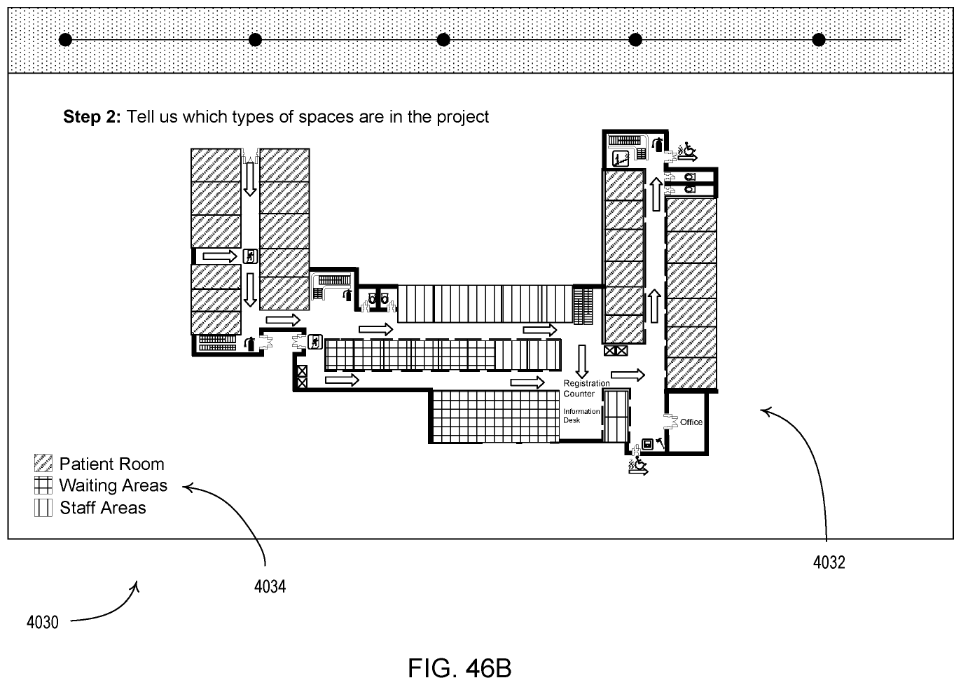

In response to an actuation of the Next button 4014 on the project details screen 4010, the control circuit of the computing device(s) executing the load control system configuration tool may display a room selection screen 4020 (e.g., as shown in FIG. 46A). The control circuit of the computing device(s) executing the configuration tool may receive a selection input by the user about one or more room types that may be a part of the job from a room list 4022 (e.g., by selecting a check box next to the respective room types in the room list). The control circuit of the computing device(s) executing the configuration tool may generate the room types that are displayed on the room selection screen 4020 based on the project type selected on the project details screen 4010 (e.g., as shown in FIG. 45). The control circuit of the computing device(s) executing the configuration tool may receive the selection input on a number of rooms of each of the selected room types in a room type number field 4024 and an average area of each of the selected room types in a room type area field 4025. The user may also search for a room type by entering text into a room type search field 4026 and/or enter a custom room type by entering text into a custom room type name field 4028.

In response to receiving the input on the actuation of an “Upload Floorplan” button 4029, the control circuit of the computing device(s) executing the control circuit of the computing device(s) executing the load control system configuration tool may display a floorplan screen 4030 (e.g., as shown in FIG. 46B). The control circuit of the computing device(s) executing the configuration tool may display the floorplan screen 4030 that may include a floorplan 4032 of the building in which the load control system is to be installed. The floorplan 4032 may be uploaded to the load control system configuration tool, for example, from a pdf or AutoCAD file. The floorplan screen 4030 may allow the user to define room types on the floorplan 4032. For example, the floorplan screen 4030 may include a floorplan legend 4034 (e.g., indicating a different color for each room type). The control circuit of the computing device(s) executing the configuration tool may allow the user to select one of the room types listed in the floorplan legend and highlight areas of the floorplan 4032 to indicate the room types on the floorplan.

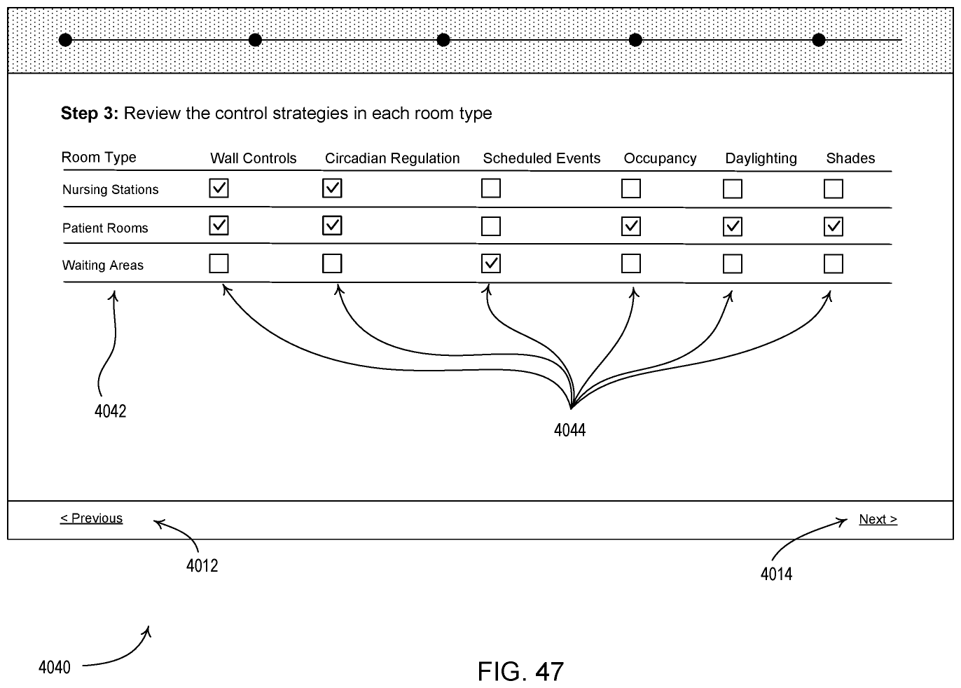

In response to receiving the input of an actuation of the “Next” button 4014 on the room selection screen 4020 (e.g., as shown in FIG. 46A), the control circuit of the computing device(s) executing the load control system configuration tool may display a control strategy summary screen 4040 (e.g., as shown in FIG. 47). The control circuit of the computing device(s) executing the configuration tool may display the control strategy summary screen 4040 that includes a selected room type list 4042 (e.g., listing those room types selected on the room selection screen 4020) as well as control strategies 4044 that may be selected for each room. For example, the control strategies may include, but not limited to wall controls, circadian regulation (e.g., “white tuning” or color temperature control), scheduled events, occupancy, daylighting, and/or shades (e.g., motorized window treatments). The selection of each of the control strategies 4044 may be indicated by a checked box underneath the respective control strategy and in the line of one of the room types of the selected room type list 4042. The control circuit of the computing device(s) executing the load control system configuration tool may select (e.g., automatically select) the control strategies 4044. The control strategies may be selected (e.g., initially selected) when the control strategy summary screen 4040 is displayed (e.g., based on knowledge of typical control strategies for the selected room types). The user may select additional control strategies 4044 by selecting an unselected check box and/or unselect one or more of the control strategies by selecting a selected check box.

In response to an actuation of the Next button 4014 on the control strategy summary screen 4040 (e.g., as shown in FIG. 47), the control circuit of the computing device(s) executing the load control system configuration tool may display a control strategy customization screen 4050 (e.g., as shown in FIG. 48A). The control strategy customization screen 4050 may include a room type list 4052 (e.g., listing those room types selected on the room selection screen 4020). When one of the room types of the room type list 4052 is selected, the control circuit of the computing device(s) executing the configuration tool may display the control strategy customization screen 4050 that includes a fixture heading 4054 as well as respective control strategy headings 4056 for the control strategies selected on the control strategy summary screen 4040. Each of the fixture heading 4054 and/or the control strategy headings 4056 may be expanded or contracted in response to actuations of respective expand/contract icons 4058. When the fixture heading 4054 is expanded, the control strategy customization screen 4050 may display a fixture customization section 4060, which may include a number of fixture tiles 4062 that note details of the types of fixtures for in the selected room type. The control circuit of the computing device(s) executing the load control system configuration tool may select (e.g., automatically select) the types of fixtures for the selected room type based on the control strategies selected for the room types on the control strategy summary screen 4040. The user may add fixture types by selecting an add fixture button 4064.

When the control strategy heading 4056 for wall controls is expanded, the control strategy customization screen 4050 may display a wall controls customization section 4070 (e.g., as shown in FIG. 48B). The wall controls customization section 4070 may display images 4072 of a number of wall controls. Each image 4072 of the wall controls may display a number of buttons 4074. The control circuit of the computing device(s) executing the load control system configuration tool may select (e.g., automatically select) the wall controls for the selected room type based on the control strategies and/or fixtures selected for the room types. The user may add one or more wall controls by selecting an add wall control button 4076. The control circuit of the computing device(s) executing the configuration tool may allow the user to select the buttons 4074 on the images of the wall controls and to customize the functionality of the buttons in the load control system (e.g., the resulting operation of the lighting fixtures in response to an actuation of the button). For example, in response to the selection of one of the buttons 4074, the control circuit of the computing device(s) executing the load control system configuration tool may display a button customization window 4080 (e.g., as shown in FIG. 48C). The user may adjust a button name (e.g., a scene name) by entering text into a button name field 4082 of the button customization window 4080. The button customization window 4080 may display one or more zones 4084 (e.g., controlled groups of lighting fixtures) in the room to allow for customization of the functionality of the selected button 4074. For example, the selected button 4074 may control a patient bed zone and a visitor couch zone as shown in FIG. 48C. The button customization window 4084 may include a navigation icon 4085 that may be actuated to scroll to more zones 4084. For each zone 4084, the button customization window 4080 may display an intensity adjustment control 4086 for adjusting an intensity of the zone 4084, and a color temperature adjustment control 4088 for adjusting a color (e.g., a color temperature) of the zone. Specifically, the user may adjust the intensity and/or color temperature by actuating raise and lower buttons, adjusting the position of a slider, and/or entering a value into a control field of each of the intensity adjustment control 4086 and the color temperature adjustment control 4088, respectively. The control circuit of the computing device(s) executing the load control system configuration tool may adjust the default control instructions defined for controlling the control-target devices (e.g., the load control devices), such as the intensities and/or the color temperature of the lighting fixtures, based on the user adjustment and update the load control instructions associated with the load control devices accordingly based on the triggering event (e.g., the user actuating a button for emergency button).

When the control strategy heading 4056 for circadian regulation on the control strategy customization screen 4050 is expanded, the control circuit of the computing device(s) executing the load control system configuration tool may display a circadian regulation customization section 4090 (e.g., as shown in FIG. 48D). The circadian regulation customization section 4090 may display a plot 4092 of the color temperature (e.g., a room color temperature) to which the lighting fixtures of the selected room type will be controlled at various times of the day (e.g., in response to a timeclock). The plot 4092 may include a number of control points 4094 indicating the times at which the lighting fixtures will be controlled. In response to the selection of one of the points, the control strategy customization screen 4050 may display a circadian regulation customization window 4095. The circadian regulation customization window 4095 may display an intensity adjustment control 4096 for adjusting an intensity of the lighting fixtures in the selected room types at the selected control point 4094, and a color temperature adjustment control 4098 for adjusting the color temperature of the lighting fixtures in the selected room types at the selected control point 4094. Similar to FIG. 48B, the control circuit of the computing device(s) executing the load control system configuration tool may update the load control instructions associated with the load control devices accordingly (e.g., adjust intensities and/or color temperatures of the lighting fixtures based on the user adjustment).

When the control strategy heading 4056 for occupancy on the control strategy customization screen 4050 is expanded, the control circuit of the computing device(s) executing the load control system configuration tool may display an occupancy customization section 4100 (e.g., as shown in FIG. 48E). When the control strategy heading 4056 for daylighting on the control strategy customization screen 4050 is expanded, the control circuit of the computing device(s) executing the load control system configuration tool may display a daylighting customization section 4110 (e.g., as shown in FIG. 48F). The control strategy customization screen 4050 may also display a “Preview the Experience” button 4112.

In response to a selection of the “Preview the Experience” button 4112 (e.g., as shown in FIG. 48F) on the control strategy customization screen 4050, the control circuit of the computing device(s) executing the load control system configuration tool may display an example simulation screen 4120 (e.g., as shown in FIG. 48G). The simulation screen 4120 may include a room type list 4121 (e.g., similar to the room type list 4052) that may list the room types selected on the room selection screen 4020. The simulation screen 4120 may display an example animation 4122 (e.g., an image) of the selected room type. The animation 4122 may display one or more lighting fixtures 4123 of the lighting fixtures for the selected room type. The simulation screen 4120 may also display one or more images 4124 of the wall controls for the selected room type. The simulation screen 4120 may include a playback control 4125. The control circuit of the computing device(s) executing the configuration tool may receive inputs on the actuations of the playback control 4125 and may start and stop a simulation of the events in the selected room type during an example day (e.g., as customized on the circadian regulation customization section 4090 shown in FIG. 48D). The user may also select a playback bar 4126 to control the playback of the simulation. The simulation screen 4120 may include a clock 4127 to indicate the present time of the simulation during the simulated day. The simulation of the event of the example day may playback at a fast rate to simulate an entire day in a short amount of time (e.g., a few minutes). The intensity and/or color of the lighting fixtures 4123 of the animation 4122 may adjust while the simulation is playing. In addition, the images of the animation 4122 may be adjusted (e.g., be animated) to indicate various events that may occur in the room type during the day. In response to the selection of one of the lighting fixtures 4123 during the playback of the simulation, the simulation screen 4120 may display a customization window 4128, for example, to allow for adjustment of the intensity and/or color temperature of the selected lighting fixture or all of the lighting fixtures in the selected room type at the present time of the simulation. In addition, the user may actuate the buttons on the images 4124 of the wall controls to simulate manual override of the automated control of the room type.

In response to a selection of the “Preview the Experience” button 4112 on the control strategy customization screen 4050, the control circuit of the computing device(s) executing the load control system configuration tool may also display an example preview screen 4130 (e.g., as shown in FIG. 48H). The preview screen 4130 may include a room type list 4131 (e.g., similar to the room type list 4052) that may list the room types selected on the room selection screen 4020. The preview screen 4130 may include a number of storyboards 4132. Each storyboard 4132 may include a number of story images 4134 and associated text 4136 that detail the operation of the selected room type during an example day. In response to the selection of an underlined sections of the text 4136, the control circuit of the computing device(s) executing the configuration tool may display the preview screen 4130 that includes a customization window 4138, for example, to allow for adjustment of the intensity and/or color temperature of the selected lighting fixture or all of the lighting fixtures in the selected room type for the identified function of the load control system.

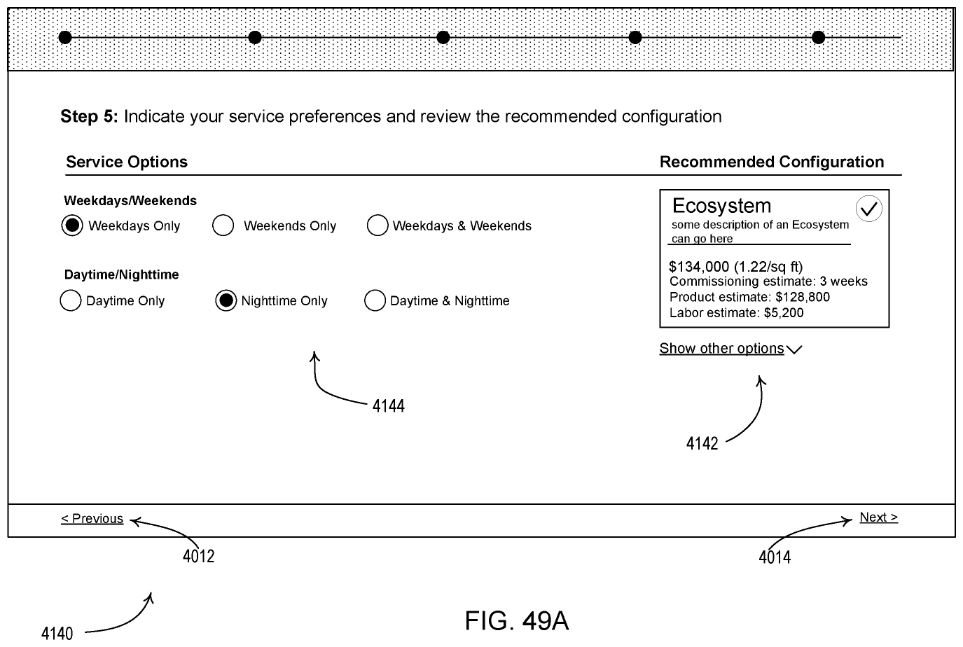

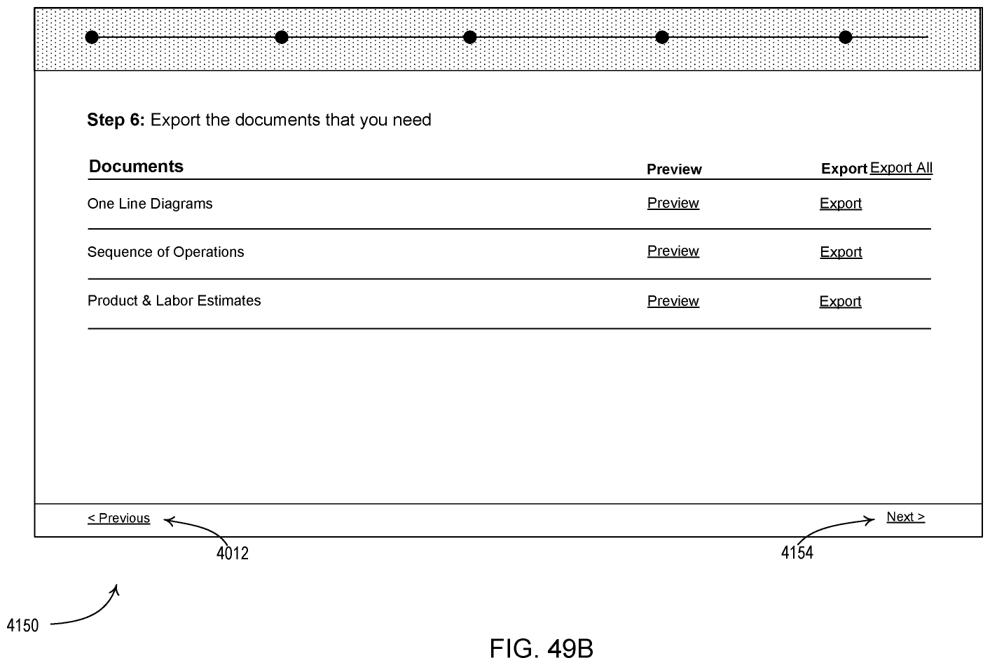

When the user is finished customizing the control strategies on the control strategy customization screen 4050, the user may select the Next button 4014 on the control strategy customization screen 4050 (e.g., as shown in FIGS. 48A-48F). In response to an actuation of the Next button 4014 on the control strategy customization screen 4050, the control circuit of the computing device(s) executing the load control system configuration tool may display a recommended load control system configuration screen 4140 (e.g., as shown in FIG. 49A). Depending on the answers/details that the user provides about the project, the control circuit of the computing device(s) executing the load control system configuration tool may provide one or more load control system configuration blocks 4142 tailored to the project. The one or more load control system configuration blocks 4142 may include recommended load control devices to be implemented for the project to function properly. The load control system configuration blocks 4142 may also include an estimated cost associated with each recommended load control system configurations. The control circuit of the computing device(s) executing the load control system configuration tool may also display cost per square footage, labor estimate, and/or shipment estimate on the one or more load control system configuration blocks 4142. In addition, the recommended load control system configuration screen 4140 may include service options section 4144 for allowing the user to select one or more schedule options to control one or more load control devices as described herein. In response to an actuation of the Next button 4014 on the recommended load control system configuration screen 4140, the control circuit of the computing device(s) executing the load control system configuration tool may display a final screen 4150 (e.g., as shown in FIG. 49B), which may allow a user to select documents regarding the project to be exported. In response to an actuation of a Finish button 4154 on the final screen 4150, the control circuit of the computing device(s) executing the load control system configuration tool may exit.

As described herein, the exported load control system configurations may be imported to other systems and/or software, such as the designer software described herein. For example, the user may import the load control system configurations from the load control system configuration tool into the designer software. Using the designer software, the user may further revise/update the load control details of the load control system configurations. For example, the user may select devices in a configuration for creating associations between devices to enable communications and/or define control instructions for enabling control of an electrical load in response to a triggering event. The load control details may also be imported from the design system or the load control configuration system to a load control system for enabling control of the load control devices as provided in the load control details of the load control system configurations. For example, the load control details, or predefined portions thereof (e.g., control-source device identifiers, control-target device identifiers, associations, and/or control information) may be imported by a system controller of a load control system for enabling identification and/or control of devices in the system.

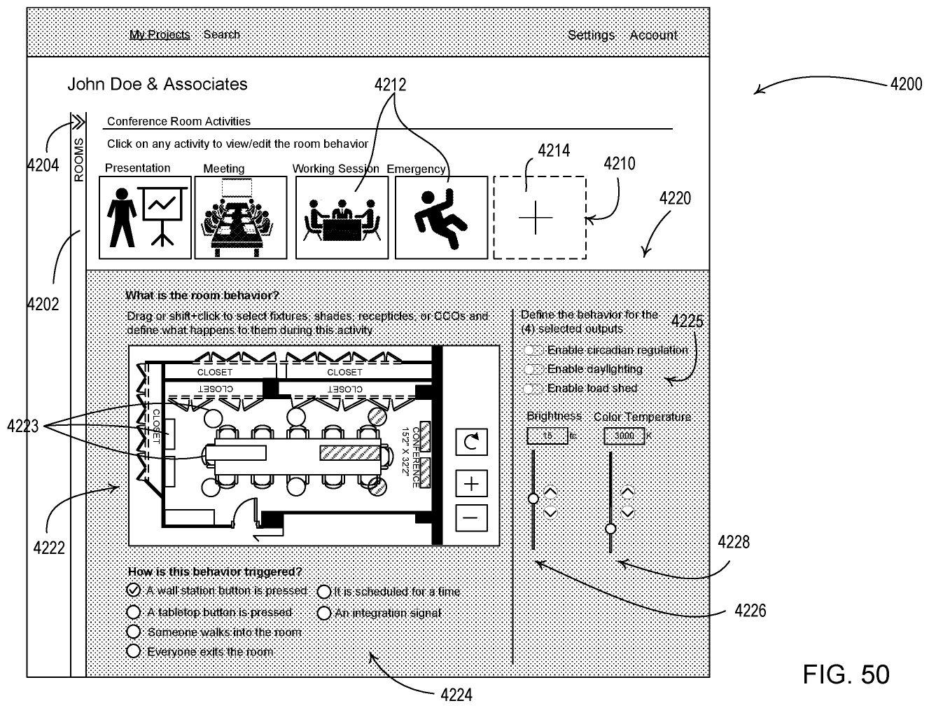

FIG. 50 illustrates another example of a control strategy customization screen 4200 that may be displayed after the control strategy summary screen 4040 (e.g., in response to an actuation of the Next button 4014 on the control strategy summary screen 4040 as shown in FIG. 47). The control circuit of the computing device(s) executing the load control system configuration tool may display the control strategy customization screen 4200 that may include a room selection bar 4202. The control circuit of the computing device(s) executing the configuration tool may expand the room selection bar to display a room type list (not shown) if the configuration tool receives an actuation input from the user selecting an expand icon 4204 on the room selection bar 4202. The control circuit of the computing device(s) executing the configuration tool may allow the user to select one of the room types selected on the room selection screen 4020. For example, “Conference Room” may be selected as shown in FIG. 50. The control strategy customization screen 4200 may display a room activity section 4210. The room activity section 4210 may include a number of room activity tiles 4212. For example, as shown in FIG. 50, the room activity tiles 4212 may be presentation, meeting, working session, and emergency. The user may add additional room activity tiles 4212 by selecting an add activity tile 4214.

The control circuit of the computing device(s) executing the load control system configuration tool may display the control strategy customization screen 4200 that may include a room behavior section 4220. The control circuit of the computing device(s) executing the load control system configuration tool may allow the user to customize the behavior of the room activities for the selected room type. In response to the actuation of one of the room activity tiles 4212, the room behavior section 4220 may display information regarding the behavior of the selected room activity (e.g., how the lighting fixture operate in response to a received input). For example, “Presentation” may be selected as shown in FIG. 50. The room behavior section 4220 may include a floorplan 4222 (e.g., a partial floorplan showing a single room). The floorplan 4222 may be uploaded to the load control system configuration tool (e.g., as previously discussed in regard to FIG. 46B). The user may adjust the floorplan 4222 until the desired portion of the floorplan is displayed on the control strategy customization screen 4200 (e.g., to display a room that is an example of the selected room type). The floorplan 4222 may include one or more lighting fixtures 4223. The lighting fixtures 4223 may be uploaded into the room behavior section 4220 along with the floorplan 4222 (e.g., as part of the uploaded data) or as a separate upload. In addition, the user may draw the lighting fixtures 4223 on the floorplan 4222. The user may select one or more of the lighting fixtures 4223 to be controlled as a part of the selected room activity. The control circuit of the computing device(s) executing the load control system configuration tool may highlight the selected fixtures a different color (e.g., yellow as shown in FIG. 50). The room behavior section 4220 may include a behavior trigger section 4224 that the user may utilize to determine how the behavior for the selected room activity may be triggered. For example, the behavior for the “Presentation” activity may be triggered in response to an actuation of a button of a wall control as shown in FIG. 50. The room behavior section 4220 may include an enable feature section 4225 that the user may use to indicate features that may be enabled or disabled for the selected room activity. The room behavior section 4220 may also display an intensity adjustment control 4226 and a color temperature adjustment control 4228 for adjusting the intensity and/or the color temperature, respectively, of the lighting fixtures in the selected room type during the selected room activity.

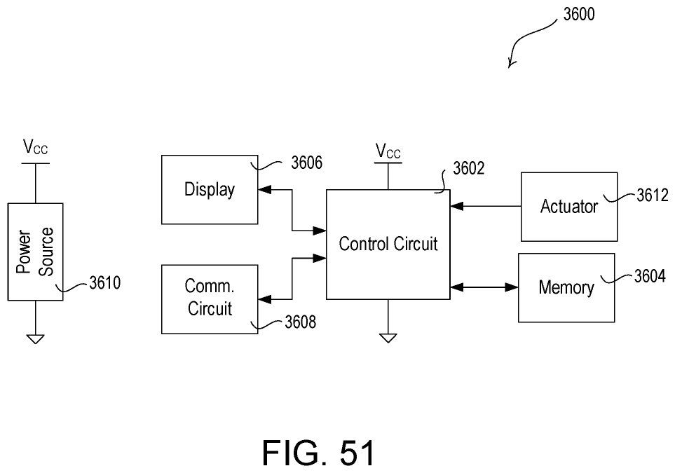

FIG. 51 is a block diagram illustrating an example network device 3600 as described herein. For example, the network device 3600 may be the computer 144. The network device 3600 may include a control circuit 3602 for controlling the functionality of the network device 3600. The control circuit 3602 may include one or more general purpose processors, special purpose processors, conventional processors, digital signal processors (DSPs), microprocessors, integrated circuits, a programmable logic device (PLD), application specific integrated circuits (ASICs), or the like. The control circuit 3602 may perform signal coding, data processing, power control, input/output processing, or any other functionality that enables the network device 3600 to perform as described herein. The control circuit 3602 may store information in and/or retrieve information from the memory 3604. The memory 3604 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory.

The network device 3600 may include a communications circuit 3608 for transmitting and/or receiving information. The communications circuit 3608 may perform wireless and/or wired communications. The communications circuit 3608 may include an RF transceiver or other circuit capable of performing wireless communications via an antenna. Communications circuit 3608 may be in communication with control circuit 3602 for transmitting and/or receiving information.

The control circuit 3602 may be in communication with a display 3606 for providing information to a user. The processor 3602 and/or the display 3606 may generate GUIs for being displayed on the network device 3600. The display 3606 and the control circuit 3602 may be in two-way communication, as the display 3606 may include a touch screen module capable of receiving information from a user and providing such information to the control circuit 3602. The network device 3600 may include an actuator 3612 (e.g., one or more buttons) that may be actuated by a user to communicate user selections to the control circuit 3602.

Each of the modules within the network device 3600 may be powered by a power source 3610. The power source 3610 may include an AC power supply or DC power supply, for example. The power source 3610 may generate a supply voltage Vcc for powering the modules within the network device 3600.

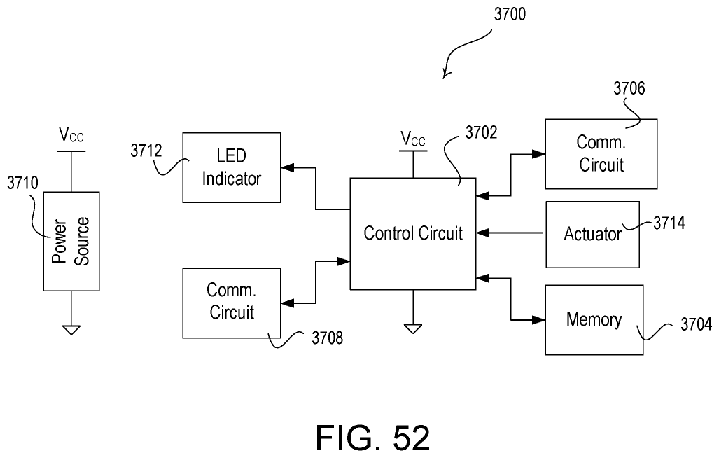

FIG. 52 is a block diagram illustrating an example server or system controller 3700 (such as remote server 160 system controller 150, described herein). The server or system controller 3700 may include a control circuit 3702 for controlling the functionality of the server system controller 3700. The control circuit 3702 may include one or more general purpose processors, special purpose processors, conventional processors, digital signal processors (DSPs), microprocessors, integrated circuits, a programmable logic device (PLD), application specific integrated circuits (ASICs), or the like. The control circuit 3702 may perform signal coding, data processing, power control, input/output processing, or any other functionality that enables the server or system controller 3700 to perform as described herein. The control circuit 3702 may store information in and/or retrieve information from the memory 3704. The memory 3704 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory.

The server or system controller 3700 may include a communications circuit 3706 for transmitting and/or receiving information. The communications circuit 3706 may perform wireless and/or wired communications. The server or system controller 3700 may also, or alternatively, include a communications circuit 3708 for transmitting and/or receiving information. The communications circuit 3706 may perform wireless and/or wired communications. Communications circuits 3706 and 3708 may be in communication with control circuit 3702. The communications circuits 3706 and 3708 may include RF transceivers or other communications modules capable of performing wireless communications via an antenna. The communications circuit 3706 and communications circuit 3708 may be capable of performing communications via the same communication channels or different communication channels. For example, the communications circuit 3706 may be capable of communicating (e.g., with a programming device, over a network, etc.) via a wireless communication channel (e.g., BLUETOOTH®, near field communication (NFC), WIFI®, WI-MAX®, cellular, etc.) and the communications circuit 3708 may be capable of communicating (e.g., with control devices and/or other devices in the load control system) via another wireless communication channel (e.g., WI-FI® or a proprietary communication channel, such as CLEAR CONNECT™).

The control circuit 3702 may be in communication with an LED indicator 3712 for providing indications to a user. The control circuit 3702 may be in communication with an actuator 3714 (e.g., one or more buttons) that may be actuated by a user to communicate user selections to the control circuit 3702. For example, the actuator 3714 may be actuated to put the control circuit 3702 in an association mode and/or communicate association messages from the server or system controller 3700.

Each of the modules within the server or system controller 3700 may be powered by a power source 3710. The power source 3710 may include an AC power supply or DC power supply, for example. The power source 3710 may generate a supply voltage Vcc for powering the modules within the server or system controller 3700.

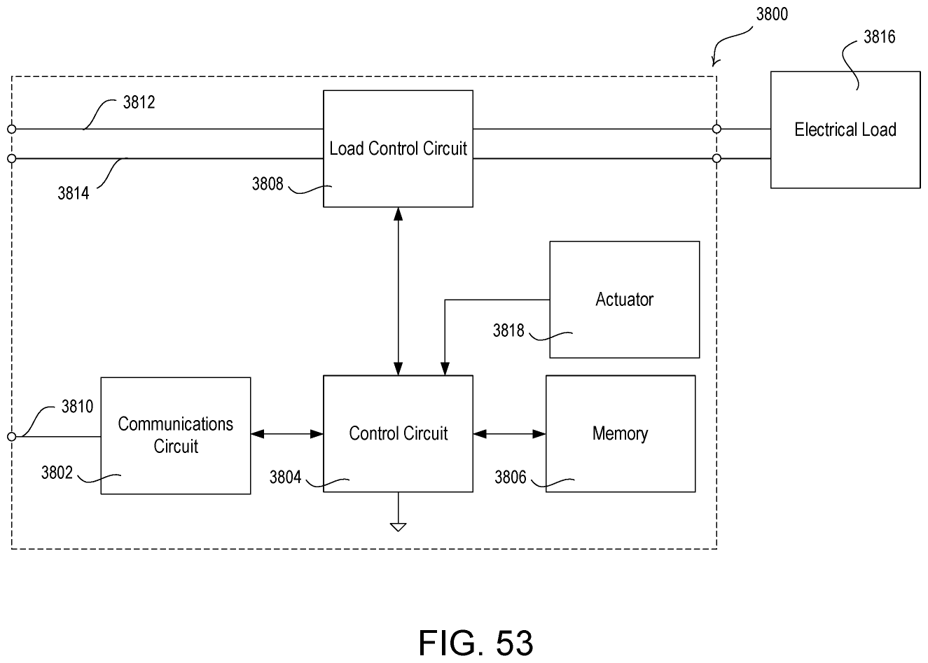

FIG. 53 is a block diagram illustrating an example control-target device, e.g., a load control device 3800, as described herein. The load control device 3800 may be a dimmer switch, an electronic switch, an electronic ballast for lamps, an LED driver for LED light sources, an AC plug-in load control device, a temperature control device (e.g., a thermostat), a motor drive unit for a motorized window treatment, or other load control device. The load control device 3800 may include a communications circuit 3802. The communications circuit 3802 may include a receiver, an RF transceiver, or other communications module capable of performing wired and/or wireless communications via communications link 3810. The communications circuit 3802 may be in communication with control circuit 3804. The control circuit 3804 may include one or more general purpose processors, special purpose processors, conventional processors, digital signal processors (DSPs), microprocessors, integrated circuits, a programmable logic device (PLD), application specific integrated circuits (ASICs), or the like. The control circuit 3804 may perform signal coding, data processing, power control, input/output processing, or any other functionality that enables the load control device 3800 to perform as described herein.

The control circuit 3804 may store information in and/or retrieve information from the memory 3806. For example, the memory 3806 may maintain a registry of associated control devices and/or control configuration instructions. The memory 3806 may include a non-removable memory and/or a removable memory. The load control circuit 3808 may receive instructions from the control circuit 3804 and may control the electrical load 3816 based on the received instructions. The load control circuit 3808 may send status feedback to the control circuit 3804 regarding the status of the electrical load 3816. The load control circuit 3808 may receive power via the hot connection 3812 and the neutral connection 3814 and may provide an amount of power to the electrical load 3816. The electrical load 3816 may include any type of electrical load.

The control circuit 3804 may be in communication with an actuator 3818 (e.g., one or more buttons) that may be actuated by a user to communicate user selections to the control circuit 3804. For example, the actuator 3818 may be actuated to put the control circuit 3804 in an association mode and/or communicate association messages from the load control device 3800.

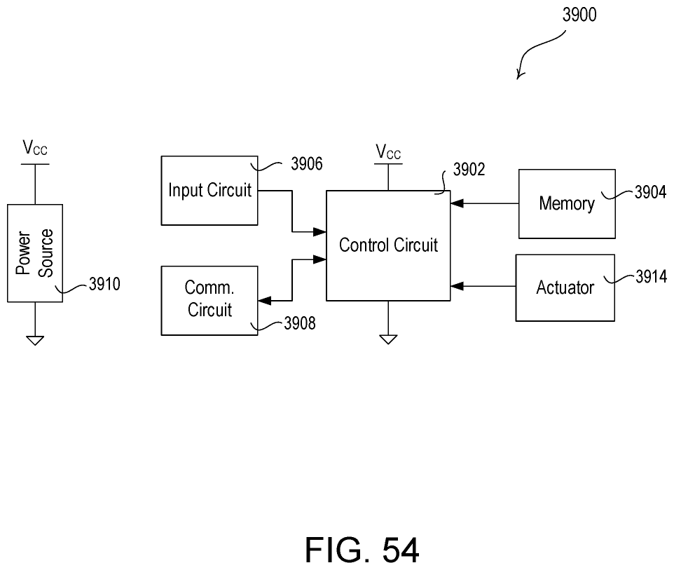

FIG. 54 is a block diagram illustrating an example control-source device 3900 as described herein. The control-source device 3900 may be a remote control device, an occupancy sensor, a daylight sensor, a window sensor, a temperature sensor, and/or the like. The control-source device 3900 may include a control circuit 3902 for controlling the functionality of the control-source device 3900. The control circuit 3902 may include one or more general purpose processors, special purpose processors, conventional processors, digital signal processors (DSPs), microprocessors, integrated circuits, a programmable logic device (PLD), application specific integrated circuits (ASICs), or the like. The control circuit 3902 may perform signal coding, data processing, power control, input/output processing, or any other functionality that enables the control-source device 3900 to perform as described herein.

The control circuit 3902 may be in communication with an actuator 3914 (e.g., one or more buttons) that may be actuated by a user to communicate user selections to the control circuit 3902. For example, the actuator 3914 may be actuated to put the control circuit 3902 in an association mode and/or communicate association messages from the control-source device 3900. The control circuit 3902 may store information in and/or retrieve information from the memory 3904. The memory 3904 may include a non-removable memory and/or a removable memory, as described herein.

The control-source device 3900 may include a communications circuit 3908 for transmitting and/or receiving information. The communications circuit 3908 may transmit and/or receive information via wired and/or wireless communications. The communications circuit 3908 may include a transmitter, an RF transceiver, or other circuit capable of performing wired and/or wireless communications. The communications circuit 3908 may be in communication with control circuit 3902 for transmitting and/or receiving information.

The control circuit 3902 may also be in communication with an input circuit 3906. The input circuit 3906 may include an actuator (e.g., one or more buttons) or a sensor circuit (e.g., an occupancy sensor circuit, a daylight sensor circuit, or a temperature sensor circuit) for receiving input that may be sent to a device for controlling an electrical load. For example, the control-source device may receive input from the input circuit 3906 to put the control circuit 3902 in an association mode and/or communicate association messages from the control-source device. The control circuit 3902 may receive information from the input circuit 3906 (e.g. an indication that a button has been actuated or sensed information). Each of the modules within the control-source device 3900 may be powered by a power source 3910.

Although features and elements are described herein in particular combinations, each feature or element can be used alone or in any combination with the other features and elements. The methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs).

What is claimed:

1. A load control system comprising:
a load control device configured to control an electrical load in response to load control instructions generated based on a triggering event at a control-source device;
a system controller configured to send the load control instructions to the load control device for controlling the electrical load in response to the triggering event at the control-source device; and
a computing device comprising a control circuit, the control circuit configured to:
receive a plurality of load control system configurations, each load control configurations comprising load control details associated with the load control system, wherein each of the load control details comprises the load control instructions for controlling the electrical load;
receive a plurality of inputs from a user corresponding to the load control details;
identify one or more of the plurality of load control system configurations in response to the plurality of inputs received from the user;
receive a selection of one of the one or more identified load control system configurations;
modify the load control instructions of the selected load control system configuration based on one or more modification inputs from the user; and
upload the modified load control instructions to the system controller; and
wherein the system controller configured to send the load control instructions configured to control the electrical load based on the modified load control instructions.

2. The load control system of claim 1, wherein the load control details comprise a plurality of first level details and a plurality of second level details, wherein the plurality of first level details comprises one or more of square footage, energy code, building function, or construction type and the plurality of second level details comprises one or more of number of buildings, number of floors associated with buildings, emergency power type, voltage type, projection completion date, room types, control strategies, fixture controls, building types, ceiling types, building ages, building wirings, fixture types, room quantities, or fixture schedules.

3. The load control system of claim 2, wherein to identify the one or more load control system configurations, the control circuit is configured to:
determine a number of load control devices in the load control system based on the plurality of inputs from the user corresponding to one or more of the square footage, the energy code, or the building function.

4. The load control system of claim 3, wherein the number of load control devices in the load control system is associated with a minimum number of load control devices in the load control system to function properly and meet the energy code.

5. The load control system of claim 2, wherein the control circuit is configured to:
receive a plurality of inputs from the user corresponding to each of the plurality of second level details; and
update the one or more load control system configurations based on the plurality of inputs received from the user.

6. The load control system of claim 1, wherein the electrical load is a lighting load, wherein the load control instructions comprise one or more intensities or color temperatures, and wherein to modify the one or more load control system configuration comprising the load control instructions, the control circuit is configured to:
receive the one or more modification inputs from the user to adjust the one or more intensities or color temperatures associated with the lighting load; and
upload the adjusted one or more intensities or color temperatures associated with the lighting load to the system controller.

7. A method for controlling an electrical load in response to load control instructions generated based on a triggering event at a control-source device, the method comprising:
receiving a plurality of load system control configurations, each load control system configurations comprising load control details associated with a load control system, wherein each of the load control details comprises the load control instructions for controlling the electrical load;
receiving a plurality of inputs from a user corresponding to the load control details;
identifying one or more of the plurality of load control system configurations in response to the plurality of inputs received from the user;
receiving a selection of one of the one or more identified load control system configurations;
modifying the load control instructions of the selected load control system configuration based on one or more modification inputs from the user; and
uploading the modified load control instructions to a system controller, wherein the system controller configured to send the load control instructions configured to control the electrical load based on the modified load control instructions.

8. The method of claim 7, wherein the load control details comprise a plurality of first level details and a plurality of second level details, wherein the plurality of first level details comprises one or more of square footage, energy code, building function, or construction type and the plurality of second level details comprises one or more of number of buildings, number of floors associated with buildings, emergency power type, voltage type, projection completion date, room types, control strategies, fixture controls, building types, ceiling types, building ages, building wirings, fixture types, room quantities, or fixture schedules.

9. The method of claim 8, wherein identifying the one or more load control system configurations, the method comprises:
determining a number of load control devices in the load control system based on the plurality of inputs from the user corresponding to one or more of the square footage, the energy code, or the building function.

10. The method of claim 9, wherein the number of load control devices in the load control system is associated with a minimum number of load control devices in the load control system to function properly and meet the energy code.

11. The method of claim 8, wherein the method comprises:
receiving a plurality of inputs from the user corresponding to each of the plurality of second level details; and
updating the one or more load control system configurations based on the plurality of inputs received from the user.

12. The method of claim 8, wherein the electrical load is a lighting load, wherein the load control instructions comprise one or more intensities or color temperatures.

13. The method of claim 12, wherein modifying the one or more load control system configuration comprising the load control instructions, the method comprises:
receiving the one or more modification inputs from the user to adjust the one or more intensities or color temperatures associated with the lighting load; and
uploading the adjusted one or more intensities or color temperatures associated with the lighting load to the system controller.

14. A computing device to control an electrical load in response to load control instructions generated based on a triggering event at a control-source device, the computing device comprising:
a control circuit configured to:
receive a plurality of load control system configurations, each load control configurations comprising load control details associated with a load control system, wherein each of the load control details comprises the load control instructions for controlling the electrical load;
receiving a plurality of inputs from a user corresponding to the load control details;
identify one or more of the plurality of load control system configurations in response to the plurality of inputs received from the user;
receive a selection of one of the one or more identified load control system configurations;
modify the load control instructions of the selected load control system configuration based on one or more modification inputs from the user; and
upload the modified load control instructions to a system controller, wherein the system controller configured to send the load control instructions configured to control the electrical load based on the modified load control instructions.

15. The computing device of claim 14, wherein the load control details comprise a plurality of first level details and a plurality of second level details, wherein the plurality of first level details comprises one or more of square footage, energy code, building function, or construction type and the plurality of second level details comprises one or more of number of buildings, number of floors associated with buildings, emergency power type, voltage type, projection completion date, room types, control strategies, fixture controls, building types, ceiling types, building ages, building wirings, fixture types, room quantities, or fixture schedules.

16. The computing device of claim 15, wherein to identify the one or more load control system configurations, the control circuit is configured to:
determine a number of load control devices in the load control system based on the plurality of inputs from the user corresponding to one or more of the square footage, the energy code, or the building function.

17. The computing device of claim 16, wherein the number of load control devices in the load control system is associated with a minimum number of load control devices in the load control system to function properly and meet the energy code.

18. The computing device of claim 15, where the control circuit is configured to:
receive a plurality of inputs from the user corresponding to each of the plurality of second level details; and
update the one or more load control system configurations based on the plurality of inputs received from the user.

19. The computing device of claim 14, wherein the electrical load is a lighting load, wherein the load control instructions comprise one or more intensities or color temperatures.

20. The computing device of claim 19, wherein to modify the one or more load control system configuration comprising the load control instructions, the control circuit is configured to:
receive the one or more modification inputs from the user to adjust the one or more intensities or color temperatures associated with the lighting load; and
upload the adjusted one or more intensities or color temperatures associated with the lighting load to the system controller.
